(19) United States
(12) Patent Application Publication
(10) Pub. No.: US 2006/0094634 A1
(43) Pub. Date: May 4, 2006

(54) Detergent or cleaning agent

(76) Inventors: Maren Jekel, Willich (DE); Alexander Lambotte, Duesseldorf (DE); Ulrich Pegelow, Duesseldorf (DE); Johannes Zipfel, Hilden (DE)

Correspondence Address: Dann, Dorfman, Herrell and Skillman, Suite 2400, 1601 Market Street, Philadelphia, PA, 19103--230, US

(21) Appl. No.: 11/236,402

(22) Filed: Sep. 26, 2005

Related U.S. Application Data
(63) Continuation of application No. PCT/EP04/02716, filed on Mar. 17, 2004.

(30) Foreign Application Priority Data
Mar. 25, 2003 (DE) 103 13 455.7

(51) Int. Cl. C11D 17/00

(52) U.S. Cl. 510/446

(57) ABSTRACT

A detergent or cleaning agent comprising a dispersion of solid particles in a dispersion agent wherein the dispersion is comprised of, based on the total weight of the dispersion (a) from 10 to 65 wt % dispersing agent and (b) from 30 to 90 wt % of dispersed materials, wherein the dispersed materials are comprised of from 0.1 to 50 wt % of an anionic and/or cationic and/or amphoteric polymer based on the total weight of the dispersed materials. This composition can be easily formed into tablets.

### CROSS-REFERENCE TO RELATED APPLICATIONS.

This application is a continuation under 35 U.S.C. § 365(c) and 35 U.S.C. § 120 of international application PCT/EP2004/002716, filed Mar. 17, 2004. This application also claims priority under 35 U.S.C. § 119 of DE 103 13 455.7, filed Mar. 25, 2003. Each of these applications is incorporated herein by reference in its entirety.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC.

Not Applicable.

### BACKGROUND OF THE INVENTION

(1) Field of the Invention

This application concerns detergents or cleaning agents. This application concerns in particular detergents or cleaning agents containing anionic, cationic, or amphoteric polymers.

Detergents or cleaning agents are available to consumers today in numerous presentation forms. In addition to powdered and granulated detergents, this presentation also comprises, for example, cleaning agent concentrates in the form of extruded or tableted compositions. These solid, concentrated, or densified presentation forms are characterized by a decreased volume per dispensed unit, and therefore reduce the costs for packaging and transport. The detergent or cleaning agent tablets, in particular, additionally meet consumers' desire for simple dispensing. The corresponding agents are comprehensively described in the existing art.

In addition to the solid presentation forms described, detergents or cleaning agents can also be formulated as gels or pastes.

(2) Description of Related Art, Including Information Disclosed Under 37 C.F.R. §§ 1.97 and 1.98.

Issued European Patent EP 331 370 (Unilever), for example, discloses a method for producing stable, viscous, liquid compositions for use in automatic dishwashers.

The subject matter of European Patent EP 797 656 (Unilever) is nonaqueous liquid detergent compositions that contain polymeric hydrotropes.

In addition to other materials, water-soluble or water-dispersible films are also, in particular, suitable for packaging solid or liquid detergents or cleaning agents. The cleaning agents, packaged in this fashion into individual dispensing units, can easily be dispensed by placing one or more pouches directly into the washing machine or dishwasher or its dispenser, or by dropping it into a predetermined quantity of water, for example in a bucket or a hand washing or rinsing tub. Packaged detergents and cleaning agents of this kind are the subject matter of numerous publications.

Issued European Patent EP 700 989 B1, for example, claims a cleaning agent for dishwashing that is packaged as a unit, the cleaning agent packaged as a unit being encased by a packaging that is made of a water-soluble material and is sticky on its outer side.

Application WO 02/16222 (Reckitt-Benckiser) discloses water-soluble packagings for aqueous cleaning agent compositions whose free water content is at least 3 wt %.

The subject matter of WO 02/16541 (Reckitt-Benckiser) is liquid cleaning agent compositions having a water content between 20 and 50 wt %, which are present packaged in a water-soluble or water-dispersible material, comprise at least one polyphosphate builder, and are characterized by a specific ratio of the potassium and sodium ions contained in the agent.

Despite the many publications in the detergent or cleaning agent sector, a need still exists for improvement of the cleaning performance of these agents, in particular while maintaining or reducing the amounts of active detergent or cleaning substances that are used for each washing or cleaning cycle.

A first object of the present invention was to improve the cleaning performance of detergents or cleaning agents. The intention was both to improve the elimination of stains, and to enhance the effect of additives such as glass or silver protection agents.

A further object of the present invention was to make available a high-density detergent or cleaning agent that simultaneously exhibits high solubility. Solid detergents or cleaning agents should furthermore exhibit good dimensional stability as well as a low tendency toward breakage. Highly densified detergents or cleaning agents of this kind occupy a reduced volume relative to one dispensing unit, and are therefore compatible with a larger number of dispensing chambers of commercially available washing machines or dishwashers.

Lastly, the intention was to make available a formulated form for detergents or cleaning agents that can easily be processing for shaping purposes, a particular intention being to circumvent limitations in terms of the three-dimensional shape of the formulated agent that are typical, for example, for formulating methods such as tableting.

It has been found that at least some of the aforesaid objects can be achieved by detergent or washing agent dispersions in the form of a dispersion, the dispersed materials comprising anionic, cationic, or amphoteric polymers.

### BRIEF SUMMARY OF THE INVENTION

A first subject of the present application is therefore a detergent or cleaning agent in the form of a dispersion of solid particles in a dispersion agent, which dispersion comprises, based on its total weight,

i) 10 to 65 wt % dispersion agent and

ii) 30 to 90 wt % dispersed materials,

wherein the dispersed materials contain, based on their total weight, 0.1 to 50 wt % of an anionic and/or cationic and/or amphoteric polymer.

### BRIEF DESCRIPTION OF THE SEVERAL VIEWS OF THE DRAWING(S)

Not Applicable

### DETAILED DESCRIPTION OF THE INVENTION

What is referred to as a “dispersion” in this application is a system made up of multiple phases, of which one is continuous (dispersion agent) and at least one further one is finely distributed (dispersed materials).

Particularly preferred detergents or cleaning agents according to the present invention are characterized in that they contain the dispersion agent in amounts above 11 wt %, preferably 13 wt %, particularly preferably above 15 wt %, very particularly preferably above 17 wt % and in particular above 19 wt %, in each case based on the total weight of the dispersion. Additionally achievable and likewise preferred are agents according to the present invention that comprise a dispersion having a weight proportion of dispersion agent above 20 wt %, preferably above 21 wt % and in particular above 22 wt %, in each case based on the total weight of the dispersion. The maximum dispersion-agent content of preferred dispersions according to the present invention, based on the total weight of the dispersion, is by preference less than 63 wt %, preferably less than 57 wt %, particularly preferably less than 52 wt %, very particularly preferably less than 47 wt %, and in particular less than 37 wt %. Those detergents or cleaning agents that contain dispersion agent in amounts from 12 to 62 wt %, preferably from 17 to 49 wt %, and in particular from 23 to 38 wt %, based on their total weight, are particularly preferred in the context of the present invention.

The dispersing agents that are used are preferably water-soluble or water-dispersible. The solubility of these dispersion agents at 25° C. is by preference more than 200 g/l, preferably more than 300 g/l, particularly preferably more than 400 g/l, very particularly preferably between 430 and 620 g/l, and in particular between 470 and 580 g/l.

The water-soluble or water-dispersible polymers, in particular the water-soluble or water-dispersible nonionic polymers, are preferably suitable as dispersion agents in the context of the present invention. The dispersion agent can be both a single polymer and a mixture of different water-soluble or water-dispersible polymers. In a further preferred embodiment of the present invention, the dispersion agent or at least 50 wt % of the polymer mixture comprises water-soluble or water-dispersible nonionic polymers from the group of the polyvinylpyrrolidones, vinylpyrrolidone/vinyl ester copolymers, cellulose ethers, polyvinyl alcohols, polyalkylene glycols, in particular polyethylene glycol and/or polypropylene glycol.

Polyvinylpyrrolidones are preferred dispersion agents in the context of the invention. Polyvinylpyrrolidones [poly(1-vinyl-2-pyrrolidones)], abbreviated PVP, are polymers of the general formula I 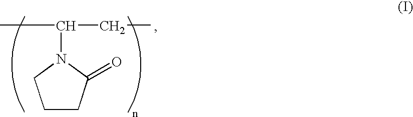
that are produced by radical polymerization of 1-vinylpyrrolidone in accordance with solution or suspension polymerization methods using radical formers (peroxides, azo compounds) as initiators. Ionic polymerization of the monomer yields only products having low molar weights. Commercially usual polyvinylpyrrolidones have molar weights in the range from approx. 2500 to 750,000 g/mol; they are characterized by indicating K values, and possess glass transition temperatures of 130-175° C. (depending on K value). They are presented as white, hygroscopic powders or as aqueous solutions. Polyvinylpyrrolidones are readily soluble in water and a plurality of organic solvents (alcohols, ketones, glacial acetic acid, chlorinated hydrocarbons, phenols, and others).

Vinylpyrrolidone/vinyl ester copolymers, such as those marketed under the trademark Luviskol® (BASF), Luviskol® VA 64 and Luviskol® VA 73, which are each vinylpyrrolidone/vinyl ester copolymers, are particularly preferred nonionic polymers.

The vinyl ester polymers are polymers, accessible from vinyl esters, having the grouping of formula (II) 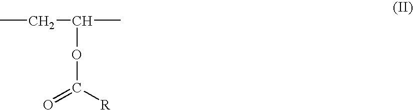
as a characteristic basic module of the macromolecule. Of these, the vinyl acetate polymers (R═CH₃) with polyvinyl acetates are the representatives having by far the greatest industrial importance.

Polymerization of the vinyl esters is accomplished radically in accordance with various methods (solution polymerization, suspension polymerization, emulsion polymerization, substance polymerization). Copolymers of vinyl acetate with vinylpyrrolidone contain monomer units of formulas (I) and (II).

Cellulose ethers, such as hydroxypropylcellulose, hydroxyethylcellulose, and methylhydroxypropylcellulose, such as those marketed, for example, under the trademarks Culminal® and Benecel® (AQUALON).

Cellulose ethers can be described by the following general formula: 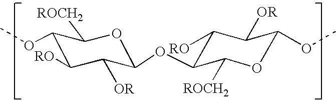
in which R denotes H or an alkyl, alkenyl, alkinyl, aryl, or alkylaryl radical. In preferred products, at least one R in the formula denotes —CH₂CH₂CH₂—OH or —CH₂CH₂—OH. Cellulose ethers are produced industrially by the etherification of alkaline celluloses (e.g. with ethylene oxide). Cellulose ethers are characterized by way of the average degree of substitution DS or the molar degree of substitution MS, which indicate respectively how many hydroxy groups of an anhydroglucose unit of the cellulose have reacted with the etherification reagent, and how many moles of the etherification reagent have attached, on average, to an anhydroglucose unit. Hydroxyethylcelluloses are water-soluble above a DS of approximately 0.6 or an MS of approximately 1. Commercially usual hydroxyethyl- and hydroxypropylcelluloses have degrees of substitution in the range of 0.85-1.32 (DS) or 1.5-3 (MS). Hydroxyethyl- and propylcelluloses are marketed as yellowish-white, odorless and tasteless powders, in a wide variety of degrees of polymerization. Hydroxyethyl- and propylcelluloses are soluble in cold and hot water and in some (hydrous) organic solvents, but insoluble in most (anhydrous) organic solvents; their aqueous solutions are relatively insensitive to changes in pH or electrolyte addition.

Polyvinyl alcohols, abbreviated PVALs, are polymers of the general structure
[—CH₂—CH(OH)—]ₙ
which also contain small proportions of structural units of the
[—CH₂—CH(OH)—CH(OH)—CH₂]
type. Because the corresponding monomer (vinyl alcohol) is not stable in its free form, polyvinyl alcohols are produced by means of polymer-analogous reactions by hydrolysis, but industrially, in particular, by alkaline-catalyzed transesterification of polyvinyl acetates with alcohols (preferably methanol) in solution. These industrial methods also provide access to PVALs that contain a predefinable residual proportion of acetate groups.

Commercially available PVALs (e.g. Mowiol® grades of Hoechst) are sold as yellowish-white powders or granulates having degrees of polymerization in the range of approx. 500-2500 (corresponding to molar weights of approx. 20,000-100,000 g/mol), and have various degrees of hydrolysis from 98 to 99 or 87 to 89 mol %. They are therefore partially saponified polyvinyl acetates having a residual acetyl-group content of approx. 1-2 or 11-13 mol %.

Polyethylene glycols and polypropylene glycols are particularly suitable as polyalkylene glycols. Polymers of ethylene glycol that conform to the general formula III
H—(O—CH₂—CH₂)ₙ—OH (III),
where n can assume values between 1 (ethylene glycol) and several thousand. Various nomenclatures exist for polyethylene glycols, and can result in confusion. The common industrial practice is to indicate the average relative molecular weight following the term “PEG”, so that “PEG 200” characterizes a polyethylene glycol having a relative molar weight of approximately 190 to approximately 210. For cosmetic ingredients a different nomenclature is used, in which the abbreviation PEG has a hyphen added to it, and the hyphen is followed directly by a number corresponding to the number n in the above formula VII. According to this nomenclature (so-called INCI nomenclature, CTFA International Cosmetic Ingredient Dictionary and Handbook, 5th Edition, The Cosmetic, Toiletry and Fragrance Association, Washington, 1997), for example, PEG-4, PEG-6, PEG-8, PEG-9, PEG-10, PEG-12, PEG-14, and PEG-16 are usable. Polyethylene glycols are available commercially, for example, under the trade names Carbowax® PEG 200 (Union Carbide), Emkapol200 (ICI Americas), Lipoxol® 200 MED (Huls America), Polyglycol® E-200 (Dow Chemical), Alkapol® PEG 300 (Rh6ne-Poulenc), Lutrol® E300 (BASF), and the corresponding trade names with higher numbers. The average relative molecular weight of at least one of the dispersion agents used in the detergents or cleaning agents according to the present invention, in particular in the poly(alkylene) glycols that are used, is by preference between 200 and 36,000, preferably between 200 and 6000, and particularly preferably between 300 and 5,000.

Polypropylene glycols (abbreviated PPG) are polymers of propylene glycol that conform to the general formula IV 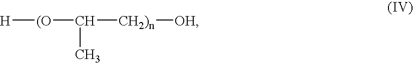
in which n can assume values between 1 (propylene glycol) and several thousand. Di-, tri-, and tetrapropylene glycol, i.e. the representatives for which n=2, 3, and 4 in formula IV, are of particular industrial significance.

Particularly preferred detergents or cleaning agents according to the present invention contain as a dispersion agent at least one nonionic polymer, by preference a poly(alkylene)glycol, preferably a poly(ethylene)glycol and/or a poly(propylene)glycol, the weight proportion of the poly(ethylene)glycol in terms of the total weight of all dispersion agents being preferably between 10 and 90 wt %, particularly preferably between 30 and 80 wt %, and in particular between 50 and 70 wt %. Particularly preferred are detergents or cleaning agents according to the present invention in which more than 92 wt %, by preference more than 94 wt %, particularly preferably more than 96 wt %, very particularly preferably more than 98 wt %, and in particular 100 wt % of the dispersion agent is made up of a poly(alkylene)glycol, preferably poly(ethylene)glycol and/or poly(propylene)glycol, but in particular poly(ethylene)glycol. Dispersion agents that also contain poly(propylene)glycol in addition to poly(ethylene)glycol exhibit a ratio of the weight proportions of poly(ethylene)glycol to poly(propylene)glycol by preference between 40:1 and 1:2, preferably between 20:1 and 1:1, particularly preferably between 10:1 and 1.5:1, and in particular between 7:1 and 2:1.

Further preferred dispersion agents are the nonionic surfactants, which can be used both alone but particularly preferably in combination with a nonionic polymer.

The nonionic surfactants used are preferably alkoxylated, advantageously ethoxylated, in particular primary alcohols having preferably 8 to 18 carbon atoms and an average of 1 to 12 mol ethylene oxide (EO) per mol of alcohol, in which the alcohol radical can be linear or preferably methyl-branched in the 2- position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethyoxylated alcohols include, for example, C₁₂₋₁₄ alcohols with 3 EO or 4 EO, C₉₋₁₁ alcohol with 7 EO, C₁₃₋₁₅ alcohols EO, 5 EO,7EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be an integer or a fraction for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Also usable as further nonionic surfactants are alkyl glycosides of the general formula RO(G)ₓ, in which R denotes a primary straight-chain or methyl-branched (in particular methyl-branched in the 2- position) aliphatic radical having 8 to 22, preferably 12 to 18 carbon atoms; and G is the symbol denoting a glycose unit having 5 or 6 carbon atoms, preferably glucose. The degree of oligomerization x, which indicates the distribution of monoglycosides and oligoglycosides, is any number between 1 and 10; preferably x is between 1.2 and 1.4.

A further class of nonionic surfactants used in preferred fashion, which are used either as the only nonionic surfactant or in combination with other nonionic surfactants, is alkoxylated, preferably ethoxylated or ethoxylated and propoxylated, fatty acid alkyl esters, preferably having 1 to 4 carbon atoms in the alkyl chain.

Nonionic surfactants of the aminoxide type, for example N-cocalkyl-N,N-dimethylaminoxide and N-tallowalkyl-N,N-dihydroxyethylaminoxide, and the fatty acid alkanolamides, can also be suitable. The amount of these nonionic surfactants is preferably no more than that of the ethoxylated fatty alcohols, in particular no more than half thereof.

Further suitable surfactants are polyhydroxy fatty acid amides of formula (V) 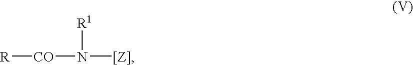
in which RCO denotes an aliphatic acyl radical having 6 to 22 carbon atoms; R¹ denotes hydrogen, an alkyl or hydroxyalkyl radical having 1 to 4 carbon atoms; and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of the following formula 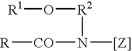
in which R denotes a linear or branched alkyl or alkylene radical having 7 to 12 carbon atoms; R¹ denotes a linear, branched, or cyclic alkyl radical or an aryl radical having 2 to 8 carbon atoms; and R² denotes a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a reducing sugar, for example glucose, fructose, maltose, lactose, galactose, mannose, or xylose. The N-alkoxy- or N-aryloxy-substituted compounds can be converted into the desired polyhydroxy fatty acid amides by reaction with fatty acid methyl esters in the presence of an alkoxide as catalyst.

Low-foaming nonionic surfactants are used as preferred surfactants. Particularly preferably, the cleaning agents according to the present invention for automatic dishwashing contain nonionic surfactants, in particular nonionic surfactants from the groups of the alkoxylated alcohols. The nonionic surfactants used are preferably alkoxylated, advantageously ethoxylated, in particular primary alcohols having preferably 8 to 18 carbon atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethyoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be an integer or a fraction for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Agents according to the present invention containing a nonionic surfactant that has a melting point above room temperature are particularly preferred. Preferred dishwashing agents are consequently characterized in that they contain nonionic surfactant(s) having a melting point above 20° C., preferably above 25° C., particularly preferably between 25 and 60° C., and in particularly between 26.6 und 43.3° C.

Suitable nonionic surfactants that exhibit melting or softening points in the aforesaid temperature range are, for example, low-foaming nonionic surfactants that can be solid or highly viscous at room temperature. If nonionic surfactants that are highly viscous at room temperature are used, it is preferred for them to exhibit a viscosity above 20 Pas, preferably above 35 Pas, and in particular above 40 Pas. Nonionic surfactants that possess a waxy consistency at room temperature are also preferred.

Nonionic surfactants that are solid at room temperature and are preferred for use derive from the groups of the alkoxylated nonionic surfactants, in particular the ethoxylated primary alcohols, and mixtures of these surfactants with structurally more complex surfactants such as polyoxypropylene / polyoxyethylene / polyoxypropylene (PO/EO/PO) surfactants. Such (PO/EO/PO) nonionic surfactants are moreover characterized by good foam control.

In a preferred embodiment of the present invention, the nonionic surfactant having a melting point above room temperature is an ethoxylated nonionic surfactant that has resulted from the reaction of a monohydroxyalkanol or alkyl phenol having 6 to 20 carbon atoms with preferably at least 12 mol, particularly preferably at least 15 mol, in particular at least 20 mol, of ethylene oxide per mol of alcohol or alkyl phenol.

A nonionic surfactant that is solid at room temperature and is particularly preferred for use is obtained from a straight-chain fatty alcohol having 16 to 20 carbon atoms (C₁₆₋₂₀ alcohol), preferably a C₁₈ alcohol, and at least 12 mol, preferably at least 15 mol, and in particular at least 20 mol of ethylene oxide. Of these, the so-called “narrow range ethoxylates” (see above) are particularly preferred.

Accordingly, particularly preferred dishwashing agents according to the present invention contain ethoxylated nonionic surfactant(s) that was/were obtained from C₆₋₂₀ monohydroxyalkanols or C₆₋₂₀ alkyl phenols or C₁₆₋₂₀ fatty alcohols and more than 12 mol, preferably more than 15 mol, and in particular more than 20 mol ethylene oxide per mol of alcohol.

The nonionic surfactant that is solid at room temperature preferably additionally possesses propylene oxide units in the molecule. Such PO units preferably constitute up to 25 wt %, particularly preferably up to 20 wt %, and in particular up to 15 wt % of the entire molar weight of the nonionic surfactant. Particularly preferred nonionic surfactants are ethoxylated monohydroxyalkanols or alkyl phenols that additionally comprise polyoxyethylene-polyoxypropylene block copolymer units. The alcohol or alkyl phenol portion of such nonionic surfactant molecules preferably makes up more than 30 wt %, particularly preferably more than 50 wt %, and in particular more than 70 wt % of the total molar weight of such nonionic surfactants. Preferred dishwashing agents are characterized in that they contain ethoxylated and propoxylated nonionic surfactants in which the propylene oxide units in the molecule constitute up to 25 wt %, preferably up to 20 wt %, and in particular up to 15 wt % of the total molar weight of the nonionic surfactant.

Additional nonionic surfactants having melting points above room temperature that are particularly preferred for use contain 40 to 70% of a polyoxypropylene/polyoxyethylene/polyoxypropylene block polymer blend, which contains 75 wt % of a reverse block copolymer of polyoxyethylene and polyoxypropylene having 17 mol ethylene oxide and 44 mol propylene oxide, and 25 w % of a block copolymer of polyoxyethylene and polyoxypropylene, initiated with trimethylolpropane and containing 24 mol ethylene oxide and 99 mol propylene oxide per mol of trimethylolpropane.

Nonionic surfactants that can be used with particular preference are obtainable, for example, from Olin Chemicals under the name Poly Tergent® SLF-18.

A further preferred dishwashing agent according to the present invention contains nonionic surfactants of the formula (VI)
R¹O[CH₂CH(CH₃)O]ₓ[CH₂CH₂O]_{y}[CH₂CH(OH)R²], (VI)
in which R denotes a linear or branched aliphatic hydrocarbon radical having 4 to 18 carbon atoms, or mixtures thereof; R² a linear or branched hydrocarbon radical having 2 to 26 carbon atoms, or mixtures thereof: and x denotes values between 0.5 and 1.5 and y denotes a value of at least 15.

Additional nonionic surfactants that are usable in preferred fashion are the end-capped poly(oxyalkylated) nonionic surfactants of the following formula:
R¹O[CH₂CH(R³)O]ₓ[CH₂]ₖCH(OH)[CH₂]ⱼOR²
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, preferably between 1 and 5. If the value of x≧2, each R³ in the formula above can be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the R³ radical, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit in the square brackets can thereby be varied. If, for example, x denotes 3, the R³ radical can be selected so as to form ethylene oxide (R³═H) or propylene oxide (R³═CH₃) units, which can be joined onto one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g. a large number of (EO) groups combined with a small number of (PO) groups, or vice versa.

Particularly preferred end-capped poly(oxyalkylated) alcohols of the above formula have values of k=1 and j=1, so that the formula above is simplified to
R¹O[CH₂CH(R³)O]ₓCH₂CH(OH)CH₂OR²
In the latter formula, R¹, R², and R³ are as defined above, and x denotes numbers from 1 to 30, preferably from 1 to 20, and in particular from 6 to 18. Surfactants in which the R¹ and R² radicals have 9 to 14 carbon atoms, R³ denotes H, and x assumes values from 6 to 15, are particularly preferred.

Summarizing what has just been stated, preferred dishwashing agents according to the present invention are those containing end-capped poly(oxyalkylated) nonionic surfactants of the formula
R¹O[CH₂CH(R³)O]ₓ[CH₂]ₖCH(OH)[CH₂]ⱼOR²
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30, and k and j denote values between 1 and 12, preferably between 1 and 5, surfactants of the following type:
R¹O[CH₂CH(R³)O]ₓCH₂CH(OH)CH₂OR²
in which x denotes numbers from 1 to 30, preferably from 1 to 20, and in particular from 6 to 18, being particularly preferred.

Nonionic surfactants that comprise alternating ethylene-oxide and alkylene-oxide units have proven to be particularly preferred nonionic surfactants in the context of the present invention. Among these in turn, surfactants having EO-AO-EO-AO blocks are preferred, one to ten EO or AO groups being connected to one another in each case before being followed by a block of the respectively other groups. Preferred here are automatic dishwashing agents according to the present invention that contain, as nonionic surfactant(s), surfactants of the general formula VII: 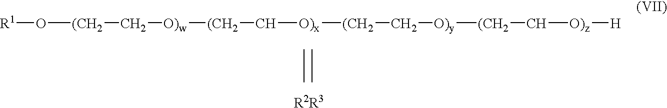
in which R¹ denotes a straight-chain or branched, saturated, or singly or multiply unsaturated C₆₋₂₄ alkyl or alkenyl radical; each R² and R³ group, independently of one another, is selected from —CH₃, —CH₂CH₃, —CH₂CH₂—CH₃, CH(CH₃)₂; and the indices w, x, y, and z denote, independently of one another, integers from 1 to 6.

The preferred nonionic surfactants of formula VII can be produced, using known methods, from the corresponding alcohols R¹—OH and ethylene or alkylene oxide. The R¹ radical in the above formula VII can vary depending on the derivation of the alcohol. If natural sources are used, the R¹ radical has an even number of carbon atoms and is generally unbranched, the linear radicals from alcohols of natural origin having 12 to 18 carbon atoms, e.g. from coconut, palm, tallow, or oleyl alcohol, being preferred. Alcohols accessible from synthetic sources are, for example, the Guerbet alcohols or radicals methyl-branched in the 2-position or mixed linear and methyl-branched radicals, such as those usually present in oxo alcohol radicals. Regardless of the nature of the alcohol used for production of the nonionic surfactants contained according to the present invention in the agents, automatic dishwashing agents according to the present invention in which R¹ in formula VII denotes an alkyl radical having 6 to 24, preferably 8 to 20, particularly preferably 9 to 15, and in particular 9 to 11 carbon atoms, are preferred.

In addition to propylene oxide, butylene oxide in particular is a possibility as an alkylene oxide unit that is contained, alternatingly with the ethylene oxide unit, in the preferred nonionic surfactants. Further alkylene oxides, in which R² and R³, independently of one another, are selected from —CH₂CH₂—CH₃ or CH(CH₃)₂, are, however also suitable. Preferred automatic dishwashing agents are characterized in that R² and R³ denote a —CH₃ radical; w and x, independently of one another, denote values of 3 or 4; and y and z, independently of one another, denote values of 1 or 2.

In summary, nonionic surfactants that comprise a C₉₋₁₅ alkyl radical having 1 to 4 ethylene oxide units, followed by 1 to 4 propylene oxide units, followed by 1 to 4 ethylene oxide units, followed by 1 to 4 propylene oxide units, are preferred for use in the agents according to the present invention. These surfactants exhibit the necessary low viscosity in aqueous solution, and are usable with particular preference according to the present invention.

Additional nonionic surfactants that are usable in preferred fashion are the end-capped poly(oxyalkylated) nonionic surfactants of formula (VIII)
R¹O[CH₂CH(R³)O]ₓR² (VIII)
in which R¹ denotes linear or branched, saturated or unsaturated, aliphatic or aromatic hydrocarbon radicals having 1 to 30 carbon atoms; R² denotes linear or branched, saturated or unsaturated, aliphatic or aromatic hydrocarbon radicals having 1 to 30 carbon atoms, which preferably comprise between 1 and 5 hydroxy groups and preferably are further functionalized with an ether group; R³ denotes H or a methyl, ethyl, n-propyl, isopropyl, n-butyl, 2-butyl, or 2-methyl-2-butyl radical; and x denotes values between 1 and 40.

In particularly preferred nonionic surfactants of the above formula (VIII), R³ denotes H. In the context of the resulting end-capped poly(oxyalkylated) nonionic surfactants of formula (IX)
R¹O[CH₂CH₂O]ₓR² (IX),
those nonionic surfactants in which in which R¹ denotes linear or branched, saturated or unsaturated, aliphatic or aromatic hydrocarbon radicals having 1 to 30 carbon atoms, preferably having 4 to 20 carbon atoms; R² denotes linear or branched, saturated or unsaturated, aliphatic or aromatic hydrocarbon radicals having 1 to 30 carbon atoms, which preferably comprise between 1 and 5 hydroxy groups; and x denotes values between 1 and 40, are particularly preferred.

Particularly preferred are those end-capped poly(oxyalkylated) nonionic surfactants that, in accordance with formula (X)
R¹O[CH₂CH₂O]ₓCH₂CH(OH)R² (X),
in addition to a R¹radical that denotes linear or branched, saturated or unsaturated, aliphatic or aromatic hydrocarbon radicals having 1 to 30 carbon atoms, preferably having 4 to 20 carbon atoms, additionally comprise a linear or branched, saturated or unsaturated, aliphatic or aromatic hydrocarbon radical having 1 to 30 carbon atoms R² which is adjacent to a monohydroxylated intermediate group —CH₂CH(OH)—. In this formula, x denotes values between 1 and 40. End-capped poly(oxyalkylated) nonionic surfactants of this kind can be obtained, for example, by reacting an end-position epoxide of formula R²CH(O)CH₂ with an ethoxylated alcohol of formula R¹O[CH₂CH₂O]ₓ₋₁CH₂CH₂OH.

The carbon chain lengths, degrees of ethoxylation, and degrees of alkoxylation indicated for the aforesaid nonionic surfactants constitute statistical averages, which may be an integer or a fractional number for a specific product. As a result of production methods, commercial products of the aforesaid formulas are usually made up not of an individual representative, but rather of mixtures, so that average values and, as a consequence, fractional numbers can result both for the carbon chain lengths and for the degrees of ethoxylation and degrees of alkoxylation.

Particularly preferred detergents or cleaning agents according to the present invention contain as a dispersion agent at least one nonionic surfactant, preferably at least one end-capped poly(oxyalkylated) nonionic surfactant, the weight proportion of the nonionic surfactant in terms of the total weight of all dispersion agents being preferably between 1 and 60 wt %, particularly preferably between 2 and 50 wt %, and in particular between 3 and 40 wt %. Particularly preferred are detergents or cleaning agents according to the present invention in which the total weight of the nonionic surfactant(s) in terms of the total weight of the agent according to the present invention is between 0.5 and 40 wt %, preferably between 1 and 30 wt %, particularly preferably between 2 and 25, and in particular between 2.5 and 23 wt %.

Preferred detergents or cleaning agents according to the present invention are characterized in that at least one dispersion agent has a melting point above 25° C., preferably above 35° C., in particular above 40° C. Agents of this kind can thus contain, for example, a dispersion agent having a melting point above 26° C., or above 27° C., or above 28° C., or above 29° C., or above 30° C., or above 31° C., or above 32° C., or above 33° C., or above 34° C., or above 35° C., or above 36° C., or above 37° C., or above 38° C, or above 39° C., or above 40° C., or above 41° C., or above 42° C., or above 43° C., or above 44° C., or above 45° C., or above 46° C., or above 47° C., or above 48° C., or above 49° C., or above 50° C. It is particularly preferred to use dispersion agents having a melting point or melting range between 30 and 80° C., preferably between 35 and 75° C., particularly preferably between 40 and 70° C., and in particular between 45 and 65° C., these dispersion agents comprising a weight proportion, based on the total weight of the dispersion agents used, above 10 wt %, preferably above 40 wt %, particularly preferably above 70 wt %, and in particular between 80 and 100 wt %.

Preferred agents according to the present invention are dimensionally stable at 20° C. Agents according to the present invention are considered dimensionally stable if they exhibit an inherent dimensional stability which enables them to assume a non-disintegrating three-dimensional shape under usual conditions of production, storage, transport, and handling by the consumer, in which context that three-dimensional shape does not change under the aforesaid conditions even over a longer period, preferably 4 weeks, particularly preferably 8 weeks, and in particular 32 weeks, i.e., under the usual conditions of production, storage, transport, and handling by the consumer, remains in the three-dimensional geometric shape conditioned by production, i.e. does not deliquesce. The dimensionally stable agents include not only agents having a hard surface but also “kneadable” agents. Agents preferred according to the present invention are dimensionally stable at temperatures up to 22° C., preferably up to 25° C., particularly preferably up to 30° C., and in particular up to 35° C.

In a further preferred embodiment, the detergents or washing agents according to the present invention contain at least one dispersion agent having a melting point below 15° C., preferably below 12° C., and in particular below 8° C. Particularly preferred dispersion agents have a melting range between 2 and 14° C., in particular between 4 and 10° C. Based on the total weight of the dispersion agents, the weight proportion in the agents according to the present invention of these low-melting-point dispersion agents, i.e. dispersion agents having a melting point below 15° C., is by preference more than 30 wt %, preferably more than 50 wt %, particularly preferably between 70 and 100%, very particularly preferably between 80 and 98 wt %, and in particular between 88 and 96 wt %. Agents according to the present invention having a proportion of such low-melting-point dispersion agents can be free-flowing. Detergents or cleaning agents according to the present invention that are free-flowing at 20° C. are particularly preferred in the context of the present invention. Preferred ones are characterized in that the dispersion is a liquid (20° C.), preferably a liquid having a viscosity (Brookfield LVT-II viscosimeter at 20 rpm and 20° C., spindle 3) from 50 to 100,000 mPas, preferably from 100 to 50,000 mpas, particularly preferably from 200 to 10,000 mPas, and in particular from 300 to 5000 mpas.

The agents according to the present invention contain, based on their total weight, 0.1 to 50 wt % of an anionic and/or cationic and/or amphoteric polymer as dispersed materials. Detergents or cleaning agents that are particularly preferred in the context of the present application are characterized in that the dispersed materials contain, based on their total weight, between 0.2 and 40 wt %, preferably between 0.4 and 35 wt %, and in particular between 0.6 and 31 wt % of an anionic and/or cationic and/or amphoteric polymer.

Very particularly preferred are detergents or cleaning agents according to the present invention in which the dispersed materials contain, based on their total weight, between 0.2 and 40 wt %, preferably between 0.4 and 35 wt %, and in particular between 0.6 and 31 wt % of an anionic polymer.

All acid group-containing polymers, for example, are usable in principle as anionic polymers. The polymers can be present in non-neutralized, partially neutralized, or completely neutralized form. The use of partial neutralizates is, however, preferred. Preferred polymers comprise at least one monomer from the group of the carboxylic acids and/or the sulfonic acids and/or the phosphonic acids.

The group of the polymers that comprise at least one monomer from the group of the carboxylic acids includes, for example, the polymeric polycarboxylates, but also acid-modified polysaccharides such as carboxymethylcellulose.

In addition, polymeric polycarboxylates are suitable, in particular, as polymers. Polymeric polycarboxylates are, for example, the alkali metal salts of polyacrylic acid or of polymethacrylic acid, for example those having a relative molecular weight of 500 to 70,000 g/mol.

The molar weights indicated for polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that, because of its structural relationship to the polymers being investigated, yielded realistic molecular weight values. These indications deviate considerably from the molecular weight indications in which polystyrenesulfonic acids are used as the standard. The molar weights measured against polystyrenesulfonic acids are usually much higher than the molar weights indicated in this document.

Suitable polymers are, in particular, polyacrylates that preferably have a molecular weight from 2000 to 20,000 g/mol. Because of their superior solubility, of this group the short-chain polyacrylates that have molar weights from 2000 to 10,000 g/ml, and particularly preferably from 3000 to 5000 g/mol, may in turn be preferred.

Copolymeric polycarboxylates, in particular those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, preferably 20,000 to 50,000 g/mol, and in particular 30,000 to 40,000 g/mol.

To improve water solubility, the polymers can also contain allylsulfonic acids, for example allyloxybenzenesulfonic acid and methallylsulfonic acid, as monomers.

Also particularly preferred are biodegradable polymers made up of more than two different monomer units, for example those that contain salts of acrylic acid and of maleic acid, as well as vinyl alcohol or vinyl alcohol derivatives, as monomers, or that contain salts of acrylic acid and of 2-alkylallylsulfonic acid, as well as sugar derivatives, as monomers.

Further preferred copolymers are those that have, as monomers, preferably acrolein and acrylic acid/acrylic acid salts, or acrolein and vinyl acetate.

It is particularly advantageous if the detergents or cleaning agents according to the present invention contain, in the context of the present application, polymers that comprise as monomer an ethylenically unsaturated monomeric carboxylic acid of the general formula XI,
R¹(R²)C═C(R³)COOH (XI),
in which R¹ to R³, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms.

Particularly preferred polymers contain at least one monomer from the group of the sulfonic acids.

Usable in particular preferred fashion as sulfonic acid group-containing polymers are copolymers of unsaturated carboxylic acids, sulfonic acid group-containing monomers, and optionally further ionic or nonionogenic monomers.

Preferred as monomers in the context of the present invention are unsaturated carboxylic acids of formula XII,
R¹(R²)C═C(R³)COOH (XII),
in which R¹to R³, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms.

Among the unsaturated carboxylic acids that can be described by formula XIII, acrylic acid (R¹═R²═R³═H), methacrylic acid (R¹═R²═H; R³═CH₃) and/or maleic acid (R¹═COOH; R²═R³═H) are particularly preferred.

Of the sulfonic acid group-containing monomers, those of formula XIII are preferred
R⁵(R⁶)C═C(R⁷)—X—SO₃H V),
in which R⁵ to R⁷, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms; and X denotes an optionally present spacer group that is selected from —CH₂)ₙ— where n=0 to 4, —COO—(CH₂)ₖ— where k=1 to 6, —C(O)—NH—C(CH₃)₂—, and —C(O)—NH—CH(CH₂CH₃)—.

Preferred among these monomers are those of formulas XIIIa, XIIIb, and/or XIIIc,
H₂C═CH—X—SO₃H (XIIIa),
H₂C═C(CH₃)—X—SO₃H (XIIIb),
HO₃S—X—(R⁶)C═C(R⁷)—X—SO₃H (XIIIc),
in which R⁶ and R⁷, are selected, independently of one another, from —H, —CH₃, —CH₂CH₃, —CH₂CH₂CH₃, —CH(CH₃)₂, and X denotes an optionally present spacer group that is selected from —CH₂)ₙ— where n=0 to 4, —COO—(CH₂)ₖ— where k=1 to 6, —C(O)—NH—C(CH₃)₂—, and —C(O)—N H—CH(CH₂CH₃)—.

Particularly preferred sulfonic acid group-containing monomers in this context are 1-acrylamido-1-propanesulfonic acid (X═—C(O)NH—CH(CH₂CH₃) in formula XIIIa), 2-acrylamido-2-propanesulfonic acid (X═—C(O)NH—C(CH₃)₂ in formula XIIIa), 2-acrylamido-2-methyl-1-propanesulfonic acid (X═—C(O)NH—CH(CH₃)CH₂— in formula XIIIa), 2-methacrylamido-2-methyl-1-propanesulfonic acid (X═—C(O)NH—CH(CH₃)CH₂— in formula XIIIb), 3-methacrylamido-2-hydroxypropanesulfonic acid (X═—C(O)NH—CH₂CH(OH)CH₂— in formula XIIIb.), allylsulfonic acid (X═CH₂ in formula XIIIa), methallylsulfonic acid (X═CH₂ in formula XIIIb), allyloxybenzenesulfonic acid (X═—CH₂—O—C₆H₄— in formula XIIIa), methallyloxybenzenesulfonic acid (X═—CH₂—O—C₆H₄— in formula XIIIb), 2-hydroxy-3-(2-propenyloxy)propanesulfonic acid, 2-methyl-2-propene-1-sulfonic acid (X═CH₂ in formula XIIIb), styrenesulfonic acid (X═C₆H₄ in formula XIIIa), vinylsulfonic acid (X not present in formula Va), 3-sulfopropylacrylate (X═—C(O)NH—CH₂CH₂CH₂— in formula XIIIa), 3-sulfopropylmethacrylate (X═—C(O)NH—CH₂CH₂CH₂— in formula XIIIb), sulfomethacrylamide (X═—C(O)NH— in formula XIIIb), sulfomethylmethacrylamide (X═—C(O)NH—CH₂— in formula XIIIb), and water-soluble salts of the aforesaid acids.

Ethylenically unsaturated compounds, in particular, are suitable as further ionic or nonionogenic monomers. The concentration of monomers of group iii) in the polymers used according to the present invention is preferably less than 20 wt % based on the polymer. Polymers to be used in particularly preferred fashion comprise only monomers of groups i) and ii).

In summary, copolymers of i) unsaturated carboxylic acids of formula XII,
R¹(R²)C═C(R³)COOH (XII),
in which R¹ to R³, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms,

ii) sulfonic acid group-containing monomers of formula XIII:
R⁵(R⁶)C═C(R⁷)—X—SO₃H (XIII),
in which R⁵ to R⁷, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms; and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,

iii) if applicable, further ionic or nonionogenic monomers, are particularly preferred ingredients of the detergents or cleaning agents according to the present invention.

Particularly preferred copolymers are made up of

i) one or more unsaturated carboxylic acids from the group of acrylic acid, methacrylic acid, and/or maleic acid;

ii) one or more sulfonic acid group-containing monomers of formulas XIIIa, XIIIb and/or XIIIc:
H₂C═CH—X—SO₃H (XIIIa),
H₂C═C(CH₃)—X—SO₃H (XIIIb),
HO₃S—X—(R⁶)C═C(R⁷)—X—SO₃H (XIIIc),
in which R⁶ and R⁷, are selected, independently of one another, from —H, —CH₃, —CH₂CH₃, —CH₂CH₂CH₃, —CH(CH₃)₂, and X denotes an optionally present spacer group that is selected from —CH₂)ₙ— where n=0 to 4, —COO—(CH₂)ₖ— where k=1 to 6, —C(O)—NH—C(CH₃)₂—, and C(O)—NH—CH(CH₂CH₃)—,

iii) if applicable, further ionic or nonionogenic monomers.

The copolymers can contain the monomers from groups i) and ii), and if applicable iii), in varying amounts, in which context all representatives of group i) can be combined with all representatives of group ii) and all representatives of group iii). Particularly preferred polymers exhibit certain structural units that are described below.

Preferred, for example, are detergents or cleaning agents according to the present invention which are characterized in that they contain one or more copolymers that contain structural units of formula XIV,
—[CH₂—CHCOOH]ₘ—[CH₂—CHC(O)—Y—SO₃H]ₚ— (XIV),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —O—CH₂)ₙ— where n=0 to 4, —O—C₆H₄)—, —NH—C(CH₃)₂—, or —NH—CH(CH₂CH₃)— being preferred.

These polymers are produced by copolymerization of acrylic acid with a sulfonic acid group-containing acrylic acid derivative. If the sulfonic acid group-containing acrylic acid derivative is copolymerized with methacrylic acid, a different polymer is arrived at, the use of which in the detergent or cleaning agent compositions according to the present invention is likewise preferred, and which is characterized in that the preferred detergent or cleaning agents contain one or more copolymers which contain structural units of formula XV,
—[CH₂—C(CH₃)COOH]ₘ—[CH₂—CHC(O)—Y—SO₃H]ₚ— (XV),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —O—CH₂)ₙ— where n=0 to 4, —O—C₆H₄)—, —NH—C(CH₃)₂—, or —NH—CH(CH₂CH₃)— being preferred.

Entirely analogously, acrylic acid and/or methacrylic acid can also be copolymerized with sulfonic acid group-containing methacrylic acid derivatives, thereby modifying the structural units in the molecule. Detergents or cleaning agents containing one or more copolymers that contain structural units of formula XVI,
—[CH₂—CHCOOH]ₘ—[CH₂—C(CH₃)C(O)—Y—SO₃H]ₚ— (XVI),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —O—CH₂)ₙ— where n=0 to 4, —O—C₆H₄)—, —NH—C(CH₃)₂—, or —NH—CH(CH₂CH₃)— being preferred, are therefore likewise a preferred embodiment of the present invention; preferred in just the same fashion are detergents or cleaning agents which are characterized in that they contain one or more copolymers of formula XVII,
—[CH₂—C(CH₃)COOH]ₘ—[Ch₂—C(CH₃)C(O)—Y-SO₃H]ₚ— (XVII),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —O—CH₂)ₙ— where n=0 to 4, —O—C₆H₄)—, —NH—C(CH₃)₂—, or —NH—CH(CH₂CH₃)— preferred.

Instead of acrylic acid and/or methacrylic acid or as a supplement thereto, maleic acid can also be used as a particularly preferred monomer of group i). This results in detergent or cleaning agent compositions preferred according to the present invention which are characterized in that they contain one or more copolymers that contain structural units of formula XVIII,
—[HOOCCH—CHCOOH]ₘ—[CH₂—CHC(O)—Y—SO₃H]ₚ— (XVIII),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —O—CH₂)ₙ— where n=0 to 4, —O—C₆H₄)—, —NH—C(CH₃)₂—,or —NH—CH(CH₂CH₃)— being preferred; and detergents or cleaning agents which are characterized in that they contain one or more copolymers that contain structural units of formula XIX:
—[HOOCCH—CHCOOH]ₘ—[CH₂—C(CH₃)C(O)O—Y—SO₃H]ₚ— (XIX),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —OCH₂)ₙ— where n=0 to 4, —O—C₆H₄)—, —NH—C(CH₃)₂—, or —NH—CH(CH₂CH₃)— being preferred.

In summary, preferred detergents or cleaning agents according to the present invention are those which contain one or more copolymers that contain structural units of formulas XIV and/or XV and/or XVI and/or XVII and/or XVIII and/or XIX,
—[CH₂—CHCOOH]ₘ—[CH₂—CHC(O)—Y—SO₃H]ₚ— (XIV),
—[CH₂—C(CH₃)COOH]ₘ—[CH₂—CHC(O)—Y—SO₃H]ₚ— (XV),
—[CH₂—CHCOOH]ₘ—[CH₂—C(CH₃)C(O)—Y—SO₃H]ₚ— (XIV),
—[CH₂—C(CH₃)COOH]ₘ—[CH₂—C(CH₃)C(O)—Y—SO₃H]ₚ— (XVII),
—[HOOCCH—CHCOOH]ₘ—[CH₂—CHC(O)—Y—SO₃H]ₚ— (XVIII),
—[HOOCCH—CHCOOH]ₘ—[CH2—C(CH₃)C(O)O—Y—SO₃H]ₚ— (XIX),
in which m and p each denote a natural integer between 1 and 2000, and Y denotes a spacer group that is selected from substituted or unsubstituted aliphatic, aromatic, or araliphatic hydrocarbon radicals having 1 to 24 carbon atoms, spacer groups in which Y denotes —O—CH₂)ₙ— where n=0 to 4, —O—C₆H₄)—, —N—C(CH₃)₂—, or —NH—CH(CH₂CH₃)— being preferred.

The sulfonic acid groups can be present in the polymers entirely or partially in neutralized form, i.e. the acid hydrogen atom of the sulfonic acid group can be exchanged, in some or all sulfonic acid groups, for metal ions, preferably alkali metal ions, and in particular sodium ions. Corresponding detergents or cleaning agents which are characterized in that the sulfonic acid groups are present in the copolymer in partially or entirely neutralized fashion are preferred according to the present invention.

In summary, preferred detergents or cleaning agents according to the present invention are those in which the anionic polymer contained in the dispersed material comprises at least one sulfonic acid group-containing polymer, preferably a copolymer of

(i) unsaturated carboxylic acids;

(ii) sulfonic acid group-containing monomers;

(iii) if applicable, further ionic or nonionogenic monomers.

The monomer distribution of the copolymers used in the detergents or cleaning agents according to the present invention is, in copolymers that contain only monomers from groups i) and ii), preferably 5 to 95 wt % from each of i) and ii), particularly preferably 50 to 90 wt % monomer from group i) and 10 to 50 wt % monomer from group ii), in each case based on the polymer.

For terpolymers, those that contain 20 to 85 wt % monomer from group i), 10 to 60 wt % monomer from group ii), and 5 to 30 wt % monomer from group iii), are particularly preferred.

The molar weight of the sulfo-copolymers described above and used in the detergents or cleaning agents according to the present invention can be varied in order to adapt the properties of the polymers to the desired application. Preferred detergent or cleaning agent compositions are characterized in that the copolymers have molar weights from 2000 to 200,000 gmol⁻¹, preferably from 4000 to 25,000 gmol⁻¹, and in particular from 5000 to 15,000 gmol⁻¹.

Detergents or cleaning agents in which the dispersed materials contain, based on their total weight, between 0.2 and 40 wt %, preferably between 0.4 and 35 wt %, and in particular between 0.6 and 31 wt % of an amphoteric polymer, are very particularly preferred.

Preferred amphoteric polymers contain at least one monomer from the group of the carboxylic acids, preferably of the ethylenically unsaturated carboxylic acids, as well as additionally at least one ethylenically unsaturated monomer unit of the general formula XX,
R¹(R²)C═C(R³)R⁴ (XX),
in which R¹ to R⁴, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, a heteroatomic group having at least one positively charged group, a quaternized nitrogen atom, or at least one amine group having a positive charge in the pH range between 2 and 11, or denotes —COOH or —COOR⁵, R⁵ being a saturated or unsaturated, straight-chain or branched hydrocarbon radical having 1 to 12 carbon atoms.

Examples of the aforesaid (unpolymerized) monomer units of formula XX are diallylamine, methyldiallylamine, dimethyldimethylammonium salts, acrylamidopropyl(trimethyl)ammonium salts (R¹, R², and R³═H, R⁴═C(O)NH(CH₂)₂N⁺(CH₃)₃X⁻), methacrylamidopropyl(trimethyl)ammonium salts (R¹ and R²═H, R³═CH₃ H, R⁴═C(O)NH(CH₂)₂N⁺(CH₃)₃ X⁻).

Particularly preferred amphoteric polymers contain, as monomer units, derivatives of diallylamine, in particular dimethyldiallylammonium salt and/or methacrylamidopropyl(trimethyl)ammonium salt, preferably in the form of the chloride, bromide, iodide, hydroxide, phosphate, sulfate, hydrosulfate, ethyl sulfate, methyl sulfate, mesylate, tosylate, formate, or acetate, in combination with monomer units from the group of the ethylenically unsaturated carboxylic acids.

Other particularly preferred anionic or amphoteric polymers contain at least one monomer from the group of the carboxylic acids, and furthermore at least one monomer from the group of the phosphonic acids.

Also preferred are detergents or cleaning agents according to the present invention in which the dispersed materials contain, based on their total weight, between 0.2 and 40 wt %, preferably between 0.4 and 35 wt %, and in particular between 0.6 and 31 wt % of a cationic polymer.

Preferred cationic polymers contain at least one ethylenically unsaturated monomer unit of the general formula XXI,
R¹ (R²)C═C(R³)R⁴ (XXI),
in which R¹ to R⁴, independently of one another, denote —H, —CH₃, a straight-chain or branched saturated alkyl radical having 2 to 12 carbon atoms, a straight-chain or branched, singly or multiply unsaturated alkenyl radical having 2 to 12 carbon atoms, alkyl or alkenyl radicals as defined above substituted with —NH₂, —OH, or —COOH, a heteroatomic group having at least one positively charged group, a quaternized nitrogen atom, or at least one amine group having a positive charge in the pH range between 2 and 11, or denotes —COOH or —COOR⁵, R⁵ being a saturated or unsaturated, straight-chain or branched hydrocarbon radical having 1 to 12 carbon atoms.

Examples of the aforesaid (unpolymerized) monomer units of formula XXI are diallylamine, methyldiallylamine, dimethyldimethylammonium salts, acrylamidopropyl(trimethyl)ammonium salts (R¹, R², and R³═H, R⁴═C(O)NH(CH₂)₂N⁺(CH₃)₃ X⁻), methacrylamidopropyl(trimethyl)ammonium salts (R¹ and R²═H, R³═CH₃ H, R⁴═C(O)NH(CH₂)₂N⁺(CH₃)₃ X⁻).

Particularly preferred cationic polymers contain, as monomer units, derivatives of diallylamine, in particular dimethyldiallylammonium salt and/or methacrylamidopropyl(trimethyl)ammonium salt, preferably in the form of the chloride, bromide, iodide, hydroxide, phosphate, sulfate, hydrosulfate, ethyl sulfate, methyl sulfate, mesylate, tosylate, formate, or acetate, in combination with monomer units from the group of the ethylenically unsaturated carboxylic acids.

The cationic or amphoteric polymer contained in the dispersed material comprises, in preferred detergents or cleaning agents, at least one polymer having a molecular weight above 2000.

Suitable as dispersed materials in the context of the present application are all active detergent or cleaning substances that are solid at room temperature, but in particular active detergent or cleaning substances from the group of the detergency builders (builders and co-builders), bleaching agents, bleach activators, glass corrosion protection agents, silver protection agents, and/or enzymes.

The builders include, in the context of the present invention, in particular the zeolites, silicates, carbonates, organic co-builders, and also (if there are no environmental prejudices against their use) the phosphates.

Suitable crystalline, layered sodium silicates possess the general formula NaMSiₓO₂ₓ₊₁. H₂O, where M denotes sodium or hydrogen, x a number from 1.9 to 4, and y is a number from 0 to 20, and preferred values for x are 2, 3, or 4. Preferred crystalline sheet silicates of the formula indicated above are those in which M denotes sodium and x assumes the value 2 or 3. Both β- and δ-sodium disilicates Na₂Si₂O₅.yH₂O are particularly preferred.

Also usable are amorphous sodium silicates having a Na₂O:SiO₂ modulus from 1:2 to 1:3.3, preferably from 1:2 to 1:2.8, and in particular from 1:2 to 1:2.6, which are dissolution-delayed and exhibit secondary washing properties. Dissolution delay as compared with conventional amorphous sodium silicates can have been brought about in various ways, for example by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but instead at most one or more maxima in the scattered X radiation, having a width of several degree units of the diffraction angle. Particularly good builder properties can, however, very easily result even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular a maximum of 20 nm, being preferred. So-called X-amorphous silicates of this kind likewise exhibit a dissolution delay as compared with conventional water glasses. Densified/compacted amorphous silicates, compounded amorphous silicates, and overdried X-amorphous silicates are particularly preferred.

Dispersions according to the present invention that are preferred in the context of the present invention are characterized in that they contain, based on the total weight of the dispersed materials, silicate(s), preferably alkali silicates, particularly preferably crystalline or amorphous alkali disilicates, in amounts from 5 to 60 wt %, preferably from 7 to 50 wt %, and in particular from 9 to 40 wt %, in each case based on the weight of the detergent or cleaning agent.

If the agents according to the present invention are used as automatic dishwashing agents, these agents then preferably contain at least one crystalline layered sodium silicate of the general formula NaMSiₓO₂ₓ₊₁.H₂O, where M denotes sodium or hydrogen, x a number from 1.9 to 22, preferably from 1.9 to 4, and y denotes a number from 0 to 33. The crystalline layered silicates of formula (I) are marketed, for example, by Clariant GmbH (Germany) under the trade name Na-SKS, e.g. Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O), or Na-SKS-4 (Na₂Si₄O₉.xH₂O, makatite).

Particularly suitable for purposes of the present invention are dispersions according to the present invention that contain crystalline layered silicates of formula (I) in which x denotes 2. Especially suitable, of these, are Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-1 1 (t-Na₂Si₂O₅), and Na-SKS-1 3 (NaHSi₂O₅), but in particular Na-SKS-6 (β-Na₂Si₂O₅). A survey of crystalline layered silicates may be found, for example, in the article published in “Seifen-Öle-Fette-Wachse” Vol. 116, No. 20, 1990, pages 805-808.

Preferred dispersions according to the present invention for automatic dishwashing comprise in the context of the present application, based on the weight portion of the dispersed materials, a weight portion of the crystalline layered silicate of formula (I) from 0.1 to 20 wt %, preferably from 0.2 to 15 wt %, and in particular from 0.4 to 10 wt %, in each case based on the total weight of those agents. Particularly preferred are, in particular, those automatic dishwashing agents that comprise, based on the weight portion of the dispersed materials, a total silicate content below 7 wt %, by preference below 6 wt %, preferably below 5 wt %, particularly preferably below 4 wt %, very particularly preferably below 3 wt %, and in particular below 2.5 wt %, preferably at least 70 wt %, preferably at least 80 wt %, and in particular at least 90 wt % of this silicate, based on the total weight of the silicate content, being silicate having the general formula NaMSiₓO₂ₓ₊₁ y H₂O.

The finely crystalline synthetic zeolite containing bound water that is used is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approx. 80 wt % zeolite X) that is marketed by CONDEA Augusta S.p.A. under the trade name VEGOBOND Ax® and can be described by the formula
nNa₂O.(1-n)K₂O.Al₂O₃.(2−2,5)SiO₂.(3,5−5,5) H₂O

The zeolite can be used both as a builder in a granular compound and as a kind of “dusting” of the entire mixture that is to be compressed, both approaches to incorporating the zeolite into the premixture usually being used. Suitable zeolites exhibit an average particle size of less than 10 μm (volume distribution; measurement method: Coulter Counter), and preferably contain 18 to 22 wt %, in particular 20 to 22 wt %, of bound water.

The use of the generally known phosphates as builder substances is also, of course, possible, provided such use is not to be avoided for environmental reasons. This applies in particular to the use of agents according to the present invention as automatic dishwashing agents, which is particularly preferred in the context of the present application. Among the plurality of commercially available phosphates, the alkali metal phosphates, with particular preference for pentasodium or pentapotassium triphosphate (sodium or potassium tripolyphosphate), have the greatest significance in the detergent and cleaning agent industry.

“Alkali metal phosphates” is the summary designation for the alkali metal (in particular sodium and potassium) salts of the various phosphoric acids, in which context a distinction can be made between metaphosphoric acids (HPO₃)n and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance.

Sodium dihydrogenphosphate, NaH₂PO₄, exists as the dihydrate (density 1.91 gcm⁻³, melting point 60°) and as the monohydrate (density 2.04 gcm⁻³). Both salts are white powders that are very easily soluble in water and that lose their water of crystallization upon heating and transition at 200° C. into the weakly acid diphosphate (disodium hydrogendiphosphate, Na₂H₂P₂O₇), and at higher temperature into sodium trimetaphosphate (Na₃P₃O₉) and Maddrell salt (see below). NaH₂PO₄ reacts in acid fashion; it is created when phosphoric acid is adjusted with sodium hydroxide to a pH of 4.5 and the mash is spray-dried. Potassium dihydrogenphosphate (primary or unibasic potassium phosphate, potassium diphosphate, KDP), KH₂PO₄, is a white salt of density 2.33 gcm⁻³, has a melting point of 253° [decomposing to form potassium polyphosphate (KPO₃)ₓ], and is easily soluble in water.

Disodium hydrogenphosphate (secondary sodium phosphate), Na₂HPO₄, is a colorless, very easily water-soluble crystalline salt. It exists anyhdrously and with 2 mol (density 2.066 gcm^{31 3}, water lost at 95°), 7 mol (density 1.68 gcm⁻³, melting point 48° with loss of 5 H₂O), and 12 mol of water (density 1.52 gcm⁻³, melting point 35° with loss of 5 H₂O); it becomes anhydrous at 100° and when more strongly heated transitions into the diphosphate Na₄P₂O₇. Disodium hydrogenphosphate is produced by the neutralization of phosphoric acid with a soda solution using phenolphthalein as indicator. Dipotassium hydrogenphosphate (secondary or dibasic potassium phosphate), K₂HPO₄, is an amorphous white salt that is easily soluble in water.

Trisodium phosphate (tertiary sodium phosphate), Na₃PO₄, exists as colorless crystals that as the dodecahydrate have a density of 1.62 gcm⁻³ and a melting point of 73-76° C. (decomposition), as the decahydrate (corresponding to 19-20% P₂O₅) a melting point of 100° C., and in the anhydrous form (corresponding to 39-40% P₂O₅) a density of 2.536 gcm⁻³. Trisodium phopshate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning agent industry.

Tetrasodium diphosphate (sodium pyrophosphate), Na₄P₂O₇, exists in anhydrous form (density 2.534 gcm⁻³, melting point 988°, also indicated as 880°) and as the decahydrate (density 1.815-1.836 gcm⁻³, melting point 94° with loss of water). Both substances are colorless crystals that are soluble in water with an alkaline reaction. Na₄P₂O₇ is created when disodium phosphate is heated to >200°, or by reacting phosphoric acid with soda in the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25°.

Condensation of NaH₂PO₄ or KH₂PO₄ yields higher-molecular-weight sodium and potassium phosphates, within which a distinction can be made between cyclic representatives (the sodium and potassium metaphosphates) and chain types (the sodium and potassium polyphosphates). For the latter in particular, a number of designations are in use: fused or thermal phosphates, Graham salt, Kurrol's salt, and Maddrell salt. All the higher sodium and potassium phosphates are together referred to as “condensed” phosphates.

The technically important pentasodium triphosphate Na₅P₃O₁₀ (sodium tripolyphosphate) is a white, water-soluble, non-hygroscopic salt, crystallizing anhydrously or with 6 H₂O, of the general formula NaO—[P(O)(ONa)—O]ₙ—Na, where n=3. Approximately 17 g of the salt containing no water of crystallization dissolves in 100 g of water at room temperature, approx. 20 g at 60° C., and approx. 32 g at 100°; after the solution is heated to 100° for two hours, approx. 8% orthophosphate and 15% disphosphate are produced by hydrolysis. In the production of pentasodium triphosphate, phosphoric acid is reacted with a soda solution or sodium hydroxide in the stoichiometric ratio, and the solution is dewatered by spraying. Like Graham salt and sodium diphosphate, pentasodium triphosphate dissolves many insoluble metal compounds (including lime soaps, etc.). Pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the detergent and cleaning agent industry. Sodium potassium tripolyphosphates also exist; these are likewise usable in the context of the present invention. They are produced, for example, when sodium trimetaphosphate is hydrolyzed with KOH:
(NaPO₃)₃+2KOH→Na₃K₂P₃O₁₀+H₂O
These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable according to the present invention.

Dispersions according to the present invention that are preferred in the context of the present invention are characterized in that they contain, based on the total weight of the dispersed materials, phosphate(s), preferably alkali metal phosphate(s), particularly preferably pentasodium or pentapotassium triphosphate (sodium or potassium tripolyphosphate), in amounts from 5 to 90 wt %, preferably from 15 to 85 wt %, and in particular from 20 to 80 wt %.

Particularly preferred are, in particular, those agents according to the present invention in which the weight ratio of potassium tripolyphosphate to sodium tripolyphosphate contained in the agent is more than 1:1, by preference more than 2:1, preferably more than 5:1, particularly preferably more than 10:1, and in particular more than 20:1. Particularly preferred are, in particular, those dispersions according to the present invention that contain exclusively potassium tripolyphosphate.

Additional builders are the alkali carriers. Alkali carriers are considered to be, for example, alkali metal hydroxides, alkali metal carbonates, alkali metal hydrogencarbonates, alkali metal sesquicarbonates, the aforesaid alkali silicates, alkali metasilicates, and mixtures of the aforesaid substances, the alkali carbonates, in particular sodium carbonate, sodium hydrogencarbonate, or sodium sesquicarbonate, being used in preferred fashion for purposes of this invention. A builder system containing a mixture of tripolyphosphate and sodium carbonate is particularly preferred. Likewise particularly preferred is a builder system containing a mixture of tripolyphosphate and sodium carbonate and sodium disilicate.

Polycarboxylates/polycarboxylic acids, aspartic acid, polyacetals, dextrins, further organic co-builders (see below), and phosphonates can be used as organic co-builders in the detergents and cleaning agents according to the present invention. These substance classes are described below.

Usable organic builder substances are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof.

The acids per se can also be used. The acids typically also possess, in addition to their builder effect, the property of an acidifying component, and thus serve also to establish a lower and milder pH for detergents or cleaning agents. Worthy of mention in this context are, in particular, citric acid, succinic acid, glutaric acid, adipic acid, gluconic acid, and any mixtures thereof.

Other suitable builder substances are polyacetals, which can be obtained by reacting dialdehydes with polyol carboxylic acids that have 5 to 7 carbon atoms and at least 3 hydroxyl groups. Preferred polyacetals are obtained from dialdehydes such as glyoxal, glutaraldehyde, terephthalaldehyde, and mixtures thereof, and from polyol carboxylic acids such as gluconic acid and/or glucoheptonic acid.

Other suitable organic builder substances are dextrins, for example oligomers or polymers of carbohydrates, which can be obtained by partial hydrolysis of starches. The hydrolysis can be performed in accordance with usual, e.g. acid- or enzyme-catalyzed, methods. Preferably these are hydrolysis products having average molar weights in the range from 400 to 500,000 g/mol. A polysaccharide having a dextrose equivalent (DE) in the range from 0.5 to 40, in particular from 2 to 30, is preferred, DE being a common indicator of the reducing effect of a polysaccharide as compared with dextrose, which possesses a DE of 100. Also usable are maltodextrins having a DE between 3 and 20, and dry glucose syrups having a DE between 20 and 37, as well as so-called yellow dextrins and white dextrins having higher molar weights in the range from 2000 to 30,000 g/mol.

The oxidized derivatives of such dextrins are their reaction products with oxidizing agents that are capable of oxidizing at least one alcohol function of the saccharide ring to the carboxylic acid function.

Oxydisuccinates and other derivatives of disuccinates, preferably ethylenediamine disuccinate, are also additional suitable co-builders. Ethylenediamine N,N′-disuccinate (EDDS) is used here preferably in the form of its sodium or magnesium salts. Also preferred in this context are glycerol disuccinates and glycerol trisuccinates. Suitable utilization amounts in zeolite-containing and/or silicate-containing formulations are 3 to 15 wt %.

Other usable organic co-builders are, for example, acetylated hydroxycarboxylic acids and their salts, which can optionally also be present in lactone form and which contain at least 4 carbon atoms and at least one hydroxy group, as well as a maximum of two acid groups.

A further substance class having co-builder properties is represented by the phosphonates. These are, in particular, hydroxyalkane- and aminoalkanephosphonates. Among the hydroxyalkanephosphonates, 1-hydroxyethane-1,1-diphosphonate (HEDP) is particularly important as a co-builder. It is preferably used as the sodium salt, the disodium salt reacting neutrally and the tetrasodium salt in alkaline fashion (pH 9). Suitable aminoalkanephosphonates are preferably ethylenediamine tetramethylenephosphonate (EDTMP), diethylenetriamine pentamethylenephosphonate (DTPMP), and their higher homologs. They are preferably used in the form of the neutrally reacting sodium salts, e.g. as the hexasodium salt of EDTMP or as the hepta- and octasodium salt of DTPMP. Of the class of phosphonates, HEDP is preferably used as a builder. The aminoalkanephosphonates furthermore possess a pronounced heavy-metal binding capability. It may accordingly be preferred, especially when the agents also contain bleaches, to use aminoalkanephosphonates, in particular DTPMP, or mixtures of the aforesaid phosphonates.

All compounds that are capable of forming complexes with alkaline-earth ions can also be used as co-builders.

The dispersions according to the present invention can furthermore contain bleaching agents as dispersed materials. Of the compounds serving as bleaching agents that yield H₂O₂ in water, sodium percarbonate, sodium perborate tetrahydrate, and sodium perborate monohydrate are of particular importance. Other usable bleaching agents are, for example, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid. Cleaning agents according to the present invention can also contain bleaching agents from the group of the organic bleaching agents. Typical organic bleaching agents are the diacyl peroxides, for example dibenzoyl peroxide. Further typical organic bleaching agents are the peroxy acids, the alkylperoxy acids and arylperoxy acids being mentioned in particular as examples. Preferred representatives are (a) peroxybenzoic acid and its ring-substituted derivatives, such as alkylperoxybenzoic acids but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamindoperoxycaproic acid, N-nonenylamidoperadipic acid, and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic)acid can also be used.

Substances that release chlorine or bromine can also be used as bleaching agents in the dispersions according to the present invention. Appropriate among the materials releasing chlorine or bromine are, for example, heterocyclic N-bromamide and N-chloramides, for example trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

Preferred dispersions according to the present invention contain bleaching agents in amounts from 1 to 40 wt %, preferably from 2.5 to 30 wt %, and in particular from 5 to 20 wt %, in each case based on the entire dispersion.

If the agents according to the present invention are used as automatic dishwashing agents, they can furthermore contain bleach activators as dispersed materials in order to achieve an improved bleaching effect when cleaning at temperatures of 60° C. and below. Compounds that, under perhydrolysis conditions, yield aliphatic peroxycarboxylic acids having preferably 1 to 10 carbon atoms, in particular 2 to 4 carbon atoms, and/or optionally substituted perbenzoic acid, can be used as bleach activators. Substances that carry the O- and/or N-acyl groups having the aforesaid number of carbon atoms, and/or optionally substituted benzoyl groups, are suitable. Multiply acylated alkylenediamines, in particular tetraacetylethylenediamine (TAED), acylated triazine derivatives, in particular 1,5-diacetyl-2,4-dioxyhexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or isononanoyl oxybenzenesulfonate (n- and iso-NOBS), carboxylic acid anhydrides, in particular phthalic acid anhydride, acylated polyvalent alcohols, in particular triacetin, ethylene glycol diacetate, and 2,5-diacetoxy-2,5-dihydrofuran, are preferred.

Further bleach activators preferred for use in the context of the present application are compounds from the group of the cationic nitriles, in particular cationic nitrile of the formula 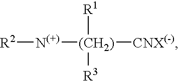
in which R¹ denotes —H, —CH₃, a C₂₋₂₄ alkyl or alkenyl radical, a substituted C₂₋₂₄ alkyl or alkenyl radical having at least one substituent from the group —Cl, —Br, —OH, —NH₂, —CN, an alkyl or alkenylaryl radical having a C₁₋₂₄ alkyl group, or denotes a substituted alkyl or alkenylaryl radical having a C₁₋₂₄ alkyl group and at least one further substituent on the aromatic ring; R² and R³, independently of one another, are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6; and X is an anion.

Particularly preferred agents according to the present invention contain a cationic nitrile of the formula 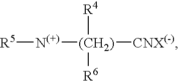
in which R⁴, R⁵ and R⁶ are selected, independently of one another, from —CH₃, —CH₂—CH₃, —CH₂—CH₂—CH₃, —CH(CH₃)—CH₃, where R⁴ can additionally also be —H; and X is an anion, such that preferably R⁵═R⁶═—CH₃ and in particular R⁴═R⁵═R⁶═—CH₃, and compounds of the formulas (CH₃)₃N⁽⁺⁾CH₂—CN X⁻, (CH₃CH₂)₃N⁽⁺⁾CH₂—CN X³¹ , (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻, are particularly preferred; of the group of these substances, the cationic nitrile of formula (CH₃)₃N⁽⁺⁾CH₂—CN X⁻, in which X⁻ denotes an anion that is selected from the group chloride, bromide, iodide, hydrogensulfate, methosulfate, p-toluenesulfonate (tosylate), or xylenesulfonate, is in turn particularly preferred.

Additionally usable as bleach activators are compounds that, under perhydrolysis conditions, yield aliphatic peroxycarboxylic acids having preferably 1 to 10 carbon atoms, in particular 2 to 4 carbon atoms, and/or optionally substituted perbenzoic acid. Substances that carry the O- and/or N-acyl groups having the aforesaid number of carbon atoms, and/or optionally substituted benzoyl groups, are suitable. Multiply acylated alkylenediamines, in particular tetraacetylethylendiamine (TAED), acylated triazine derivatives, in particular 1,5-diacetyl-2,4-dioxyhexahydro-1,3,5-triazine (DADHT), acylated glycolurils, in particular tetraacetyl glycoluril (TAGU), N-acylimides, in particular N-nonanoylsuccinimide (NOSI), acylated phenolsulfonates, in particular n-nonanoyl- or isononanoyl oxybenzenesulfonate (n- or iso-NOBS), carboxylic acid anhydrides, in particular phthalic acid anhydrides, acylated polyvalent alcohols, in particular triacetin, ethylene glycol diacetate, 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular pentaacetylglucose (PAG), pentaacetylfructose, tetraacetylxylose and octaacetyllactose as well as acylated, optionally N-alkylated glucamine und gluconolactone, and/or N-acylated lactams, for example N-benzoylcaprolactam, are preferred. Hydrophilically substituted acyl acetates and acyl lactams are also used in preferred fashion. Combinations of conventional bleach activators can also be used. The bleach activators are used in automatic dishwashing agents usually in amounts from 0.1 to 20 wt %, preferably from 0.25 to 15 wt %, and in particular from 1 to 10 wt %, in each case based on the agent. In the context of the present invention, the aforesaid quantitative proportions refer to the weight of the agent without the water-soluble or water-dispersible container.

In addition to or instead of the conventional bleach activators, so-called bleach catalysts can also be incorporated into the agents. These substances are bleach-enhancing transition metal salts or transition metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also applicable as bleach catalysts.

If further bleach activators in addition to the nitrilquats are used, the bleach activators used are preferably those from the group of the multiply acylated alkylenediamines, in particular tetraacetylethylendiamine (TAED), N-acylimides, in particular N-nonanoylsuccinimide (NOSI), acylated phenolsulfonates, in particular n-nonanoyl- or isononanoyl oxybenzenesulfonate (n- or iso-NOBS), n-methylmorpholinium acetonitrile methyl sulfate (MMA), preferably in amounts up to 10 wt %, in particular 0.1 wt % to 8 wt %, in particular 2 to 8 wt %, and particularly preferably 2 to 6 wt %, based on the total weight of the dispersion.

Bleach-enhancing transition metal complexes, in particular having the central atoms Mn, Fe, Co, Cu, Mo, V, Ti, and/or Ru, preferably selected from the group of the manganese and/or cobalt salts and/or complexes, particularly preferably the cobalt(ammine) complexes, the cobalt(acetate) complexes, the cobalt(carbonyl) complexes, the chlorides of cobalt or manganese, and manganese sulfate, are used in usual amounts, preferably in a quantity up to 5 wt %, in particular from 0.0025 wt % to 1 wt %, and particularly preferably from 0.01 wt % to 0.25 wt %, in each case based on the entire agent. Even more bleach activator can, however, be used in specific cases.

A further important criterion for evaluating an automatic dishwashing agent, in addition to its cleaning performance, is the visual appearance of the dry dishes after cleaning is complete. Calcium carbonate deposits that may occur on dishes or in the interior of the machine may, for example, negatively affect customer satisfaction and thus have a causative influence on the economic success of such a cleaning agent. A further problem that has existed for some time with automatic dishwashing is the corrosion of glassware, which can be expressed in general by the occurrence of clouding, smearing, and scratches, but also as iridescence of the glass surface. The effects that are observed are based substantially on two processes: the departure of alkali and alkaline-earth ions from the glass in combination with hydrolysis of the silicate network, and on the other hand a deposition of silicate compounds onto the glass surface.

The aforesaid problems can be solved with the dispersions according to the present invention if, in addition to the aforementioned obligatory and, if applicable, optional ingredients, specific glass corrosion inhibitions are incorporated into the agent. Preferred agents according to the present invention therefore additionally contain glass corrosion protection agents, preferably from the group of the magnesium and/or zinc salts and/or magnesium and/or zinc complexes, as dispersed material.

A preferred class of compounds that can be added to the agents according to the present invention in order to prevent glass corrosion is insoluble zinc salts. These can attach during the dishwashing process to the glass surface, where they prevent metal ions from going into solution out of the glass network, and prevent the hydrolysis of silicates. These insoluble zinc salts additionally prevent the deposition of silicate onto the glass surface, so that the glass is protected from the consequences discussed above.

Insoluble zinc salts for purposes of this preferred embodiment are zinc salts that possess a solubility of, at maximum, 10 grams of zinc salt per liter of water at 20° C. Examples of insoluble zinc salts that are particularly preferred according to the present invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The aforesaid zinc compounds are used in the agents according to the present invention preferably in amounts that bring about a zinc ion content in the agent of between 0.02 and 10 wt %, preferably between 0.1 and 5.0 wt %, and in particular between 0.2 and 1.0 wt %, in each case based on the agent. The agents' exact content of zinc salt or salts is, of course, dependent on the type of zinc salts: the lower the solubility of the zinc salt used, the higher its concentration should be in the agents according to the present invention.

Because the insoluble zinc salts remain for the most part unchanged during the dishwashing process, the particle size of the salts is a criterion requiring care so that the salts do not adhere to glassware or to machine parts. Liquid aqueous automatic dishwashing agents according to the present invention in which the insoluble zinc salts have a particle size below 1.7 millimeters are preferred here.

If the maximum particle size of the insoluble zinc salts is below 1.7 mm, there is no risk of insoluble residues in the dishwasher. In order further to minimize the danger of insoluble residues, the insoluble zinc salt preferably has an average particle size that is well below that value, for example an average particle size of less than 250 μm. This once again is all the more applicable the less soluble the zinc salt is. In addition, the glass corrosion-inhibiting effectiveness rises with decreasing particle size. For very poorly soluble zinc salts, the average particle size is preferably below 100 μm. It can be even lower for even more poorly soluble salts; for the very poorly soluble zinc oxide, for example, average particle sizes below 100 μm are preferred.

A further preferred class of compounds is magnesium and/or zinc salt(s) of at least one monomeric and/or polymeric organic acid. The effect of these is that even with repeated use, the surfaces of washed glassware are not modified in corrosive fashion; in particular, no clouding, smearing, or scratching, but also no iridescence of the glass surfaces, are caused.

Although according to the present invention all magnesium and/or zinc salt(s) of monomeric and/or polymeric organic acids can be contained in the agents claimed, nevertheless, as described above, the magnesium and/or zinc salts of monomeric and/or polymeric organic acids from the groups of the unbranched saturated or unsaturated monocarboxylic acids, the branched saturated or unsaturated monocarboxylic acids, the saturated and unsaturated dicarboxylic acids, the aromatic mono-, di- and tricarboxylic acids, the sugar acids, the hydroxy acids, the oxo acids, the amino acids, and/or the polymeric carboxylic acids are preferred. Within these groups, the acids recited below are in turn preferred in the context of the present invention:

From the group of the unbranched saturated or unsaturated monocarboxylic acids: methanoic acid (formic acid), ethanoic acid (acetic acid), propanoic acid (propionic acid), pentanoic acid (valeric acid), hexanoic acid (caproic acid), heptanoic acid (oenanthic acid), octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid (margaric acid), octadecanoic acid (stearic acid), eicosanoic acid (arachidic acid), docosanoic acid (behenic acid), tetracosanoic acid (lignoceric acid), hexacosanoic acid (cerotinic acid), triacontanoic acid (melissic acid), 9c-hexadecenoic acid (palmitoleic acid), 6c-octadeceneoic acid (petroselinic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid), and 9c,12c,15c-octadecatrienoic acid (linolenic acid).

From the group of the branched saturated or unsaturated monocarboxylic acids: 2-methylpentanoic acid, 2-ethylhexanoic acid, 2-propylheptanoic acid, 2-butyloctanoic acid, 2-pentylnonanoic acid, 2-hexyldecanoic acid, 2-heptylundecanoic acid, 2-octyldodecanoic acid, 2-nonyltridecanoic acid, 2-decyltetradecanoic acid, 2-undecylpentadecanoic acid, 2-dodecyl-hexadecanoic acid, 2-tridecylheptadecanoic acid, 2-tetradecyloctadecanoic acid, 2-pentadecylnonadecanoic acid, 2-hexadecyleicosanoic acid, 2-heptadecylheneicosanoic acid.

From the group of the unbranched saturated or unsaturated di- or tricarboxylic acids: propanedioic acid (malonic acid), butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), 2c-butenedioic acid (maleic acid), 2t-butenedioic acid (fumaric acid), 2-butinedicarboxylic acid (acetylenedicarboxylic acid).

From the group of the aromatic mono-, di-, and tricarboxylic acids: benzoic acid, 2-carboxybenzoic acid (phthalic acid), 3-carboxybenzoic acid (isophthalic acid), 4-carboxybenzoic acid (terephthalic acid), 3,4-dicarboxybenzoic acid (trimellitic acid), 3,5-dicarboxybenzoic acid (trimesionic acid).

From the group of the sugar acids: galactonic acid, mannonic acid, fructonic acid, arabinonic acid, xylonic acid, ribonic acid, 2-deoxyribonic acid, alginic acid.

From the group of the hydroxy acids: hydroxyphenylacetic acid (mandelic acid), 2-hydroxypropionic acid (lactic acid), hydroxysuccinic acid (maleic acid), 2,3-dihydroxybutanedioic acid (tartaric acid), 2-hydroxy-1,2,3-propanetricarboxylic acid (citric acid), ascorbic acid, 2-hydroxybenzoic acid (salicylic acid), 3,4,5-trihydroxybenzoic acid (gallic acid).

From the group of the oxy acids: 2-oxypropionic acid (pyruvic acid), 4-oxypentanoic acid (levulinic acid).

From the group of the amino acids: alanine, valine, leucine, isoleucine, proline, tryptophan, phenylalanine, methionine, glycine, serine, tyrosine, threonine, cysteine, asparagine, glutamine, asparagic acid, glutamic acid, lysine, arginine, histidine.

From the group of the polymeric carboxylic acids: polyacrylic acid, polymethacrylic acid, alkylacrylamide/acrylic acid copolymers, alkylacrylamide/methacrylic acid copolymers, alkylacrylamide/methylmethacrylic acid copolymers, copolymers of unsaturated carboxylic acids, vinyl acetate/crotonic acid copolymers, vinylpyrrolidone/vinyl acrylate copolymers.

The spectrum of zinc salts of organic acids, preferably of organic carboxylic acids, preferred according to the present invention extends from salts that are poorly soluble or insoluble in water, i.e. exhibit a solubility below 100 mg/L, preferably below 10 mg/L, in particular no solubility, to those salts that exhibit in water a solubility above 100 mg/L, preferably above 500 mg/L, particularly preferably above 1 g/L, and in particular above 5 g/L (all solubilities at a 20° C. water temperature). Zinc citrate, zinc oleate, and zinc stearate, for example, belong to the first group of zinc salts; zinc formate, zinc acetate, zinc lactate, and zinc gluconate, for example, belong to the group of the soluble zinc salts.

In a further preferred embodiment of the present invention, the dispersions according to the present invention contain at least one zinc salt, but no magnesium salt, of an organic acid, this being preferably at least one zinc salt of an organic carboxylic acid, particularly preferably a zinc salt from the group of zinc stearate, zinc oleate, zinc gluconate, zinc acetate, zinc lactate, and/or zinc citrate. Zinc ricinoleate, zinc abietate, and zinc oxalate are also preferred.

An agent preferred in the context of the present invention contains zinc salt in amounts from 0.1 to 5 wt %, preferably from 0.2 to 4 wt %, and in particular from 0.4 to 3 wt %, or zinc in oxidized form (calculated as Zn²+) in amounts from 0.01 to 1 wt %, preferably from 0.02 to 0.5 wt %, and in particular from. 0.04 to 0.2 wt %, in each case based on the total weight of the dispersion.

If the dispersions according to the present invention are used as dishwashing agents, these cleaning agents can contain corrosion inhibitors as dispersed materials in order to protect the items being washed or the machine, silver protection agents having particular importance in the automatic dishwashing sector. The known substances of the existing art are usable. In general, silver protection agents can be selected principally from the group of the triazoles, benzotriazoles, bisbenzotriazoles, aminotriazoles, alkylaminotriazoles, and transition metal salts or complexes. Benzotriazole and/or alkylaminotriazole are particularly preferred for use. The following can be mentioned as examples of the 3-amino-5-alkyl-1,2,4-triazoles preferred for use according to the present invention: 5,- -propyl-, -butyl-, -pentyl-, -heptyl-, -octyl-, -nonyl-, -decyl-, -undecyl-, -dodecyl-, -isononyl-, -Versatic-10-acid alkyl-, -phenyl-, -p-tolyl-, -(4-tert. butylphenyl), -(4-methoxyphenyl)-, -(2-, -3-, -4-pyridyl)-, -(2-thienyl), -(5-methyl-2-furyl), -(5-oxo-2-pyrrolidinyl)-, -3-amino-1,2,4-triazole. In dishwashing agents, the alkylamino-1,2,4-triazoles or their physiologically acceptable salts are used at a concentration of 0.001 to 10 wt %, preferably 0.0025 to 2 wt %, particularly preferably 0.01 to 0.04 wt %. Preferred acids for salt formation are hydrochloric acid, sulfuric acid, phosphoric acid, carbonic acid, sulfurous acid, organic carboxylic acids such as acetic, glycolic, citric, succinic acid. 5-pentyl, 5-heptyl, 5-nonyl, 5-undecyl, 5-isononyl, 5-versatic-10-acid alkyl-3-amino-1,2,4-triazoles, and mixtures of these substances, are very particularly effective.

Cleaner formulations moreover often comprise agents containing active chlorine, which agents can greatly decrease the corrosion of silver surfaces. In chlorine-free cleaners, oxygen- and nitrogen-containing organic redox-active compounds are used in particular, such as di- and trivalent phenols, e.g. hydroquinone, catechol, hydroxyhydroquinone, gallic acid, phloroglucine, pyrogallol, and derivatives of these classes of compounds. Salt-like and complex-like inorganic compounds, for example salts of the metals Mn, Ti, Zr, Hf, V, Co, and Ce, are also often used. Preferred in this context are the transition metal salts that are selected from the group of the manganese and/or cobalt salts and/or complexes, in particularly preferred fashion the cobalt(amine) complexes, cobalt(acetate) complexes, cobalt(carbonyl) complexes, the chlorides of cobalt or manganese, and manganese sulfate. Zinc compounds can also be used to prevent corrosion of the items being washed.

Instead of or in addition to the silver protection agents described above, for example the benzotriazoles, redox-active substances can be used in the dispersions according to the present invention. These substances are preferably inorganic redox-active substances from the group of the manganese, titanium, zirconium, hafnium, vanadium, cobalt, and cerium salts and/or complexes, the metals preferably being present in one of the oxidation stages II, III, IV, V, or VI.

The metal salts or metal complexes that are used should be at least partially soluble in water. The counterions suitable for salt formation comprise all usual singly, doubly, or triply negatively charged inorganic anions, e.g. oxide, sulfate, nitrate, fluoride, but also organic anions such as, for example, stearate.

Metal complexes for purposes of the invention are compounds that comprise a central atom and one or more ligands, as well as, if applicable, additionally one or more of the aforementioned anions. The central atom is one of the aforementioned metals in one of the aforementioned oxidation stages. The ligands are neutral molecules or anions that are unidentate or multidentate; the term “ligand” for purposes of the invention is explained in more detail in, for example, Römpp Chemie Lexikon, Georg Thieme Verlag Stuttgart/New York, 9th edition, 1990, page 2507. If the charge of the central atom and the charge of the ligand(s) in a metal complex do not add up to zero, charge equalization is ensured by either one or more of the aforementioned anions or one or more cations, e.g. sodium, potassium, ammonium ions, depending on whether a cationic or anionic charge excess exists. Suitable complexing agents are, for example, citrate, acetyl acetonate, or 1-hydroxyethane-1,1-diphosphonate.

The definition of “oxidation stage” commonly used in chemistry is provided, for example, in “Römpp Chemie Lexikon,” Georg Thieme Verlag Stuttgart/New York, 9th edition, 1991, page 3168.

Particularly preferred metal salts and/or metal complexes are selected from the group of MnSO₄, Mn(II) citrate, Mn(Ii) stearate, Mn(II) acetyl acetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ and mixtures thereof, so that preferred automatic dishwashing agents according to the present invention are characterized in that the metal salts and/or metal complexes are selected from the group of MnSO₄, Mn(II) citrate, Mn(II) stearate, Mn(II) acetyl acetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts or metal complexes are, in general, commercially available substances that can be used without prior purification in agents according to the present invention for purposes of silver corrosion protection. For example, the mixture of pentavalent and tetravalent vanadium (V₂O₅, VO₂, V_{2O}₄) known from SO₃ production (contact method) is suitable, as is the titanyl sulfate TiOSO₄ resulting from dilution of a Ti(SO₄)₂ solution.

The inorganic redox-active substances, in particular metal salts or metal complexes, are preferably coated, i.e. completely covered with a material that is watertight but easily soluble at cleaning temperatures, in order to prevent their premature decomposition or oxidation during storage. Preferred coating materials, which are applied using known methods, e.g. Sandwik melt-coating methods from the food industry, are paraffins, microcrystalline waxes, waxes of natural origin such as camauba wax, candellila wax, beeswax, higher-melting-point alcohols such as hexadecanol, soaps, or fatty acids. The coating material, which is solid at room temperature, is applied in the molten state onto the material to be coated, for example by shooting fine particles of material to be coated, in a continuous stream, through a likewise continuously generated spray-mist zone of the molten coating material. The melting point must be selected so that the coating material does not easily dissolve or rapidly melt during silver treatment. The melting point should ideally be in the range between 45° C. and 65° C., and preferably in the range 50° C. to 60° C.

The aforesaid metal salts and/or metal complexes are contained in the dispersions according to the present invention, in particular automatic dishwashing agents, by preference in a quantity from 0.05 to 6 wt %, preferably 0.2 to 2.5 wt %, based on the total weight of the dispersion.

Agents according to the present invention can contain enzymes as dispersed materials in order to enhance washing or cleaning performance, all enzymes established in the existing art for those purposes being usable in principle. These include, in particular, proteases, amylases, lipases, hemicellulases, cellulases, or oxidoreductases, as well as preferably mixtures thereof. These enzymes are, in principle, of natural origin; improved variants based on the natural molecules are available for use in washing and cleaning agents and are correspondingly preferred for use. Agents according to the present invention contain enzymes preferably in total amounts from 1×10⁻⁶ to 5 wt %, based on active protein. The protein concentration can be determined with known methods, for example the BCA method or the biuret method.

Among the proteases, those of the subtilisin type are preferred. Examples thereof are the subtilisins BPN′ and Carlsberg, protease PB92, subtilisins 147 and 309, the alkaline protease from Bacillus lentus, subtilisin DY, and the enzymes (to be classified, however, as subtilases and no longer as subtilisins in the strict sense) thermitase, proteinase K, and proteases TW3 and TW7. Subtilisin Carlsberg is obtainable in further developed form under the trade name Alcalase® from Novozymes A/S, Bagsvaerd, Denmark. Subtilisins 147 and 309 are marketed by Novozymes under the trade names Esperase® and Savinase®, respectively. The variants listed under the designation BLAP® are derived from the protease from Bacillus lentus DSM 5483.

Other usable proteases are, for example, the enzymes obtainable under the trade names Durazym®, Relase®, Everlase®, Nafizym, Natalase®, Kannase®, and Ovozymes® from Novozymes, under the trade names Purafect®, Purafect® OxP and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

Examples of amylases usable according to the present invention are the α-amylases from Bacillus licheniformis, from B. amyloliquefaciens, or from B. stearothermophilus, and their further developments improved for use in detergents and cleaning agents. The enzyme from B. licheniformus is available from Novozymes under the name Termamyl®, and from Genencor under the name Purastar® ST. Further developed products of these α-amylases are available from Novozymes under the trade names Duramyl and Termamyle ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed, again by Novozymes, under the names BSG® and Novamyl®.

Additionally to be highlighted for this purpose are the α-amylase from Bacillus sp. A 7-7 (DSM 12368) and the cyclodextrin-glucanotransferase (CGTase) from B. agaradherens (DSM 9948).

The further developments of the α-amylase from Aspergillus niger and A. oryzae, obtainable from Novozymes under the trade names Fungamyl®, are also suitable. A further commercial product is, for example, Amylase-LT®.

Agents according to the present invention can contain lipases or cutinases, in particular because of their triglyceride-cleaving activities but also in order to generate peracids in situ from suitable precursors. These include, for example, the lipases obtainable originally from Humicola lanuginosa (Thermomyces lanuginosus) or further developed lipases, in particular those having the D96L amino-acid exchange. They are marketed, for example, by Novozymes under the trade names Lipolase®, Lipolase® Ultra, LipoPrime®, Lipozyme®, and Lipex®. The cutinases that were originally isolated from Fusarium solani pisi and Humicola insolens are moreover usable. Usable lipases are likewise obtainable from Amano under the designations Lipase CE®, Lipase P®, Lipase B®, or Lipase CES®, Lipase AKG®, Bacillis sp. Lipase®, Lipase AP®, Lipase M-AP®, and Lipase AML®. The lipases and cutinases from, for example, Genencor, whose starting enzymes were originally isolated from Pseudomonas mendocina and Fusarium solanii, are usable. To be mentioned as further important commercial products are the preparations M1 Lipase® and Lipomax® originally marketed by Gist-Brocades, and the enzymes marketed by Meito Sangyo KK, Japan, under the names Lipase MY-30®, Lipase OF®, and Lipase PL®, as well as the Lumafast® product of Genencor.

Agents according to the present invention can contain further enzymes that are grouped under the term “hemicellulases.” These include, for example, mannanases, xanthanlyases, pectinlyases (=pectinases), pectinesterases, pectatelyases, xyloglucanases (=xylanases), pullulanases, and β-glucanases. Suitable mannanases are obtainable, for example, under the names Gamanase® and Pektinex AR® from Novozymes, under the name Rohapec®5 B1L from AB Enzymes, and under the name Pyrolase® from Diversa Corp., San Diego, Calif., USA. The β-glucanase obtained from B. subtilis is available under the name Cereflo® from Novozymes.

To enhance the bleaching effect, detergents and cleaning agent compositions according to the present invention can contain oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases). Suitable commercial products that may be mentioned are Denilitee 1 and 2 of Novozymes. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the dirt particles, to ensure electron flow (mediators).

The enzymes used in the agents according to the present invention derive either originally from microorganisms, for example the genera Bacillus, Streptomyces, Humicola, or Pseudomonas, and/or are produced by suitable microorganisms in accordance with biotechnological methods known per se, for example by transgenic expression hosts of Bacillus genera or filamentous fungi.

Purification of the relevant enzymes is favorably accomplished by way of methods established per se, for example by precipitation, sedimentation, concentration, filtration of the liquid phases, microfiltration, ultrafiltration, the action of chemicals, deodorization, or suitable combinations of these steps.

Agents according to the present invention can have the enzymes added to them in any form established according to the existing art. These include, for example, the solid preparations obtained by granulation, extrusion, or lyophilization or, especially in the case of liquid or gelled agents, solutions of the enzymes, advantageously as concentrated as possible, anhydrous, and/or with stabilizers added.

Alternatively, the enzymes can be encapsulated for both the solid and the liquid administration form, for example by spray-drying or extrusion of the enzyme solution together with a preferably natural polymer, or in the form of capsules, for example ones in which the enzyme is enclosed e.g. in a solidified gel, or in those of the core-shell type, in which an enzyme-containing core is covered with a protective layer impermeable to water, air, and/or chemicals. Further ingredients, for example stabilizers, emulsifiers, pigments, bleaching agents, or dyes, can additionally be applied in superimposed layers. Such capsules are applied in accordance with methods known per se, for example by vibratory or rolling granulation or in fluidized-bed processes. Such granulated materials are advantageously low in dust, e.g. as a result of the application of polymer film-forming agents, and are stable in storage as a result of the coating.

It is additionally possible to formulate two or more enzymes together, so that a single granulated material exhibits several enzyme activities.

A protein and/or enzyme contained in an agent according to the present invention can be protected, especially during storage, against damage such as, for example, inactivation, denaturing, or decomposition, e.g. resulting from physical influences, oxidation, or proteolytic cleavage. An inhibition of proteolysis is particularly preferred in the context of microbial recovery of the proteins and/or enzymes, in particular when the agents also contain proteases. Agents according to the present invention can contain stabilizers for this purpose; the provision of such agents represents a preferred embodiment of the present invention.

Reversible protease inhibitors are one group of stabilizers. Benzamidine hydrochloride, borax, boric acids, boronic acids, or their salts or esters are often used, among them principally derivatives having aromatic groups, e.g. ortho-substituted, meta-substituted, and para-substituted phenylboronic acids, or their salts or esters. Ovomucoid and leupeptin may be mentioned as peptide protease inhibitors; an additional option is the creation of fusion proteins from proteases and peptide inhibitors.

Further enzyme stabilizers are aminoalcohols such as mono-, di-, triethanol- and -propanolamine and mixtures thereof, aliphatic carboxylic acids up to C₁₂ such as succinic acid, other dicarboxylic acids, or salts of the aforesaid acids. End-capped fatty acid amide alkoxylates are also suitable. Certain organic acids used as builders are additionally capable of stabilizing a contained enzyme.

Lower aliphatic alcohols, but principally polyols, for example glycerol, ethylene glycol, propylene glycol, or sorbitol, are other frequently used enzyme stabilizers. Calcium salts are likewise used, for example calcium acetate or calcium formate, and magnesium salts.

Polyamide oligomers or polymeric compounds such as lignin, water-soluble vinyl copolymers or cellulose ethers, acrylic polymers, and/or polyamides stabilize the enzyme preparation, inter alia, with respect to physical influences or pH fluctuations. Polyamine-N-oxide-containing polymers act as enzyme stabilizers. Other polymeric stabilizers are the linear C₈-C₁₈ polyoxyalkylenes. Alkyl polyglycosides can stabilize the enzymatic components of the agent according to the present invention, and even improve its performance. Crosslinked nitrogen-containing compounds likewise function as enzyme stabilizers.

Reducing agents and antioxidants increase the stability of the enzymes with respect to oxidative breakdown. One sulfur-containing reducing agent is, for example, sodium sulfite.

Combinations of stabilizers are preferably used, for example made up of polyols, boric acid and/or borax, the combination of boric acid or borate, reducing salts, and succinic acid or other dicarboxylic acids, or the combination of boric acid or borate with polyols or polyamino compounds and with reducing salts. The effect of peptide aldehyde stabilizers is increased by the combination with boric acid and/or boric acid derivatives and polyols, and further enhanced by the additional use of divalent cations, for example calcium ions.

Preferred dispersions according to the present invention are characterized in that they additionally contain one or more enzymes and/or enzyme preparations, preferably solid protease preparations and/or amylase preparations, in amounts from 0.1 to 5 wt %, preferably from 0.2 to 4.5, and in particular from 0.4 to 4 wt %, in each case based on the entire agent.

Preferred agents according to the present invention are characterized in that the dispersed materials contain, based on their total weight, at least 20 wt %, preferably at least 30 wt %, particularly preferably at least 40 wt %, and in particular at least 50 wt % of builders and/or bleaching agents and/or bleach activators and/or active detergent or cleaning polymers and/or glass corrosion protection agents and/or silver protection agents and/or enzymes.

Particularly preferred agents according to the present invention are further made up, in addition to the aforementioned preferred dispersion agents, in a proportion of at least 90 wt %, by preference at least 92 wt %, preferably at least 94 wt %, particularly preferably at least 96 wt %, especially preferably at least 98 wt %, and most preferably 99.5 wt %, exclusively of builders and/or bleaching agents and/or bleach activators and/or active detergent or cleaning polymers and/or glass corrosion protection agents and/or silver protection agents and/or enzymes.

In addition to the active detergent or cleaning substances described above as preferred dispersion agents and dispersed materials, the dispersions according to the present invention can, of course, contain further ingredients. These ingredients are preferably one or more substances from the group of the anionic, cationic, or amphoteric surfactants, bursting agents, acidifying agents, disintegration adjuvants, hydrotopes, pH adjusting agents, dyes, fragrances, optical brighteners, foam inhibitors, silicone oils, anti-redeposition agents, graying inhibitors, and color transfer inhibitors.

The sulfonate and sulfate types can be used, for example, as anionic surfactants. Possibilities as surfactants of the sulfonate type are, preferably, C₉₋₁₃ alkyl benzenesulfonates, olefinsulfonates, i.e. mixtures of alkene and hydroxyalkanesulfonates, and disulfonates, for example such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are understood as the mono-, di- and triesters, and mixtures thereof, that are obtained during production by esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium, salts of the sulfuric acid semi-esters of the C_{12-C}₁₈ fatty alcohols, for example from coconut fatty alcohol, tallow alcohol, lauryl, myristyl, cetyl, or stearyl alcohol, or the C₁₀-C₂₀ oxo alcohols and those semi-esters of secondary alcohols of those chain lengths. Additionally preferred are alk(en)yl sulfates of the aforesaid chain length that contain a synthetic straight-chain alkyl radical produced on a petrochemical basis, that possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. 2,3-alkyl sulfates that can be obtained, as commercial products of the Shell Oil Company, under the name DAN® are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO, are also suitable. Because of their high foaming characteristics they are used in cleaning agents only in relative small amounts, for example in amounts of 1 to 5 wt %.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular ethyoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered per se, represent nonionic surfactants (see below for description). Sulfosuccinates whose fatty alcohol radicals derive from ethoxylated fatty alcohols with a restricted homolog distribution are, in turn, particularly preferred. It is likewise possible to use alk(en)ylsuccinic acid having preferably 8 to 18 carbon atoms in the alk(en)yl chain, or salts thereof.

Further appropriate anionic surfactants are, in particular, soaps. Saturated fatty acid soaps, such as the salts of lauric acid, myristic acid, palmitic acid, stearic acid, hydrogenated erucic acid, and behenic acid, are suitable, as are, in particular, soap mixtures derived from natural fatty acids, e.g. coconut, palm kernel, or tallow fatty acids.

The anionic surfactants, including the soaps, can be present in the form of their sodium, potassium, or ammonium salts, and as soluble salts of organic bases, such as mono-, di-, or triethanolamine. The anionic surfactants are preferably present in the form of their sodium or potassium salts, in particular in the form of the sodium salts.

If the agents according to the present invention are used as automatic dishwashing agents, their anionic surfactant content is by preference less than 4 wt %, preferably less than 2 wt %, and very particularly preferably less than 1 wt %. Automatic dishwashing agents that contain no anionic surfactants are particularly preferred.

Instead of the aforesaid surfactants or in combination with them, cationic and/or amphoteric surfactants can also be used.

The agents according to the present invention can contain as cationic active substances, for example, cationic compounds of formulas XXII, XXIII, or XXIV, 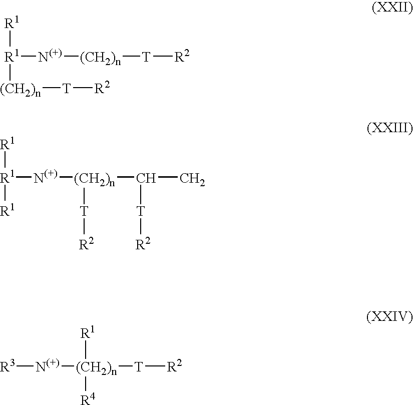
in which each R¹ group, independently of one another, is selected from C₁₋₆ alkyl, alkenyl, or hydroxyalkyl groups; each R² group, independently of one another, is selected from C₈₋₂₈ alkyl or alkenyl groups; R³═R¹ or (CH₂)ₙ—T-R²; R⁴═R¹ or R² or (CH₂)ₙ-T-R²; T═—CH₂—, —O—CO— or —CO—O,— and n is an integer from 0 to 5.

If the agents according to the present invention are used as automatic dishwashing agents, their cationic and/or amphoteric surfactant content is by preference less than 6 wt %, preferably less than 4 wt %, very particularly preferably less than 2 wt %, and in particular less than 1 wt %. Automatic dishwashing agents that contain no cationic or amphoteric surfactants are particularly preferred.

Useful acidifying agents are both inorganic acids and organic acids, provided they are compatible with the other ingredients. For reasons of consumer protection and handling safety, the solid mono-, oligo-, and polycarboxylic acids are usable in particular. Preferred from this group in turn are citric acid, tartaric acid, succinic acid, malonic acid, adipic acid, maleic acid, fumaric acid, oxalic acid, and polyacrylic acid. The anhydrides of these acids can also be used as acidifying agents, maleic acid anhydride and succinic acid anhydride in particular being commercially available. Organic sulfonic acids such as amidosulfonic acid are likewise usable. Sokalan® DCS (trademark of BASF), a mixture of succinic acid (max. 31 wt %), glutaric acid (max. 50 wt %) and adipic acid (max. 33 wt %), is commercially obtainable and likewise preferred for use as an acidifying agent in the context of the present invention.

In order to facilitate the breakdown of agents according to the present invention, it is possible to incorporate disintegration adjuvants, so-called tablet bursting agents, into those agents in order to shorten breakdown times. Tablet bursting agents or breakdown accelerators are understood, in accordance with Römpp (9th ed., Vol. 6, p. 4440) and Voigt “Lehrbuch der pharmazeutischen Technologie” [Textbook of pharmaceutical technology] (6th ed., 1987, pp. 182-184) as adjuvants that ensure the rapid breakdown of tablets in water or gastric juice, and the release of drugs in resorbable form.

These substances, which are also referred to as “bursting” agents because of their action, increase in volume upon the entry of water; on the one hand, their own volume is increased (swelling), and on the other hand the release of gases can also generate a pressure that allows the tablets to break down into smaller particles. Familiar disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivatives, alginates, or casein derivatives.

Preferred agents according to the present invention contain 0.5 to 10 wt %, preferably 3 to 7 wt %, and in particular 4 to 6 wt % of one or more disintegration adjuvants, in each case based on the weight of the agent.

Cellulose-based disintegration agents are used as preferred disintegration agents in the context of the present invention, so that preferred detergent and cleaning agent compositions contain such a cellulose-based disintegration agent in amounts from 0.5 to 10 wt %, preferably 3 to 7 wt %, and in particular 4 to 6 wt %. Pure cellulose has the formal gross composition (C₆H₁₀O₅)ₙ, and in formal terms constitutes a β-1,4-polyacetal of cellobiose, which in turn is made up of two molecules of glucose. Suitable celluloses comprise approx. 500 to 5000 glucose units, and consequently have average molar weights of 50,000 to 500,000. Also usable in the context of the present invention as cellulose-based disintegration agents are cellulose derivatives that are obtainable from cellulose by means of polymer-analogous reactions. Such chemically modified celluloses comprise, for example, products of esterification or etherification processes in which hydroxy hydrogen atoms were substituted. Celluloses in which the hydroxy groups were replaced with functional groups that are not bound by means of an oxygen atom can also, however, be used as cellulose derivatives. The group of the cellulose derivatives embraces, for example, alkali celluloses, carboxymethylcellulose (CMC), cellulose esters and ethers, and aminocelluloses. The aforesaid cellulose derivatives are preferably not used as the only cellulose-based disintegration agent, but are utilized mixed with cellulose. The cellulose-derivative content of these mixtures is preferably below 50 wt %, particularly preferably below 20 wt %, based on the cellulose-based disintegration agent. Pure cellulose that is free of cellulose derivatives is particularly preferred for use as a cellulose-based disintegration agent.

The cellulose used as a disintegration adjuvant is preferably used not in finely divided form, but instead is converted into a coarser form, for example granulated or compacted, before being mixed into the premixtures that are to be compressed. The particle sizes of such disintegration agents are usually above 200 μm, preferably at least 90 wt % between 300 and 1600 μm, and in particular at least 90 wt % between 400 and 1200 μm. The aforesaid coarser cellulose-based disintegration adjuvants mentioned above and described in more detail in the referenced documents are preferable for use as disintegration adjuvants in the context of the present invention, and obtainable commercially, for example, under the designation Arbocel® TF-30-HG of the Rettenmaier company.

Microcrystalline cellulose can be used as a further cellulose-based disintegration agent or as a constituent of those components. This microcrystalline cellulose is obtained by partial hydrolysis of celluloses under conditions such that only the amorphous regions (approx. 30% of the total cellulose mass) of the celluloses are attacked and dissolve completely, but the crystalline regions (approx. 70%) remain undamaged. A subsequent disaggregation of the microfine celluloses produced by hydrolysis yields the microcrystalline celluloses, which have primary particle sizes of approx. 5 μm and are compactable, for example, into granulates having an average particle size of 200 μm.

Agents preferred in the context of the present invention additionally contain a disintegration adjuvant, preferably a cellulose-based disintegration adjuvant, preferably in granular, co-granulated, or compacted form, in amounts from 0.5 to 10 wt %, preferably from 3 to 7 wt %, and in particular from 4 to 6 wt %, in each case based on the total weight of the agent.

The agents according to the present invention can furthermore contain a gas-evolving effervescence system. The gas-evolving effervescence system can be made up of a single substance that releases a gas upon contact with water. To be mentioned among these compounds is, in particular, magnesium peroxide, which releases oxygen upon contact with water. Usually, however, the gas-releasing bubbling system is in turn made up of at least two constituents that react with one another to form gas. While a plurality of systems that release, for example, nitrogen, oxygen, or hydrogen are conceivable and implementable here, the bubbling system used in the detergent and cleaning agent compositions according to the present invention will be selected with regard to both economic and environmental considerations. Preferred effervescence systems comprise alkali metal carbonate and/or hydrogencarbonate as well as an acidifying agent that is suitable for releasing carbon dioxide from the alkali metal salts in aqueous solution.

Among the alkali metal carbonates or hydrogencarbonates, the sodium and potassium salts are greatly preferred over the other salts for cost reasons. It is of course not necessary for the relevant pure alkali metal carbonates or hydrogencarbonates to be used; mixtures of different carbonates and hydrogencarbonates can instead be preferred.

In preferred agents according to the present invention, 2 to 20 wt %, preferably 3 to 15 wt %, and in particular 5 to 10 wt % of an alkali metal carbonate or hydrogencarbonate, as well as 1 to 15, preferably 2 to 12, and in particular 3 to 10 wt % of an acidifying agent, in each case based on the total weight of the agent according to the present invention, are used as an effervescence system.

Boric acid, as well as alkali metal hydrogensulfates, alkali metal dihydrogenphosphates, and other inorganic salts are usable, for example, as acidifying agents that release carbon dioxide from the alkali salts in aqueous solution. Organic acidifying agents are preferably used, however, citric acid being a particularly preferred acidifying agent. Also usable in particular, however, are the other solid mono-, oligo-, and polycarboxylic acids. Of this group, tartaric acid, succinic acid, malonic acid, adipic acid, maleic acid, fumaric acid, oxalic acid, and polyacrylic acid are in turn preferred. Organic sulfonic acids such as amidosulfonic acid are likewise usable. Sokalan® DCS (trademark of BASF), a mixture of succinic acid (max. 31 wt %), glutaric acid (max. 50 wt %) and adipic acid (max. 33 wt %), is commercially obtainable and likewise preferred for use as an acidifying agent in the context of the present invention.

Agents in which a substance from the group of the organic di-, tri-, and oligocarboxylic acids, or mixtures thereof, is used as an acidifying agent in the effervescence system are preferred in the context of the present invention.

Dyes and fragrances can be added to the agents according to the present invention in order to improve the aesthetic impression of the resulting products and make available to the consumer not only performance but also a visually and sensorially “typical and unmistakable” product. Individual aroma compounds, e.g. the synthetic products of the ester, ether, aldehyde, ketone, alcohol, and hydrocarbon types, can be used as perfume oils or fragrances. Aroma compounds of the ester type are, for example, benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether; the aldehydes, for example, the linear alkanals having 8-18 carbon atoms, citral, citronellal, citronellyloxyacetaldehyde, cyclamenaldehyde, hydroxycitronellal, lilial und bourgeonal; the ketones, for example, the ionones, (x-isomethylionone und methylcedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different aromas that together produce a corresponding fragrance note are used. Such perfume oils can also contain natural aroma mixtures, such as those accessible from plant sources, for example pine, citrus, jasmine, patchouli, rose, or ylang-ylang oil. Also suitable are muscatel, salvia oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

The fragrances can be incorporated directly into the agents according to the present invention, but it may also be advantageous to apply the fragrances onto carriers that ensure a slower fragrance release for longer-lasting fragrance. Cyclodextrins, for example, have proven successful as carrier materials of this kind; the cyclodextrin-perfume complexes can additionally be coated with further adjuvants.

In order to improve the aesthetic impression of the agents according to the present invention, it (or parts thereof) can be colored with suitable dyes. Preferred dyes, the selection of which will present absolutely no difficulty to one skilled in the art, possess excellent shelf stability and insensitivity to the other ingredients of the agents and to light, and no substantivity with respect to the substrates to be treated with the agents, such as glass, ceramics, or plastic dishes, in order not to color them.

The dispersions according to the present invention can furthermore contain, in addition to the active detergent or cleaning ingredients described above, nonaqueous organic solvents and/or thickeners.

The agent according to the present invention is the dispersion of a solid in a dispersion agent (suspension) which can also contain, inter alia, nonaqeous solvents. The term “solid suspension” does not, in the context of the present invention, exclude the fact that the solid substances contained in the agents according to the present invention are present, at least in part, in solution. Regardless of these dissolved portions, however, the agents according to the present invention comprise a portion of suspended solids. The aforementioned nonaqueous solvents derive, for example, from the groups of the monoalcohols, diols, triols or polyols, ethers, esters, and/or amides. Particularly preferred in this context are nonaqueous solvents that are water-soluble, “water-soluble” solvents in the context of the present application being solvents that are completely miscible, i.e. without miscibility gaps, with water at room temperature.

Nonaqueous solvents that can be used in the agents according to the present invention derive preferably from the group of the univalent or polyvalent alcohols, alkanolamines, or glycol ethers, provided they are miscible with water in the indicated concentration range. The solvents are preferably selected from ethanol, n- or i-propanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, etheylene glycol mono-n-butyl ether, diethylene glycol methyl ether, diethylene glycol ethyl ether, propylene glycol methyl, ethyl, or propyl ether, dipropylene glycol methyl or ethyl ether, methoxy-, ethoxy-, or butoxytriglycol, 1-butoxyethoxy-2-propanol, 3-methyl-3-methoxybutanol, propylene glycol-t-butyl ether, and mixtures of these solvents.

A dispersion according to the present invention that is particularly preferred in the context of the present invention is characterized in that it contains nonaqueous solvent(s) in amounts from 0.1 to 15 wt %, preferably from 0.2 to 12 wt %, particularly preferably from 0.4 to 8 wt %, very particularly preferably from 0.8 to 6 wt %, and in particular from 1 to 4 wt %, in each case based on the entire dispersion, preferred nonaqueous solvent(s) being selected from the group of the nonionic surfactants that are liquid at room temperature, the polyethylene glycols and polypropylene glycols, glycerol, glycerol carbonate, triacetin, ethylene glycol, propylene glycol, propylene carbonate, hexylene glycol, ethanol, and n-and/or isopropanol.

In addition to the aforesaid nonaqueous solvents, the dispersions according to the present invention can also contain further ingredients for viscosity regulation, with the use of which, for example, the sedimentation behavior or the pourability or fluidity can be specifically controlled. Combinations of structuring agents and thickeners have proven particularly successful in nonaqueous systems.

Dispersions according to the present invention that are preferred in the context of the present invention further contain
a) 0.1 to 1.0 wt % of one or more structuring agents, preferably from the group of the bentonites and/or at least partially etherified sorbitols; and/or
b) 0.1 to 1.0 wt % of one or more thickeners, preferably from the group of the amorphous or crystalline disilicates, in particular from the group of the pyrogenic silicic acids.
   The structuring agent a) derives from the group of the bentonites and/or at least partially etherified sorbitols. These substances are used to ensure the physical stability of the agents and to adjust viscosity.

Bentonites are unpurified clays that are produced by the weathering of volcanic tuffs. Because of their high montmorillonite content, bentonites possess valuable properties such as swellability, ion exchange capability, and thixotropy. It is possible to modify the properties of the bentonites in accordance with their intended use. Bentonites are a common clay constituent in tropical soils, and are mined as sodium bentonite, for example, in Wyoming (USA). Sodium bentonite exhibits the most favorable applications-engineering properties (swellability), so that its use is preferred in the context of the present invention. Naturally occurring calcium bentonites are obtained, for example, from Mississippi (USA) or Texas (USA) or from Landshut (Germany). The naturally obtained Ca bentonites are artificially converted into the more swellable Na bentonites by exchanging Ca for Na.

So-called montmorillonites, which can also be used in pure form in the context of the invention, represent the principal constituents of the bentonites. Montmorillonites are clay minerals, belonging to the phyllosilicates and in this case to the dioctahedral smectites, that crystallize in monoclinic-pseudohexagonal fashion. Montmorillonites form predominantly white, grayish-white, or yellow masses, which appear entirely amorphous, are easily pulverized, and swell in water but do not become plastic; they can be described by the following formulas:
Al₂[(OH)₂/Si₄O₁₀].nH₂O or
Al₂O₃.4SiO₂.H₂OnH₂O or
Al₂[(OH)₂/Si₄O₁₀] (dried at 150°).

Preferred dispersions according to the present invention are characterized in that montmorillonites are used as structuring agents. Montmorillonites possess a three-layer structure that comprises two tetrahedral layers that are electrostatically crosslinked by means of the cations of an octahedral intermediate layer. The layers are not rigidly connected, but can swell up by the reversible inclusion of water (in amounts of two to seven times) and other substances such as, for example, alcohols, glycols, pyridine, α-picoline, ammonium compounds, hydroxyaluminum silicate ions, etc. The formulas indicated above represent only approximate formulas, since montmorillonites possess excellent ion-exchange abilities. For example, Al can be exchanged for Mg, Fe²⁺, Fe³⁺, Zn, Cr, Cu and other ions. The result of such a substitution is a negative charge on the layers which is equalized by other cations, in particular Na⁺ and Ca²⁺.

In combination with the bentonites, or as a replacement for them if their use is not desirable, at least partially etherified sorbitols can be used as structuring agents.

Sorbitol is a hexavalent alcohol (sugar alcohol), one of the hexites, that relatively readily splits off one or two mol of water intramolecularly and forms cyclic ethers (e.g. sorbitan and sorbide). Water can also be split off intermolecularly, forming noncyclic ethers of sorbitol and the relevant alcohols. Here again, the formation of monoethers and bisethers is possible, and higher degrees of etherification, such as 3 and 4, can also occur. At least partially etherified sorbitols that are preferred for use in the context of the present invention are doubly etherified sorbitols, of which dibenzylidene sorbitol is particularly preferred. Automatic dishwashing agents that contain doubly etherified sorbitols, in particular dibenzylidene sorbitol, as structuring agents are preferred here.

The agents according to the present invention can contain the structuring agents in amounts from 0.1 to 1.0 wt %, based on the entire agent and on the active substance of the structuring agent. Preferred agents contain the structuring agents in amounts from 0.2 to 0.9 wt %, preferably in amounts from 0.25 to 0.75 wt %, and in particular in amounts from 0.3 to 0.5 wt %, in each case based on the entire agent.

Pyrogenic silicic acids are preferably used as thickeners. The preferred agents according to the present invention contain the thickeners in amounts from 0.2 to 1.3 wt %, by preference in amounts from 0.25 to 1.15 wt %, preferably in amounts from 0.3 to 1.05 wt %, and in particular in amounts from 0.35 to 0.95 wt %, in each case based on the entire agent.

Other substances usable as thickeners are the methyl- and ethylcelluloses, the polyurethanes, and the polyacrylates.

The water content of dispersions according to the present invention is, based on their total weight, by preference less than 30 wt %, by preference less than 23 wt %, preferably less than 19 wt %, particularly preferably less than 15 wt %, and in particular less than 12 wt %. Detergents or cleaning agents preferred according to the present invention are low in water or anhydrous. Particularly preferred detergents or cleaning agents according to the present invention are characterized in that the dispersion has, based on its total weight, a free water content below 10 wt %, preferably below 7 wt %, particularly preferably below 3 wt %, and in particular below 1 wt %.

Preferred agents according to the present invention are characterized by a density above 1.040 g/cm³. This high density decreases not only the overall volume of the detergents or cleaning agents according to the present invention. Particularly preferred detergents or cleaning agents according to the present invention are therefore characterized in that the dispersion has a density of 1.050 g/cm³, preferably above 1.060 g/cm³, or above 1.070 g/cm³, or above 1.080 g/cm³, or above 1.090 g/cm³, or above 1.100 g/cm³, or above 1.110 g/cm³, or above 1.120 g/cm³, or above 1.130 g/cm³, or above 1.140 g/cm³, or above 1.150 g/cm³, or above 1.160 g/cm³, or above 1.170 g/cm³, or above 1.180 g/cm³, or above 1.190 g/cm³, or above 1.200 g/cm³, or above 1.210 g/cm³, or above 1.220 g/cm³, or above 1.230 g/cm³, or above 1.240 g/cm³, or above 1.250 g/cm³, or above 1.260 g/cm³, or above 1.270 g/cm³, or above 1.280 g/cm³, or above 1.290 g/cm³, or above 1.300 g/cm³, or above 1.310 g/cm³, or above 1.320 g/cm³, or above 1.330 g/cm³, or above 1.340 g/cm³, or above 1.350 g/cm³, or above 1.360 g/cm³, or above 1.370 g/cm³, or above 1.380 g/cm³, or above 1.390 g/cm³, or above 1.400 g/cm³, or above 1.410 g/cm³, or above 1.420 g/cm³, or above 1.430 g/cm³, or above 1.440 g/cm³, or above 1.450 g/cm³, or above 1.460 g/cm³, or above 1.470 g/cm³, or above 1.480 g/cm³, or above 1.490 g/cm³, or above 1.050 g/cm³. Particularly preferred are those dispersions that have a density in the range between 1.040 und 1.700 g/cm³, preferably between 1.050 and 1.700 g/cm³, preferably between 1.060 and 1.700 g/cm³, preferably between 1.070 and 1.700 g/cm³, preferably between 1.080 and 1.700 g/cm³, preferably between 1.090 and 1.700 g/cm³, preferably between 1.100 and 1.700 g/cm³, preferably between 1.110 and 1.700 g/cm³, preferably between 1.120 and 1.700 g/cm³, preferably between 1.130 and 1.700 g/cm³, preferably between 1.140 and 1.700 g/cm³, preferably between 1.150 and 1.700 g/cm³, preferably between 1.160 and 1.700 g/cm³, preferably between 1.170 and 1.700 g/cm³, preferably between 1.180 and 1.700 g/cm³, preferably between 1.190 and 1.700 g/cm³, preferably between 1.200 and 1.700 g/cm³, preferably between 1.210 and 1.700 g/cm³, preferably between 1.220 and 1.700 g/cm³, preferably between 1.230 and 1.700 g/cm³, preferably between 1.240 and 1.700 g/cm³, preferably between 1.250 and 1.700 g/cm³, preferably between 1.260 and 1.700 g/cm³, preferably between 1.270 and 1.700 g/cm³, preferably between 1.280 and 1.700 g/cm³, preferably between 1.290 and 1.700 g/cm³, preferably between 1.300 and 1.700 g/cm³, preferably between 1.310 and 1.700 g/cm³, preferably between 1.320 and 1.700 g/cm³, preferably between 1.330 and 1.700 g/cm³, preferably between 1.340 and 1.700 g/cm³, preferably between 1.350 and 1.700 g/cm³, preferably between 1.360 and 1.700 g/cm³, preferably between 1.370 and 1.700 g/cm³, preferably between 1.380 and 1.700 g/cm³, preferably between 1.390 and 1.700 g/cm³, preferably between 1.400 and 1.700 g/cm³, preferably between 1.410 and 1.700 g/cm³, preferably between 1.420 and 1.700 g/cm³, preferably between 1.430 and 1.700 g/cm³, preferably between 1.440 and 1.700 g/cm³, preferably between 1.450 and 1.700 g/cm³, preferably between 1.460 and 1.700 g/cm³, preferably between 1.470 and 1.700 g/cm³, preferably between 1.480 and 1.700 g/cm³, preferably between 1.490 and 1.700 g/cm³, preferably between 1.050 and 1.700 g/cm³. Very particularly preferred are dispersions according to the present invention having a density between 1.040 and 1.670 g/cm³, preferably between 1.120 and 1.610 g/cm³, particularly preferably between 1.210 and 1.570 g/cm³, very particularly preferably between 1.290 and 1.510 g/cm³, and in particular between 1.340 and 1.480 g/cm³. The density indications refer in each case to the densities of the agents according to the present invention at 20° C.

The density of the dispersion agents used is preferably between 0.8 and 1.4 g/cm³ at 20° C. Particularly preferably, water-soluble or water-dispersible polymers having a density (20° C.) above 1.040 g/cm³, preferably in the range between 1.080 and 1.320 g/cm³, are used.

Detergents or cleaning agents preferred according to the present invention are characterized in that they dissolve in water (40° C.) in less than 12 minutes, by preference less than 10 minutes, preferably in less than 9 minutes, particularly preferably in less than 8 minutes, and in particular in less than 7 minutes. To determine the solubility, 20 g of the dispersion is introduced into the interior of a dishwasher (Miele G 646 PLUS). The main washing phase of a standard washing cycle (45° C.) is started. The solubility is determined by measuring the conductivity, which is recorded by means of a conductivity sensor. The dissolution process is complete when a conductivity maximum is reached. In the conductivity diagram, this maximum corresponds to a plateau. The conductivity measurement begins with activation of the circulation pump in the main washing phase. The quantity of water used is 5 liters.

The agents according to the present invention can be formulated and packaged in various ways. For example, dispersions according to the present invention can be extruded or cast or pressed into shape. Detergents or washing agents which contain the dispersion according to the present invention in particulate form with a size in the range between 0.5 and 5 mm are conceivable, but larger bodies having at least one side length in excess of 1 cm, for example above 1.5 cm, in particular above 2 cm, can be produced. Dispersions according to the present invention are thus also suitable, for example, as cavity fillers for cavity tablets or ring tablets.

In addition to the commercially usual water-insoluble polymer films, water-soluble or water-dispersible materials are also, in particular suitable for packaging the agents according to the present invention. Detergents or cleaning agents according to the present invention that comprise at least one water-soluble or water-dispersible encasing material are therefore particularly preferred in the context of the present application. Those agents according to the present invention in which the encasing materials used comprise a water-soluble or water-dispersible polymer are particularly preferred. Detergents or cleaning agents preferred according to the present invention are therefore characterized in that they comprise a water-soluble or water-dispersible packaging.

Some particularly preferred water-soluble or water-dispersible packaging materials are listed below:

a) water-soluble nonionic polymers from the group of the
a1) polyvinylpyrrolidones,
a2) vinylpyrrolidone/vinyl ester copolymers,
a3) cellulose ethers

b) water-soluble amphoteric polymers from the group of the
b1) alkylacrylamide/acrylic acid copolymers
b2) alkylacrylamide/methacrylic acid copolymers
b3) alkylacrylamide/methylmethacrylic acid copolymers
b4) alkylacrylamide/acrylic acid/alkylaminoalkyl(meth)acrylic acid copolymers
b5) alkylacrylamide/methacrylic acid/alkylaminoalkyl(meth)acrylic acid copolymers
b6) alkylacrylamide/methylmethacrylic acid/alkylaminoalkyl(meth)acrylic acid copolymers
b7) alkylacrylamide/alkylmethacrylate/alkylaminoethylmethacrylate/alkylmethacryl ate copolymers

b8) copolymers of
b8i) unsaturated carboxylic acids
b8ii) cationically derivatized unsaturated carboxylic acids
b8iii) if applicable, further ionic or nonionogenic monomers

c) water-soluble zwitterionic polymers from the group of the
c1) acrylamidoalkyltrialkylammonium chloride/acrylic acid copolymers and their alkali and ammonium salts
c2) acrylamidoalkyltrialkylammonium chloride/methacrylic acid copolymers and their alkali and ammonium salts
c3) methacroylethyl betaine/methacrylate copolymers

d) water-soluble anionic polymers from the group of the
d1) vinyl acetate/crotonic acid copolymers
d2) vinylpyrrolidone/vinyl acrylate copolymers
d3) acrylic acid/ethyl acrylate/N-tert.butylacrylamide terpolymers
d4) graft polymers of vinyl esters, esters of acrylic acid or methacrylic acid alone or mixed, copolymerized with crotonic acid, acrylic acid, or methacrylic acid with polyalkylene oxides and/or polykalkylene glycols
d5) grafted and crosslinked copolymers from the copolymerization of
   d5i) at least one monomer of the nonionic type,
   d5ii) at least one monomer of the ionic type,
   d5iii) polyethylene glycol, and
   d5iv) a crosslinker
d6) copolymers obtained by copolymerization of at least one monomer of each of the following three groups:
   d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group d6ii) with saturated or unsaturated, straight-chain or branched C₈₋₁₈ alcohols
d7) terpolymers of crotonic acid, vinyl acetate, and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters, or straight-chain allyl or methallyl esters
d9) crotonic acid copolymers with one or more monomers from the group of ethylene, vinylbenzene, vinyl methyl ether, acrylamide, and their water-soluble salts
d10) terpolymers of vinyl acetate, crotonic acid, and vinyl esters of a saturated monocarboxylic acid branched in the a- position

e) water-soluble cationic polymers from the group of the
e1) quaternized cellulose derivatives
e2) polysiloxanes having quaternized groups
e3) cationic guar derivatives
e4) polymeric dimethyidiallylammonium salts and their copolymers with esters and amides of acrylic acid and methacrylic acid
e5) copolymers of vinylpyrrolidone with quaternized derivatives of dialkylaminoacrylate and methacrylate
e6) vinylpyrrolidone-methoimidazolinium chloride copolymers
e7) quaternized polyvinyl alcohol
e8) polymers listed under the INCI names polyquaternium 2, polyquaternium 17, polyquaternium 18, and polyquaternium 27.

Water-soluble polymers for purposes of the invention are those polymers that are soluble in water at more than 2.5 wt %.

Preferred encasing materials preferably comprise, at least in part, a substance from the group of (acetalized) polyvinyl alcohol, polyvinylpyrrolidone, polyethylene oxide, gelatin.

“Polyvinyl alcohols” (abbreviated PVAL, occasionally also PVOH) is the term for polymers having the general structure 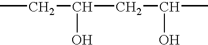
which also contain, in small proportions (approx. 2%), structural units of the type:

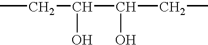

Commercially usual polyvinyl alcohols, which are presented as yellowish-white powders or granulates having degrees of polymerization in the range from approx. 100 to 2500 (molar weights from approx. 4000 to 100,000 g/mol), have degrees of hydrolysis of 98-99 or 87-89 mol %, i.e. still have a residual content of acetyl groups. The polyvinyl alcohols are characterized by manufacturers by indicating the degree of polymerization of the initial polymer, the degree of hydrolysis, the saponification number, or the solution viscosity.

Depending on the degree of hydrolysis, polyvinyl alcohols are soluble in water and in less highly polar organic solvents (formamide, dimethyl formamide, dimethyl sulfoxide); they are not attacked by (chlorinated) hydrocarbons, esters, fats, and oils. Polyvinyl alcohols are classified as toxicologically harmless, and are at least partially biodegradeable. The water solubility can be decreased by post-treatment with aldehydes (acetalization), by complexing with Ni or Cu salts, or by treatment with bichromates, boric acid, or borax. Coatings made of polyvinyl alcohol are largely impermeable to gases such as oxygen, nitrogen, helium, hydrogen, carbon dioxide, but allow water vapor to pass through.

It is preferred in the context of the present invention for an agent according to the present invention to comprise at least one packaging or encasing material that comprises at least in part a polyvinyl alcohol whose degree of hydrolysis is 70 to 100 mol %, preferably 80 to 90 mol %, particularly preferably 81 to 89 mol %, and in particular 82 to 88 mol %. In a preferred embodiment, at least 20 wt %, particularly preferably at least 40 wt %, very particularly preferably at least 60 wt %, and in particular at least 80 wt % of the at least one encasing material used is made up of a polyvinyl alcohol whose degree of hydrolysis is 70 to 100 mol %, preferably 80 to 90 mol %, particularly preferably 81 to 89 mol %, and in particular 82 to 88 mol %. Preferably at least 20 wt %, particularly preferably at least 40 wt %, very particularly preferably at least 60 wt %, and in particular at least 80 wt % of the entire encasing material used is made up of a polyvinyl alcohol whose degree of hydrolysis is 70 to 100 mol %, preferably 80 to 90 mol %, particularly preferably 81 to 89 mol %, and in particular 82 to 88 mol %.

Polyvinyl alcohols of a specific molecular-weight range are preferably used as encasing materials, it being preferred according to the present invention for the encasing material to comprise a polyvinyl alcohol whose molecular weight is in the range from 10,000 to 100,000 g/mol⁻¹, preferably from 11,000 to 90,000 gmol⁻¹, particularly preferably from 12,000 to 80,000 gmol⁻¹, and in particular from 13,000 to 70,000 gmol⁻¹.

The degree of polymerization of such preferred polyvinyl alcohols is between approximately 200 and approximately 2100, preferably between approximately 220 and approximately 1890, particularly preferably between approximately 240 and approximately 1680, and in particular between approximately 260 and approximately 1500. Detergents or cleaning agents preferred according to the present invention having a water-soluble or water-dispersible packaging are characterized in that the water-soluble or water-dispersible packaging material comprises polyvinyl alcohols and/or PVAL copolymers whose average degree of polymerization is between 80 and 700, preferably between 150 and 400, particularly preferably between 180 and 300, and/or whose molecular weight ratio MG(50%) to MG(90%) lies between 0.3 and 1, preferably between 0.4 and 0.8, and in particular between 0.45 and 0.6.

The polyvinyl alcohols described above are widely available commercially, for example under the trademark Mowiol® (Clariant). Polyvinyl alcohols particularly suitable in the context of the present invention are, for example, Mowiol® 3-83, Mowiole 4-88, Mowiol® 5-88, Mowiole 8-88, as well as L648, L734, Mowiflex LPTC 221 ex KSE, and compounds of Texas Polymers such as, for example, Vinex 2034.

Further polyvinyl alcohols that are particularly suitable as packaging materials may be inferred from the table below:

| | Degree of | Molar | Melting |
|---|---|---|---|
| Designation | hydrolysis (%) | weight (kDa) | point (° C.) |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23,600 | 100 |
| Gohsefimer ® LL02 | 41-51 | 17,700 | 100 |

Further polyvinyl alcohols suitable as materials for the water-soluble or water-dispersible films and/or containers are ELVANOL® 51-05, 52-22, 50-42, 85-82, 75-15, T-25, T-66, 90-50 (trademarks of Du Pont), ALCOTEX® 72.5, 78, B72, F80/40, F88/4, F88/26, F88/40, F88/47 (trademarks of Harlow Chemical Co.), Gohsenol®NK-05, A-300, AH-22, C-500, GH-20, GL-03, GM-14L, KA-20, KA-500, KH-20, KP-06, N-300, NH-26, NM11Q, (trademarks of Nippon Gohsei K.K.). ERKOL grades from Wacker are also suitable.

The water content of preferred PVAL packaging materials is by preference less than 10 wt %, preferably less than 8 wt %, particularly preferably less than 6 wt %, and in particular less than 4 wt %.

The water solubility of PVAL can be modified by post-treatment with aldehydes (acetalization) or ketones (ketalization). Polyvinyl alcohols that have been acetalized or ketalized with the aldehyde or keto groups of saccharides or polysaccharides or mixtures thereof have proven to be particularly preferred and, because of their decidedly good cold-water solubility, particularly advantageous. The reaction products of PVAL and starch are to be used in extremely advantageous fashion.

The solubility can furthermore be modified by complexing with Ni or Cu salts or by treatment with bichromates, boric acid, or borax, and thus adjusted specifically to desired values. Films made of PVAL are largely impermeable to gases such as oxygen, nitrogen, helium, hydrogen, carbon dioxide, but allow water vapor to pass through.

Examples of suitable water-soluble PVAL films are the PVAL films obtainable under the designation “SOLUBLON®” from Syntana Handelsgesellschaft E. Harke GmbH & Co. Their solubility in water can be adjusted to within one degree, and films of this product series are available that are soluble in the aqueous phase in every temperature range relevant for the application.

Preferred detergents or cleaning agents according to the present invention having a water-soluble or water-dispersible packaging are characterized in that the water-soluble or water-dispersible packaging comprises hydroxypropylmethylcellulose (HPMC) that has a degree of substitution (average number of methoxy groups per anhydroglucose unit of the cellulose) from 1.0 to 2.0, preferably from 1.4 to 1.9, and a molar substitution (average number of hydroxypropoxyl groups per anhydroglucose unit of the cellulose) from 0.1 to 0.3, preferably from 0.15 to 0.25.

Polyvinylpyrrolidones, abbreviated PVP, can be described by the following general formula: 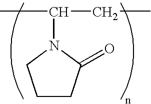
PVPs are produced by radical polymerization of 1-vinylpyrrolidone. Commercially usual PVPs have molar weights in the range from approx. 2,500 to 750,000 g/mol, and are offered as white, hygroscopic powders or as aqueous solutions.

Polyethylene oxides, abbreviated PEOX, are polyalkylene glycols of the general formula
H—[O—CH₂—CH₂]ₙ—OH,
which are produced industrially by basically catalyzed polyaddition of ethylene oxide (oxirane), in systems usually containing small amounts of water, with ethylene glycol as the starting molecule. They have molar weights in the range from approx. 200 to 5,000,000 g/mol, corresponding to degrees of polymerization n of approx. 5 to >100,000. Polyethylene oxides possess an extremely low concentration of reactive hydroxy end groups, and exhibit only weak glycol properties.

Gelatin is a polypeptide (molar weight: approx. 15,000 to >250,000 g/mol) that is obtained principally by hydrolysis, under acid or alkaline conditions, of the collagen contained in animal skin and bones. The amino acid composition of gelatin corresponds largely to that of the collagen from which it was obtained, and varies as a function of its provenience. The use of gelatin as a water-soluble encasing material is extremely prevalent especially in the pharmacy sector, in the form of hard or soft gelatin capsules. Gelatin is little used in the form of films because of its high price as compared with the polymers cited above.

Encasing materials that comprise a polymer from the group of starch and starch derivatives, cellulose and cellulose derivatives, in particular methylcellulose, and derivatives thereof, are preferred in the context of the present invention.

Starch is a homoglycan, the glucose units being linked in α-glycoside fashion. Starch is made up of two components of different molecular weights: approximately 20 to 30% straight-chain amylose (MW approx. 50,000 to 150,000) and 70 to 80% branched-chain amylopectin (MW approx. 300,000 to 2,000,000). Small amounts of lipids, phosphoric acid, and cations are also present. Whereas amylose, because of the bond in the 1,4- position, forms long, screw-shaped, looped chains having approximately 300 to 1,200 glucose molecules, in amylopectin the chain branches after an average of 25 glucose units because of the 1,6- bond, forming a branch-like structure having approximately 1,500 to 12,000 molecules of glucose. In addition to pure starch, starch derivatives that are obtainable from starch by polymer-analogous reactions are suitable in the context of the present invention for the production of water-soluble casings of the detergent, dishwashing agent and cleaning agent portions. Such chemically modified starches comprise, for example, products of esterification or etherification processes in which hydroxy hydrogen atoms were substituted. Starches in which the hydroxy groups have been replaced with functional groups that are not bound by means of an oxygen atom can also, however, be used as starch derivatives. Alkali starches, carboxymethyl starch (CMS), starch esters and ethers, and amino starches, for example, fall into the group of the starch derivatives.

Pure cellulose has the formal gross composition (C₆H₁₀O₅)n, and in formal terms constitutes a β-1,4-polyacetal of cellobiose, which in turn is made up of two molecules of glucose. Suitable celluloses comprise approx. 500 to 5,000 glucose units, and consequently have average molar weights of 50,000 to 500,000. Also usable in the context of the present invention as cellulose-based disintegration agents are cellulose derivatives that are obtainable from cellulose by means of polymer-analogous reactions. Such chemically modified celluloses comprise, for example, products of esterification or etherification processes in which hydroxy hydrogen atoms were substituted. Celluloses in which the hydroxy groups were replaced with functional groups that are not bound by means of an oxygen atom can also, however, be used as cellulose derivatives. Alkali celluloses, carboxymethylcellulose (CMC), cellulose esters and ethers, and aminocelluloses, for example, fall into the group of the cellulose derivatives.

Preferred water-soluble or water-dispersible packagings comprise a receiving container having at least one receiving chamber. Particularly preferred in the context of the present invention, however, are receiving containers that comprise two, three, four, or five receiving chambers. Each of these receiving chambers can furthermore comprise a closure part. According to the present invention, those detergents or cleaning agents whose water-soluble or water-dispersible packaging comprises at least one closure part are preferred. Two or more receiving chambers can also, for example, be sealed with a single closure part, but multiple receiving chambers can also each be equipped with a separate closure part.

The dissolution behavior of the water-soluble or water-dispersible packaging (container and closure part) can be influenced not only by the chemical composition of the encasing materials used but also, for example, by the thickness of the container walls or of the closure parts. Preferred agents are characterized in the content of the present application in that the container and/or the closure part(s) has/have a thickness from 5 to 2000 μm, preferably from 6 to 1000 pm, particularly preferably from 7 to 500 μm, very particularly preferably from 8 to 200 μm, and in particular from 10 to 100 μm. It is particularly preferred in this context to use containers and closure parts of different thicknesses, those agents whose closure parts have a lesser wall thickness as compared with the associated containers being advantageous.

Because the wall thickness of the water-soluble or water-dispersible packaging has an influence on the dissolution behavior of the agents according to the present invention, but because rapidly soluble detergents or cleaning agents are particularly preferred in the context of the present application, the water-soluble packaging of particularly preferred detergents or cleaning agents comprises a water-soluble or water-dispersible container and/or at least one water-soluble or water-dispersible closure part, the container and/or the closure part having a wall thickness of less than 200 μm, preferably less than 120 μm, particularly preferably less than 90 μm, and in particular less than 70 μm. In a particularly preferred embodiment, both the water-soluble or water-dispersible container and the water-soluble or water-dispersible closure part have a wall thickness of less than 200 μm, preferably less than 120 μm, particularly preferably less than 90 μm, and in particular less than 70 μm.

Preferred agents according to the present invention are characterized in that the water-soluble or water-dispersible packaging is at least in part transparent or translucent.

The packaging that is used is preferably transparent. “Transparency” for purposes of the invention is to be understood to mean that the transmissivity within the visible spectrum of light (410 to 800 nm) is greater than 20%, preferably greater than 30%, extremely preferably greater than 40%, and in particular greater than 50%. As soon as a wavelength of the visible spectrum of light exhibits a transmissivity greater than 20%, therefore, it is to be considered transparent for purposes of the invention.

If the packaging that is used, the encasing material that is used, comprises e.g. a receiving container and a closure part, then preferably at least the receiving container or the closure part is transparent or translucent. Packagings made up of a receiving container and closure part in which both the receiving container and the closure part are transparent or translucent are, however, particularly preferred.

Agents preferred according to the present invention that comprise at least in part a transparent encasing material can contain stabilizing agents. Stabilizing agents for purposes of the invention are materials that protect the ingredients present in the receiving chambers and/or in an interstice from decomposition or deactivation by light irradiation. Antioxidants, UV absorbers, and fluorescent dyes have proven particularly advantageous here.

Particularly suitable stabilizing agents for purposes of the invention are the antioxidants to prevent undesirable changes to the formulations caused by light irradiation and therefore radical decomposition, the formulations can contain antioxidants. Phenols, bisphenols, and thiobisphenols substituted, for example, with sterically hindered groups can be used as antioxidants. Further examples are propyl gallate, butylhydroxytoluene (BHT), butylhydroxyanisol (BHA), t-butylhydroquinone (TBHQ), tocopherol, and the long-chain (C8-22) esters of gallic acid, such as dodecylgallate. Other substance classes are aromatic amines, preferably secondary aromatic amines and substituted p-phenylenediamines, phosphorus compounds with trivalent phosphorus such as phosphines, phosphites, and phosphonites, citric acids and citric acid derivatives, such as isopropyl citrate, endiol-group-containing compounds, so-called reductones, such as ascorbic acid and its derivatives such as ascorbic acid palmitate, organosulfur compounds such as the esters of 3,3′-thiodipropionic acid with C₁₋₁₈ alkanols, in particular C₁₀₋₁₈ alkanols, metal ion deactivators that are capable of complexing the autooxidation-catalyzing metal ions such as, for example, copper, such as nitrilotriacetic acid and its derivatives, and mixtures thereof. Antioxidants can be contained in the formulations in amounts up to 35 wt %, preferably up to 25 wt %, particularly preferably from 0.01 to 20, and in particular from 0.03 to 20 wt %.

A further class of stabilizing agents usable in preferred fashion are the UV absorbers. UV absorbers can improve the light fastness of the formula constituents. They are to be understood as organic substances (light protection filters) that are capable of absorbing ultraviolet rays and reemitting the absorbed energy in the form of longer-wavelength radiation, e.g. heat. Compounds that exhibit these desired properties are, for example, the compounds and derivatives of benzophenone having substituents in the 2- and/or 4-position which act by radiationless deactivation,. Also suitable are substituted benzotriazoles, for example the water-soluble benzenesulfonic acid-3-(2H-benzotriazole-2-yl)-4-hydroxy-5-(methylpropyl)monosodium salt (Cibafast® H), acrylates phenyl-substituted in the 3-position (cinnamic acid derivatives), if applicable having cyano groups in the 2-position, salicylates, organic Ni complexes, and natural substances such as umbelliferone and endogenous urocanic acid. Biphenyl and especially stilbene derivatives, which are obtainable commercially from Ciba as Tinosorb® FD or Tinosorb® FR, are of particular importance. UV-B absorbers that may be mentioned are 3-benzylidene camphor and 3-benzylidene norcamphor and its derivatives, e.g. 3-(4-methylbenzylidene) camphor; 4-aminobenzoic acid derivatives, preferably 4-(dimethylamino)benzoic acid 2-ethylhexyl ester, 4-(dimethylamino)benzoic acid 2-octyl ester, and 4-(dimethylamino)benzoic acid amyl ester; esters of cinnamic acid, preferably 4-methoxycinnamic acid 2-ethylhexyl ester, 4-methoxycinnamic acid propyl ester, 4-methoxycinnamic acid isoamyl ester, 2-cyano-3,3-phenylcinnamic acid 2-ethylhexyl ester (octocrylene); esters of salicylic acid, preferably salicylic acid 2-ethylhexyl ester, salicylic acid 4-isopropylbenzyl ester, salicylic acid homomenthyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzalmalonic acid di-2-ethylhexyl ester; triazine derivatives, for example 2,4,6-trianilino-(p-carbo-2′-ethyl-1′-hexyloxy)-1,3,5-triazine and octyl triazone or dioctyl butamido triazone (Uvasorb® HEB); propane-1,3-diones, for example 1-(4-tert.butylphenyl)-3-(4′methoxyphenyl)propane-1,3-dione; ketotricyclo(5.2.1.0)decane derivatives. Additionally suitable are 2-phenylbenzimidazole-5-sulfonic acid and its alkali, alkaline-earth, ammonium, alkylammonium, alkanolammonium, and glucammonium salts; sulfonic acid derivatives of benzophenones, preferably 2-hydroxy-4-methoxybenzophenone-5-sulfonic acid and their salts; sulfonic acid derivatives of 3-benzylidene camphor, for example 4-(2-oxo-3-bornylidenemethyl)benzenesulfonic acid and 2-methyl-5-(2-oxo-3-bornylidene)sulfonic acid and their salts.

Typical UV-A filters that are suitable are, in particular, derivatives of benzoylmethane, for example 1-(4′-tert.butylphenyl)-3-(4′-methoxyphenyl)propane-1,3-dione, 4-tert.-butyl-4′-methoxydibenzoylmethane (Parsol 1789), 1-phenyl-3-(4′-isopropylphenyl)-propane-1,3-dione, as well as enamine compounds. The UV-A and UV-B filters can, of course, also be used in mixtures. In addition to the aforesaid soluble substances, insoluble light-protection pigments are also suitable for this purpose, namely finely dispersed, preferably nanoized metal oxides or salts. Examples of suitable metal oxides are, in particular, zinc oxide and titanium dioxide, and also oxides of iron, zirconium, silicon, manganese, aluminum, and cerium, as well as their mixtures. Silicates (talc), barium sulfate, or zinc stearate can be used as salts. The oxides and salts are already used, in the form of pigments, for skin-care and skin-protection emulsions and decorative cosmetics. The particles should have an average diameter of less than 100 nm, preferably between 5 and 50 nm, and in particular between 15 and 30 nm. They can exhibit a spherical shape, but those particles that possess an ellipsoidal shape or one otherwise deviating from a spherical form can also be used. The pigments can also be present in surface-treated fashion, i.e. hydrophilized or hydrophobized. Typical examples are coated titanium dioxides, for example titanium dioxide T 805 (Degussa) or Eusolex® T2000 (Merck). Suitable hydrophobic coating agents are, in particular, silicones and especially trialkoxysilanes or simethicones. Micronized zinc oxide is preferably used.

UV absorbers can be contained in amounts of up to 5 wt %, preferably up to 3 wt %, particularly preferably from 0.01 to 2.0, and in particular from 0.03 to 1 wt %, in each case based on the total weight of a substance mixture present in a receiving chamber or an interstice.

A further class of stabilizing agents to be used in preferred fashion is the fluorescent dyes. These include the 4,4′-diamino-2,2′-stilbenedisulfonic acids (flavonic acids), 4,4′-distyrylbiphenylene, methylumbelliferones, cumarins, dihydroquinolinones, 1,3-diarylpyrazolines, naphthalic acid imides, benzoxazole, benzisoxazole, and benzimidazole systems, and the heterocycle-substituted pyrene derivatives. The sulfonic acid salts of the diaminostilbene derivatives, as well as polymeric fluorescent materials, are of particular importance.

Fluorescent materials can be contained, based on the total weight of a substance mixture present in a receiving chamber or an interstice, in amounts of up to 5 wt %, preferably up to 3 wt %, particularly preferably from 0.01 to 2.0, and in particular from 0.03 to 1 wt %.

In a preferred embodiment, the aforesaid stabilizing agents are used in any desired mixtures. The stabilizing agents are used, based on the total weight of a substance mixture present in a receiving chamber, in amounts of up to 40 wt %, preferably up to 30 wt %, particularly preferably from 0.01 to 20 wt %, in particular from 0.02 to 5 wt %.

In a further preferred embodiment of the present application, agents according to the present invention are preferred which make possible in their container part, but preferably in their closure part, an apparatus for pressure equalization between the container interior and the surrounding atmosphere. A pressure equalization of this kind is preferred, in particular, for those agents according to the present invention whose container interior is filled with those liquid or solid active substances that tend to release gas during storage, after the container interior has been closed off with a closure part. The reason for such gas release is usually chemical reactions, in particular
reactions between the agents present in the container interior and the encasing materials; or
reactions between the agents present in the container interior and substances (e.g. water) that have diffused from outside through the encasing material into the container interior; or
reactions among the agents present in the container interior; or
decomposition reactions of individual agents present in the container interior, caused by light or heat.

The active substances that tend to release gas in accordance with any of the above-described reactions include, in particular, the bleaching agents described below, for example the percarbonates and perborates. Designated as an apparatus for pressure equalization in the context of the present application are, in particular, valves, but preferably micro-orifices, preferably micro-orifices having a diameter between 0.1 and 2 mm, particularly preferably between 0.2 and 1.5 mm, and in particular between 0.5 and 1 mm. These micro-orifices can be created, for example, automatically by perforators which “drill through” the packaging or encasing material; this “perforation” can be performed both before filling or sealing of the packaging and after sealing. If the receiving container or closure part is “drilled through” before filling or sealing, puncturing of the encasing material then preferably takes place from the inner side of the encasing material, ie. the side that is located on the inner side of the container after sealing, toward the outer side of the encasing material. In addition to micro-orifices, microchannels or the use of permeable encasing materials are also suitable for attaining pressure equalization.

The dispersions according to the present invention can contain a complete detergent or cleaning agent formula, but can also be used with particular advantage in combination with further detergent or cleaning agent ingredients, in particular with ingredients or ingredient mixtures that exhibit a different formulated form. These alternative formulated forms include, for example, solids such as powders, granulates, extrudates, compactates such as tablets, cast bodies, or dimensionally stable gels. The solid or liquid detergents or cleaning agents that are used in combination with the dispersions according to the present invention can, of course, comprise all ingredients contained in the sector of detergents or cleaning agents, although they preferably differ in composition from the composition of the agents according to the present invention. Particularly suitable as ingredients for the solid or liquid detergents or cleaning agents are the builders, surfactants, bleaching agents, bleach activators, polymers, enzymes, glass corrosion protection agents, silver protection agents, dyes, fragrances, pH adjusting agents, and bursting agents. To avoid repetition, the reader is referred to the previous sections for a more detailed description of these ingredients.

If the dispersions according to the present invention are combined with further solid or liquid detergents or cleaning agents into one end product, for example by using a water-soluble or water-dispersible packaging having one, two, three, or more receiving chambers, it is then preferred according to the present invention for the dispersion(s) according to the present invention to contain, based on the overall composition of the combination product:
at least 20 wt %, preferably at least 50 wt %, particularly preferably at least 70 wt %, and in particular at least 90 wt % of the anionic and/or cationic and/or amphoteric polymers contained in the combination product;
at least 20 wt %, preferably at least 40 wt %, particularly preferably at least 60 wt %, and in particular at least 80 wt % of the nonionic surfactants contained in the combination product; and/or
at least 10 wt %, preferably between 20 and 90 wt %, particularly preferably between 30 and 85 wt %, and in particular between 40 and 80 wt % of the builder, preferably the phosphate or citrate, contained in the combination product.

As stated previously, however, the agents according to the present invention are preferably formulated in water-soluble or water-dispersible packagings, in which context these packagings can comprise, for example, a container having one, two, three, four, or more receiving chambers. Suitable as ingredients for the receiving chambers, in addition to the dispersions according to the present invention, are also other liquids and solids such as powders, granulates, extrudates, compactates, cast bodies, or dimensionally stable gels. In addition to low-viscosity, pourable liquids or pourable gels or pourable dispersions, emulsions or suspensions, for example, are usable as liquids. Ingredients or ingredient combinations are considered “pourable” if they exhibit no inherent dimensional stability which makes them able, under usual conditions of production, storage, transport, and handling by the consumer, to assume a non-disintegrating three-dimensional shape, in which context that three-dimensional shape does not change under the aforesaid conditions even over a longer period, preferably 4 weeks, particularly preferably 8 weeks, and in particular 32 weeks, i.e., under the usual conditions of production, storage, transport, and handling by the consumer, remains in the three-dimensional geometric shape conditioned by production, i.e. does not deliquesce. The determination of pourability refers in particular to conditions usual for storage and transport, i.e. in particular to temperatures below 50° C., preferably below 40° C. Ingredients or ingredient combinations having a melting point below 25° C., preferably below 20° C., particularly preferably below 15° C., are therefore, in particular, considered liquids.

A number of possibilities therefore present themselves for the combination of the aforementioned formulated forms of solid and liquid detergents or cleaning agents with the dispersions according to the present invention. The tables below describe some preferred embodiments. The receiving chambers filled with liquid, powder, or granulate preferably comprise a seal. For the receiving chambers filled with compactates, extrudates, cast bodies, or dimensionally stable gels, sealing is optional but is preferred.

Water-soluble or water-dispersible packaging having one receiving chamber:

Receiving chamber 1
Dispersion according to the present invention and liquid
Dispersion according to the present invention and power
Dispersion according to the present invention and granulate
Dispersion according to the present invention and compactate
Dispersion according to the present invention and extrudate
Dispersion according to the present invention and cast body
Dispersion according to the present invention and dimensionally stable gel

Water-soluble or water-dispersible packaging having two receiving chambers

| Receiving chamber 1 | Receiving chamber 2 |
|---|---|
| Dispersion according to the present invention | Liquid |
| Dispersion according to the present invention | Powder |
| Dispersion according to the present invention | Granulate |
| Dispersion according to the present invention | Compactate |
| Dispersion according to the present invention | Extrudate |
| Dispersion according to the present invention | Cast body |
| Dispersion according to the present invention | Dimensionally stable gel |
| Dispersion according to the present invention | Dispersion according to |
| | the present invention 2 |
| Dispersion according to the present invention and powder | Liquid |
| Dispersion according to the present invention and powder | Powder |
| Dispersion according to the present invention and powder | Granulate |
| Dispersion according to the present invention and powder | Compactate |
| Dispersion according to the present invention and powder | Extrudate |
| Dispersion according to the present invention and powder | Cast body |
| Dispersion according to the present invention and powder | Dimensionally stable gel |
| Dispersion according to the present invention and powder | Dispersion according to |
| | the present invention 2 |
| Dispersion according to the present invention and granulate | Liquid |
| Dispersion according to the present invention and granulate | Powder |
| Dispersion according to the present invention and granulate | Granulate |
| Dispersion according to the present invention and granulate | Compactate |
| Dispersion according to the present invention and granulate | Extrudate |
| Dispersion according to the present invention and granulate | Cast body |
| Dispersion according to the present invention and granulate | Dimensionally stable gel |
| Dispersion according to the present invention and granulate | Dispersion according to |
| | the present invention 2 |
| Dispersion according to the present invention and compactate | Liquid |
| Dispersion according to the present invention and compactate | Powder |
| Dispersion according to the present invention and compactate | Granulate |
| Dispersion according to the present invention and compactate | Compactate |
| Dispersion according to the present invention and extrudate | Powder |
| Dispersion according to the present invention and extrudate | Granulate |
| Dispersion according to the present invention and extrudate | Compactate |
| Dispersion according to the present invention and extrudate | Extrudate |
| Dispersion according to the present invention and extrudate | Cast body |
| Dispersion according to the present invention and extrudate | Dimensionally stable gel |
| Dispersion according to the present invention and extrudate | Dispersion according to |
| | the present invention 2 |
| Dispersion according to the present invention and cast body | Liquid |
| Dispersion according to the present invention and cast body | Powder |
| Dispersion according to the present invention and cast body | Granulate |
| Dispersion according to the present invention and cast body | Compactate |
| Dispersion according to the present invention and cast body | Extrudate |
| Dispersion according to the present invention and cast body | Cast body |
| Dispersion according to the present invention and cast body | Dimensionally stable gel |
| Dispersion according to the present invention and cast body | Dispersion according to |
| | the present invention 2 |

Water-soluble or water-dispersible packaging having three receiving chambers:

| Receiving chamber 1 | Receiving chamber 2 | Receiving chamber 3 |
|---|---|---|
| Dispersion according to the present invention | Liquid | Liquid |
| Dispersion according to the present invention | Powder | Liquid |
| Dispersion according to the present invention | Granulate | Liquid |
| Dispersion according to the present invention | Compactate | Liquid |
| Dispersion according to the present invention | Extrudate | Liquid |
| Dispersion according to the present invention | Cast body | Liquid |
| Dispersion according to the present invention | Dimensionally stable gel | Liquid |
| Dispersion according to the present invention | Liquid | Powder |
| Dispersion according to the present invention | Powder | Powder |
| Dispersion according to the present invention | Granulate | Powder |
| Dispersion according to the present invention | Compactate | Powder |
| Dispersion according to the present invention | Cast body | Powder |
| Dispersion according to the present invention | Dimensionally stable gel | Powder |
| Dispersion according to the present invention | Liquid | Granulate |
| Dispersion according to the present invention | Powder | Granulate |
| Dispersion according to the present invention | Granulate | Granulate |
| Dispersion according to the present invention | Compactate | Granulate |
| Dispersion according to the present invention | Extrudate | Granulate |
| Dispersion according to the present invention | Cast body | Granulate |
| Dispersion according to the present invention | Dimensionally stable gel | Granulate |
| Dispersion according to the present invention | Liquid | Compactate |
| Dispersion according to the present invention | Powder | Compactate |
| Dispersion according to the present invention | Granulate | Compactate |
| Dispersion according to the present invention | Compactate | Compactate |
| Dispersion according to the present invention | Extrudate | Compactate |
| Dispersion according to the present invention | Cast body | Compactate |
| Dispersion according to the present invention | Dimensionally stable gel | Compactate |
| Dispersion according to the present invention | Liquid | Extrudate |
| Dispersion according to the present invention | Powder | Extrudate |
| Dispersion according to the present invention | Granulate | Extrudate |
| Dispersion according to the present invention | Compactate | Extrudate |
| Dispersion according to the present invention | Extrudate | Extrudate |
| Dispersion according to the present invention | Cast body | Extrudate |
| Dispersion according to the present invention | Dimensionally stable gel | Extrudate |
| Dispersion according to the present invention | Liquid | Cast body |
| Dispersion according to the present invention | Powder | Cast body |
| Dispersion according to the present invention | Granulate | Cast body |
| Dispersion according to the present invention | Compactate | Cast body |
| Dispersion according to the present invention | Extrudate | Cast body |
| Dispersion according to the present invention | Cast body | Cast body |
| Dispersion according to the present invention | Dimensionally stable gel | Cast body |
| Dispersion according to the present invention | Liquid | Dimensionally stable gel |
| Dispersion according to the present invention | Powder | Dimensionally stable gel |
| Dispersion according to the present invention | Granulate | Dimensionally stable gel |
| Dispersion according to the present invention | Compactate | Dimensionally stable gel |
| Dispersion according to the present invention | Extrudate | Dimensionally stable gel |
| Dispersion according to the present invention | Cast body | Dimensionally stable gel |
| Dispersion according to the present invention | Dimensionally stable gel | Dimensionally stable gel |
| Dispersion according to the present invention | Liquid | Dispersion according to |
| | | the present invention 2 |
| Dispersion according to the present invention | Powder | Dispersion according to |
| | | the present invention 2 |
| Dispersion according to the present invention | Granulate | Dispersion according to |
| | | the present invention 2 |
| Dispersion according to the present invention | Compactate | Dispersion according to |
| | | the present invention 2 |
| Dispersion according to the present invention | Extrudate | Dispersion according to |
| | | the present invention 2 |
| Dispersion according to the present invention | Cast body | Dispersion according to |
| | | the present invention 2 |
| Dispersion according to the present invention | Dimensionally stable gel | Dispersion according to |
| | | the present invention 2 |

If water-soluble or water-dispersible packagings are used for packaging of the agents according to the present invention, the dispersions according to the present invention are then formulated preferably alone or in combination with one or more solids (e.g. powders, granulates, extrudates, compactates, cast bodies, dimensionally stable gels) or liquids (e.g. liquids, pourable gels or dispersions), preferably with one or more powders, in one receiving chamber. Filling of the receiving chamber can be accomplished both simultaneously and in chronological sequence. Stepwise filling of the receiving chamber with the dispersion according to the present invention and one or more powders is particularly preferred, since in this fashion immobilized layer structures, whose multi-phase nature can be visually emphasized, for example, by the addition of corresponding dyes, can easily be produced inside a receiving chamber. Such multi-layer receiving chambers can comprise two, three, four, five, or more individual layers. The resulting multi-layer detergents or cleaning agents, packaged in water-soluble fashion, are characterized, because of the high density of the dispersions according to the present invention, by a density comparable to the densities of detergent or cleaning-agent tablets, but on the other hand are substantially more rapidly soluble, since no compressive pressures were used in order to produce them. Some examples of particularly preferred embodiments of these multi-phase receiving chambers having up to five layers are shown in the table below:

Water-soluble or water-dispersible receiving chamber having a two- or three-layer filling:

| Layer 1 | Layer 2 | Layer 3 |
|---|---|---|
| Dispersion according to the | Solid 1 | — |
| present invention | | |
| Dispersion according to the | Dispersion according to the | |
| present invention | present invention 2 | |
| Dispersion according to the | Solid 1 | Solid 2 |
| present invention | | |
| Solid 1 | Dispersion according to the | Solid 1 |
| | present invention | |
| Solid 1 | Dispersion according to the | Solid 2 |
| | present invention | |
| Dispersion according to the | Liquid 1 | — |
| present invention | | |
| Solid 1 | Dispersion according to the | Liquid 1 |
| | present invention | |
| Dispersion according to the | Solid 1 | Dispersion according to the present |
| present invention | | invention 2 |
| Dispersion according to the | Dispersion according to the | Solid 1 |
| present invention | present invention 2 | |
| Dispersion according to the | Liquid 1 | Dispersion according to the |
| present invention | | present invention 2 |

If one or more dispersion(s) according to the present invention is/are combined, according to one of the exemplifying embodiments described above, with further solids and/or liquids into a detergent or cleaning agent, the proportion by weight of the dispersion(s) according to the present invention in terms of the total weight of the resulting detergent or cleaning agent (leaving aside any optional water-soluble or water-dispersible packaging) is by preference between 5 and 95 wt %, preferably between 7 and 80 wt %, particularly preferably between 9 and 65 wt %, and in particular between 11 and 53 wt %.

If the dispersions according to the present invention are formulated in combination with a further liquid or solid detergent or cleaning agent, then in the context of the present application those combination products in which the liquid or solid detergent or cleaning agent dissolves more quickly than the dispersion according to the present invention are particularly preferred. Solid detergents or cleaning agents are considered in this context to be the powders, granulates, extrudates, compactates, or cast bodies already mentioned previously. Particularly preferred are combination products, made up of dispersion according to the present invention and powder and/or granulate and/or compactate and/or extrudate and/or cast body, in which the dispersion contains at least 40 wt %, by preference at least 60 wt %, preferably at least 70 wt %, particularly preferably at least 80 wt %, and in particular at least 90 wt % of all the nonionic surfactants and/or cationic polymers and/or amphoteric polymers contained in that combination product.

To determine the solubility, 20 g of the respective substance (dispersion or solid or liquid) is introduced into the interior of a dishwasher (Miele G 646 PLUS). The main washing phase of a standard washing cycle (45° C.) is started. The solubility is determined by measuring the conductivity, which is recorded by means of a conductivity sensor. The dissolution process is complete when a conductivity maximum is reached. In the conductivity diagram, this maximum corresponds to a plateau. The conductivity measurement begins with activation of the circulation pump in the main washing phase. The quantity of water used is 5 liters.

In this context, it should be noted that the dispersions according to the present invention contain by preference less than 5 wt %, preferably less than 3 wt %, particularly preferably less than 1 wt %, and in particular no waxes and/or fat(s) and/or triglyceride(s) and/or fatty acids and/or fatty alcohols or other high-melting-point, water-insoluble ingredients.

“Fat(s) and/or triglyceride(s)” is the designation for compounds of glycerol in which the three hydroxy groups of glycerol are esterified with carboxylic acids. The naturally occurring fats are triglycerides that, as a rule, contain various fatty acids in the same glycerol molecule. Synthetic triglycerides in which only one fatty acid is bound (e.g. tripalmitin, triolein, or tristearin) are, however, also accessible by saponification of the fats and subsequent esterification or reaction with acyl chlorides. Dispersions according to the present invention contain in predominant part no natural and/or synthetic fats and/or mixtures of the two. The weight proportion of fats in terms of the total weight of dispersions according to the present invention is by preference less than 4 wt %, preferably less than 3 wt %, particularly preferably less than 2 wt %, very particularly preferably less than 1 wt %, and in particular less than 0.5 wt %. Dispersions according to the present invention that contain no fats are particularly preferred.

In the present application, aliphatically saturated or unsaturated carboxylic acids having a branched or unbranched carbon chain are referred to as “fatty acids.” A number of production methods exist for producing fatty acids. Whereas the lower fatty acids are usually based on oxidative methods proceeding from alcohols and/or aldehydes as well as aliphatic or acyclic hydrocarbons, the higher homologs are still for the most part, even today, most easily accessible by means of the saponification of natural fats. As a result of progress in transgenic plants, almost unlimited possibilities now exist for varying the fatty acid spectrum in the stored fats of oil plants. Decanoic acid, undecanoic acid, lauric acid, tridecanoic acid, myristic acid, pentadecanoic acid, palmitic acid, margaric acid, stearic acid, nonadecanoic acid, arachidic acid, erucic acid, elaeostearic acid, are examples of such fatty acids.

“Fatty alcohol” is a collective term for the linear, saturated or unsaturated, primary alcohols, having 6 to 22 carbon atoms, obtainable by the reduction of triglycerides, fatty acids, or fatty acid esters. The fatty alcohols can be saturated or unsaturated, depending on the production method. Myristyl alcohol, 1-pentadecanol, cetyl alcohol, 1-heptadecanol, stearyl alcohol, erucyl alcohol, 1-nonadecanol, arachidyl alcohol, 1-heneicosanol, behenyl alcohol, erucyl alcohol, brassidyl alcohol are examples of such fatty alcohols.

Dispersions contain in predominant part no fatty acids and/or fatty alcohols and/or mixtures of the two. The weight proportion of fatty acids and/or fatty alcohols in terms of the total weight of dispersions according to the present invention is by preference less than 4 wt %, preferably less than 3 wt %, particularly preferably less than 2 wt %, very particularly preferably less than 1 wt %, and in particular less than 0.5 wt %. Dispersions according to the present invention that contain no fatty acids and/or fatty alcohols are particularly preferred.

“Waxes” are understood as a number of natural or artificially obtained substances that as a rule melt above 40° C. without decomposition, and just above the melting point are already relatively low in viscosity and not stringy. They exhibit a highly temperature-dependent consistency and solubility. Waxes are divided into three groups depending on their derivation: natural waxes, chemically modified waxes, and synthetic waxes.

The natural waxes include, for example, vegetable waxes such as candellila wax, carnauba wax, Japan wax, esparto grass wax, cork wax, guaruma wax, rice seed oil wax, sugar cane wax, ouricury wax, or montan wax; animal waxes such as beeswax, shellac wax, spermaceti, lanolin (wool wax), or uropygial grease; mineral waxes such as ceresin or ozocerite (earth wax); or petrochemical waxes such as petrolatum, paraffin waxes, or microcrystalline waxes.

The chemically modified waxes include, for example, hard waxes such as montan ester waxes, sassol waxes, or hydrogenated jojoba waxes.

Synthetic waxes are usually understood to be higher esters of phthalic acid, in particular dicyclohexyl phthalate, which is commercially available under the name Unimolle 66 (Bayer AG), as well as the synthetically produced waxes from lower carboxylic acids and fatty alcohols, for example dimyristyl tartrate, which is obtainable under the name Cosmacol® ETLP (Condea). Also belonging to the group of the synthetic waxes, conversely, are synthetic or partially synthetic esters from lower alcohols with fatty acids from natural sources. This substance class contains, for example, Tegin® 90 (Goldschmidt), a glycerol monostearate-palmitate, or shellac, for example Schellack-KPS-Dreiring-SP (Kalkhoff GmbH).

Also considered among the waxes in the context of the present invention are, for example, the so-called waxy alcohols. Waxy alcohols are higher-molecular-weight, water-insoluble fatty alcohols usually having 22 to 40 carbon atoms. The waxy alcohols occur, for example in the form of wax esters of higher-molecular-weight fatty acids (waxy acids), as a principal constituent of many natural waxes. Examples of waxy alcohols are lignoceryl alcohol (1-tetracosanol), cetyl alcohol, myristyl alcohol, or melissyl alcohol. The weight proportion of waxes in terms of the total weight of dispersions according to the present invention is by preference less than 4 wt %, preferably less than 3 wt %, particularly preferably less than 2 wt %, very particularly preferably less than 1 wt %, and in particular less than 0.5 wt %. Dispersions according to the present invention that contain no waxes are particularly preferred.

In a further preferred embodiment, the dispersions according to the present invention contain in predominant part no paraffin wax (paraffins) as dispersion agents. Paraffin waxes comprise principally alkanes, as well as small proportions of iso- and cycloalkanes. The weight proportion of paraffin waxes in terms of the total weight of dispersions according to the present invention is by preference less than 4 wt %, preferably less than 3 wt %, particularly preferably less than 2 wt %, very particularly preferably less than 1 wt %, and in particular less than 0.5 wt %. Dispersions according to the present invention that contain no paraffin waxes are particularly preferred.

Deep drawing methods, injection molding methods, or casting methods are suitable, for example, as shaping methods for the processing of encasing materials, i.e. for production of the water-soluble or water-dispersible packaging.

“Deep drawing methods” refers, in the context of the present application, to those methods in which a first film-like encasing material, after placement over a receiving cavity located in a female die forming the deep-drawing plane and shaping of the encasing material into that receiving cavity, is deformed by the action of pressure and/or vacuum. The encasing material can be pretreated before or during shaping by the action of heat and/or solvents and/or conditioning by way of relative humidities and/or temperatures modified with respect to ambient conditions. The pressure can act by way of two parts of a tool which behave as positive and negative with respect to one another, and which deform a film placed between those tools when pressed together. Also suitable as pressing forces, however, are the action of compressed air and/or the dead weight of the film and/or the dead weight of an active substance placed onto the upper side of the film.

The deep-drawn encasing materials are immobilized after deep drawing, inside the receiving cavity and in their three-dimensional shape achieved as a result of the deep-drawing operation, preferably by the use of a vacuum. The vacuum is preferably applied continuously from deep drawing until filling, preferably until sealing, and in particular until the receiving chambers are separated. The use of a discontinuous vacuum, however, for example for deep drawing the receiving chambers and (after an interruption) before and after filling of the receiving chambers, is also possible with comparable success. The continuous or discontinuous vacuum can also vary in its intensity and, for example, assume higher values at the beginning of the method (during deep drawing of the film) than at its end (during filling or sealing or separation).

As already mentioned, the encasing material can be pretreated, before or after shaping into the receiving cavities of the dies, by the action of heat. The encasing material, preferably a water-soluble or water-dispersible polymer film, is heated for up to 5 seconds, preferably for 0.1 to 4 seconds, particularly preferably for 0.2 to 3 seconds, and in particular for 0.4 to 2 seconds, to temperatures above 60° C, preferably above 80° C., particularly preferably between 100 and 120° C., and in particular to temperatures between 105 and 115° C. In order to dissipate this heat, but also in particular to dissipate the heat (e.g. melting) introduced by way of the agents dispensed into the deep-drawn receiving chambers, it is preferred to cool the dies that are used and the receiving cavities located in those dies. Cooling is accomplished by preference to temperatures below 20° C., preferably below 15° C., particularly preferably to temperatures between 2 and 14° C., and in particular to temperatures between 4 and 12° C. The cooling is preferably accomplished continuously, from the beginning of the deep-drawing operation until sealing and separation of the receiving chambers. Cooling fluids, preferably water, which are circulated in special cooling lines within the die, are particularly suitable for cooling.

This cooling, like the continuous or discontinuous application of a vacuum previously described, has the advantage of preventing the deep-drawn receptacles from shrinking back after deep drawing, thereby not only improving the appearance of the product of the method, but at the same time also preventing the emergence, beyond the rim of the receiving chambers, of the agents introduced into the receiving chambers, for example into the sealing regions of the chambers. Problems with sealing the filled chambers are thereby avoided.

With regard to the deep drawing method, a distinction can be made between methods in which the encasing material is guided horizontally into a shaping station and from there, in horizontal fashion, for filling and/or sealing and/or separation, and methods in which the encasing material is guided over a continuously circulating female die shaping roller (if applicable, optionally having a male die shaping roller, guided in the opposite direction, which guides the shaping plunger to the cavities of the female die shaping roller). The former process variant (the flat-bed process) can be operated both continuously and discontinuously; the process variant using a shaping roller is generally carried out continuously. All the aforesaid deep drawing methods are suitable for production of the agents preferred according to the present invention. The receiving cavities located in the female dies can be arranged “in line” or in offset fashion.

A further preferred method used for the production of water-soluble or water-dispersible containers according to the present invention is injection molding. Injection molding refers to the shaping of a molding compound in such a way that the compound for more than one injection molding operation, contained in a compound cylinder, is plastically softened under the action of heat, and flows under pressure through a nozzle into the hollow chamber of a previously closed tool. The method is applied principally to non-curable molding compounds that solidify in the tool by cooling. Injection molding is a very economical modern method for producing formed objects without cutting, and is particularly suited for automated mass production. In practical operation, the thermoplastic molding compounds (powders, grains, cubes, pastes, etc.) are heated until liquefied (up to 180° C.), and are then injected under high pressure (up to 140 MPa) into closed, preferably water-cooled hollow molds having two parts, i.e. comprising an impression die (formerly called a female die) and a mandrel (formerly called a male die), where they cool and solidify. Piston and screw injection molding machines are usable. Water-soluble polymers such as, for example, the aforementioned cellulose ethers, pectins, polyethylene glycols, polyvinyl alcohols, polyvinylpyrrolidones, alginates, gelatin, or starch, are suitable as molding compounds (injection-molding compounds).

The encasing materials can, however, also be cast to form hollow shapes. The hollow shape of the resulting water-soluble or water-dispersible portioned agents preferred according to the present invention comprises at least one solidified melt. This melt can be a molten pure substance of a mixture of multiple substances. It is, of course, possible to mix the individual substances of a multi-substance melt prior to melting, or to produce separate melts that are then combined. Melts made up of substance mixtures can be advantageous, for example, when eutectic mixtures form which are much lower-melting and thus decrease process costs.

In a preferred embodiment of the present invention, the encasing material cast into a hollow shape comprises at least in part a detergent or cleaning agent according to the present invention. The production of cast hollow shapes that are made up entirely of a washing or cleaning agent according to the present invention is particularly preferred.

Preferred portioned agents according to the present invention are characterized in that the hollow shape is made up of at least one material or material mixture whose melting point lies in the range from 40 to 1000° C., preferably from 42.5 to 500° C., particularly preferably from 45 to 200° C., and in particular from 50 to 160° C.

The material of the melt preferably exhibits a high water solubility that is, for example, above 100 g/l, solubilities above 200 g/l in distilled water at 20° C. being particularly preferred.

Such substances derive from a very wide variety of substance groups. In the context of the present invention, those melts that derive from the groups of the carboxylic acids, carboxylic acid anhydrides, dicarboxylic acids, dicarboxylic acid anhydrides, hydrogencarbonates, hydrogensulfates, polyethylene glycols, polypropylene glycols, sodium acetate trihydrate, and/or urea, have proven especially suitable as materials for the hollow shape. Portioned agents according to the present invention in which the material of the hollow shape comprises one or more substances from the groups of the carboxylic acids, carboxylic acid anhydrides, dicarboxylic acids, dicarboxylic acid anhydrides, hydrogencarbonates, hydrogensulfates, polyethylene glycols, polypropylene glycols, sodium acetate trihydrate, and/or urea, in amounts of at least 40 wt %, preferably at least 60 wt %, and in particular at least 80 wt %, in each case based on the weight of the hollow shape, are particularly preferred here.

In addition to the dicarboxylic acids, carboxylic acids and their salts are also suitable as materials for production of the open hollow shape. Of this substance class, in particular citric acid and trisodium citrate, as well as salicylic acid and glycolic acid, have proven suitable. It is also possible, in particularly advantageous fashion, to use fatty acids, preferably having more than 10 carbon atoms, and their salts, as materials for the open hollow shape. Carboxylic acids usable in the context of the present invention are, for example, hexanoic acid (caproic acid), heptanoic acid (oenanthic acid), octanoic acid (caprylic acid), nonanoic acid (pelargonic acid), decanoic acid (capric acid), undecanoic acid, etc. It is preferred in the context of the present compound to use fatty acids such as dodecanoic acid (lauric acid), tetradecanoic acid (myristic acid), hexadecanoic acid (palmitic acid), octadecanoic acid (stearic acid), eicosanoic acid (arachidic acid), docosanoic acid (behenic acid), tetracosanoic acid (lignoceric acid), hexacosanoic acid (cerotinic acid), triacontanoic acid (melissic acid), as well as the unsaturated species 9c-hexadecenoic acid (palmitoleic acid), 6c-octadeceneoic acid (petroselinic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid), and 9c,12c,15c-octadecatrienoic acid (linolenic acid). For cost reasons, it is preferred to use not the pure species but instead technical mixtures of the individual acids that are accessible by means of fat cleavage. Such mixtures are, for example, coconut oil fatty acid (approx. 6 wt % C₈, 6 wt% C₁₀, 48 wt % C₁₂, 18 wt % C₁₄, 10 wt % C₁₆, 2 wt % C₁₈, 8 wt % C_{18′}, 1 wt % C_{18″}), palm oil fatty acid (approx. 4 wt % C₈, 5 wt % C₁₀, 50 wt % C₁₂, 15 wt % C₁₄, 7 wt % C₁₆, 2 wt % C₁₈, 15 wt % C_{18′}, 1 wt % C_{18′}), tallow fatty acid (approx. 3 wt % C₁₄, 26 wt % C₁₆, 2 wt % C_{16′}, 2 wt % C₁₇, 17 wt % C₁₈, 44 wt % C_{18′}, 3 wt % C_{18″}, 1 wt % C_{18″}), hardened tallow fatty acid (approx. 2 wt % C₁₄, 28 wt % C,₆, 2 wt % C₁₇, 63 wt % C₁₈, 1 wt% C_{18′}), technical oleic acid (approx. 1 wt % C₁₂, 3 wt % C₁₄, 5 wt % C₁₆, 6 wt % C_{16′}, 1 wt % C₁₇, 2 wt % C₁₈, 70 wt % C_{18′}, 10 wt % C_{18″}, 0.5 wt % C_{18′″}), technical palmitic/stearic acid (approx. 1 wt % C₁₂, 2 wt % C₁₄, 45 wt % C₁₆, 2 wt % C₁₇, 47 wt % C₁₈, 1 wt % C_{18′}), and soybean oil fatty acid (approx. 2 wt % C₁₄, 15 wt % C₁₆, 5 wt % C₁₈, 25 wt % C_{18′}, 45 wt % C_{18″}, 7 wt % C_{18′″}).

The aforementioned carboxylic acids are for the most part obtained industrially from natural fats and oils by hydrolysis. Whereas alkaline saponification, already performed in the last century, resulted directly in the alkaline salts (soaps), what is used today on an industrial scale for cleavage is only water, which cleaves the fats into glycerol and the free fatty acids. Methods applied industrially are, for example, cleavage in an autoclave or continuous high-pressure cleavage. The alkali metal salts of the aforementioned carboxylic acids or carboxylic acid mixtures can also be used, if applicable mixed with other materials, for production of the open hollow shape. Also usable are, for example, salicylic acid and/or acetylsalicylic acid or their salts, preferably their alkali metal salts.

Further suitable materials that can be processed by means of the melt state into open hollow shapes are hydrogencarbonates, in particular the alkali metal hydrogencarbonates, especially sodium and potassium hydrogencarbonate, as well as the hydrogensulfates, in particular alkali metal hydrogensulfates, especially potassium hydrogensulfate or sodium hydrogensulfate. The eutectic mixture of potassium hydrogensulfate and sodium hydrogensulfate that comprises 60 wt % NaHSO₄ and 40 wt % KHSO₄ has also proven particularly suitable.

Further particularly suitable melt materials may be inferred from the table below:

| | Melting | Solubility |
|---|---|---|
| | point | [g/l |
| | [° C.] | H₂O] |
| Ammonium aluminum sulfate dodecahydrate | 93 | 150 |
| Potassium aluminum sulfate dodecahydrate | 92 | 110 |
| Aluminum sulfate monohydrate | 90 | 600 |
| Aluminum sulfate octadecahydrate | 90 | 600 |
| Sodium phosphinate monohydrate | 90 | 1000 |
| Sodium dihydrogenphosphate | 100 | 1103 |
| Sodium dihydrogenphosphate monohydrate | 100 | 1103 |
| Sodium ammonium hydrogenphosphate tetrahydrate | 79 | 167 |
| Disodium hydrogenphosphate heptahydrate | 48 | 154 |
| Trisodiumphosphate dodecahydrate | 75 | 258 |
| Tripotassium phosphate heptahydrate | 46 | 900 |
| Ammonium iron(II) sulfate hexahydrate | 100 | 269 |
| Iron sulfate heptahydrate | 64 | 400 |
| Glucose | 83 | 820 |
| Magnesium acetate tetrahydrate | 80 | 1200 |
| Manganese(II) chloride tetrahydrate | 58 | 1980 |
| Sodium acetate trihydrate | 58 | 762 |
| Sodium hydrogensulfate monohydrate | 58 | 670 |
| Sodium carbonate peroxyhydrate | 60 | 150 |
| Sodium thiosulfate pentahydrate | 48 | 680 |
| Potassium sodium tartrate tetrahydrate | 70-80 | 630 |
| D(+)-glucose monohydrate | 83 | 820 |
| Zinc acetate dihydrate | 100 | 430 |
| Zinc sulfate heptahydrate | 40 | 960 |

As is apparent from the table, sugars are also suitable materials for the melts. Agents which are characterized in that the material of the hollow shape comprises one or more substances from the group of the sugars and/or sugar acids and/or sugar alcohols, preferably from the group of the sugars, particularly preferably from the group of the oligosaccharides, oligosaccharide derivatives, monosaccharides, disaccharides, monosaccharide derivatives, and disaccharide derivatives and their mixtures, in particular from the group of glucose and/or fructose and/or ribose and/or maltose and/or lactose and/or sucrose and/or maltodextrin and/or Isomalt®, are therefore also further preferred.

The sugars, sugar acids, and sugar alcohols, have proven in the context of the present invention to be particularly suitable as materials for the melts. These substances are in general not only sufficiently soluble, but are moreover characterized by low cost and good processability. Sugars and sugar derivatives, in particular the mono- and disaccharides and their derivatives, can be processed e.g. in the form of their melts, those melts exhibiting good dissolution capacity both for dyes and for many active detergent and cleaning substances. The solid bodies resulting from solidification of the sugar melts are moreover characterized by a smooth surface and an advantageous appearance, such as transparency or a high surface gloss.

The group of sugars preferred as material for the melt in the context of the present application includes, from the group of the mono- and disaccharides and derivatives of mono- and disaccharides, in particular glucose, fructose, ribose, maltose, lactose, sucrose, maltodextrin, and Isomalt®, as well as mixtures of two, three, four, or more mono- and/or disaccharides and/or the derivatives of mono- and/or disaccharides. For example, mixtures of Isomalte and glucose, Isomalt® and lactose, Isomalt® and fructose, Isomalt® and ribose, Isomalt® and maltose, glucose and sucrose, Isomalt® and maltodextrin, or Isomalt® and sucrose are particularly preferred as materials for the melt. The weight proportion of Isomalt® in terms of the total weight of the aforesaid mixtures is preferably at least 20 wt %, particularly preferably at least 40 wt %, and in particular at least 80 wt %.

Also particularly preferred as material for the melt are mixtures of maltodextrin and glucose, maltodextrin and lactose, maltodextrin and fructose, maltodextrin and ribose, maltodextrin and maltose, or maltodextrin and sucrose. The weight proportion of maltodextrin in terms of the total weight of the aforesaid mixtures is preferably at least 20 wt %, particularly preferably at least 40 wt %, and in particular at least 80 wt %.

“Maltodextrin” refers, in the context of the present application, to water-soluble carbohydrates (dextrose equivalents DE 3-20) obtained by enzymatic breakdown of starch, having a chain length of 5 to 10 anhydroglucose units and a high proportion of maltose. Maltodextrin is added to foods in order to improve Theological and caloric properties, has only a slight sweet taste, and has no tendency to retrogression. Commercial products, for example from Cerestar, are usually offered as spray-dried free-flowing powders, and have a water content from 3 to 5 wt %.

The term “Isomalt®” refers, in the context of the present application, to a mixture of 6-O-α-D-glucopyranosyl-D-sorbitol (1,6-GPS) and 1-O-α-D-glucopyranosyl-D-mannitol (1,1-GPM). In a preferred embodiment, the weight proportion of 1,6-GPS in terms of the total weight of the mixture is less than 57 wt %. Such mixtures can be produced industrially, for example, by enzymatic transposition of sucrose into isomaltose and subsequent catalytic hydrogenation of the resulting isomaltose, forming an odorless, colorless, crystalline solid.

In a further preferred embodiment, the subject matter of the present invention is a detergent or cleaning agent in the form of a dispersion according to the present invention that is surrounded at least in part by a hollow shape made up of at least one solidified melt. Those hollow shapes that comprise at least one further solid body are particularly preferred, the at least one further solid body being present, at least in part, cast into the wall of the hollow shape.

In the context of the present invention, the term “hollow shape” characterizes a shape enclosing at least one space, such that the enclosed space can be filled or capable of being filled. In addition to the at least one enclosed space, the hollow shape can have further enclosed spaces and/or incompletely enclosed spaces. The hollow shape need not, in the context of the present invention, be made of a uniform wall material, but instead can also be assembled from multiple different materials.

The inclusion of at least one solid body into the wall of the hollow shape is possible, for example, by the fact that a hollow shell is produced from a first solidified melt, and at least in part encloses at least one solid body. This hollow shell can then be filled and closed, for example by means of a melt of differing composition. The two solidified melts together form the hollow shape of the agent preferred according to the present invention.

Analogously, at least one solid body can also be at least in part incorporated into the melt that closes off the hollow shell made of solidified melt. Once again the hollow shell of solidified melt, and the solidified melt that forms the “cover,” together form the hollow shape of the agent according to the present invention. In this embodiment, the hollow shell can at least in part enclose at least one solid body (in which case the hollow shape contains at least two solid bodies); it can, however, also be entirely free of a solid body, since the solid body enclosed at least in part by the closing-off melt is present, according to the present invention, at least in part cast into the wall of the hollow shape.

The portioned agents preferred according to the present invention comprise a hollow shape. This can be, for example, a hollow shell that is suitable for receiving the dispersion according to the present invention and that can, if applicable, be closed off. It is also possible, however (see above), to produce a hollow shell with no solid body inclusion, and to embed at least one solid body, at least in part, into a solidifying melt closing off the hollow shape. At least one further solid body is cast at least in part into the wall of this hollow shape. “Solid body” means, in the context of the presentinvention, that the body or bodies do not themselves melt at the melting temperature of the melt, and also do not dissolve in the melt. Upon processing into the portioned agents according to the present invention, therefore, the melts are therefore present, before cooling, as a pourable compound as well as solids. After cooling of the melts, the solids still represent discrete regions of the hollow shape wall, but the hollow shape as a whole is, of course, solid.

Preferred detergents or cleaning agents according to the present invention are characterized in that the water-soluble or water-dispersible packaging was produced at least in part by deep drawing or injection-molding or casting.

As already mentioned above, preferred water-soluble or water-dispersible containers are characterized by a closure part closing off the water-soluble or water-dispersible container at least in part. Such closure parts can be mounted onto the water-soluble or water-dispersible containers, in particular the deep-drawn body, injection-molded body, or melted body, with a variety of methods.

In the context of the present invention, those agents particularly are preferred whose water-soluble or water-dispersible container is joined to the water-soluble or water-dispersible closure part by means of an adhesive agent.

All substances or substance mixtures known to one skilled in the art for that purpose can be used as adhesive agents in the context of this application. Particularly suitable and particularly preferred in the context of the present application, however, are water-soluble or water-dispersible polymers or their mixtures, or solutions, in particular aqueous solutions, of those water-soluble or water-dispersible polymers, or solutions, in particular aqueous solutions, of those mixtures. Aqueous solutions of polyvinyl alcohol, polyvinylpyrrolidone, polyethylene oxide, gelatin, or polymers from the group of starch and starch derivatives, cellulose and cellulose derivatives, in particular methylcellulose, are particularly preferred.

Additionally preferred are water-soluble melt adhesives, in particular melt adhesives that contain
a) 40 to 70 wt % of at least one homo- or copolymer with free carboxylic acid groups based on ethylenically unsaturated monomers (component A),
b) 15 to 45 wt % of at least one water-soluble orwater-dispersible polyurethane (component B), and
c) 10 to 45 wt % of at least one inorganic or organic base (component C), as well as
d) 0 to 20 wt % of further additives, the sum of the components yielding 100 wt %.

Lastly, however, pure solvents, in particular water, or solutions of inorganic or organic salts, in particular aqueous solutions of inorganic or organic salts, are also usable as adhesive agents and preferred in the context of the present invention.

The method for adhesively bonding the deep-drawn bodies, injection-molded bodies, or melted bodies can be varied within wide limits as a function of production requirements. One particularly preferred method for adhesively bonding water-soluble or water-dispersible receiving containers, in particular water-soluble or water-dispersible deep-drawn bodies, injection-molded bodies, or melted bodies, to water-soluble or water-dispersible closure parts will be described below.

In a first preferred method for producing formulated dispersions according to the present invention,
a) a water-soluble or water-dispersible deep-drawn body or injection-molded body, or a cast body produced from a dispersion according to the present invention, preferably a cast body filled with one or more further substances or substance mixtures,
b) has an adhesive agent applied to it and
c) is closed off in adhesive fashion with a water-soluble or water-dispersible closure part.

In a preferred embodiment of this method, application of the adhesive agent in step b) is accomplished by means of a roller, a circulating conveyor belt, a spray apparatus, or a plunger.

In preferred variant methods, closure parts made of water-soluble or water-dispersible polymers are used as the closure part in step c), in which context, for example, film webs or prefabricated closure labels can be used as closure parts.

In a second preferred method for producing formulated dispersions according to the present invention,
a) a water-soluble or water-dispersible deep-drawn body or injection-molded body, or a cast body produced from a dispersion according to the present invention, preferably a cast body filled with one or more further substances or substance mixtures,
b) is closed off in adhesive fashion with a water-soluble or water-dispersible closure part that
c) previously had an adhesive agent applied to it.

Once again, it is preferred to perform the application of the adhesive agent by means of a roller, a circulating conveyor belt, a spray apparatus, or a plunger; it is particularly preferred in the case of this method to perform the closure part not over its entire surface but instead exclusively in the regions that are actually adhesively bonded to the surface of the corresponding body. Here again, closure parts made of water-soluble or water-dispersible polymers, in particular in the form of film webs or prefabricated closure labels, are preferably used.

If closure parts (e.g. film webs) that do not close off the corresponding bodies in accurately fitting fashion are used in the methods described above, those closure parts must, subsequent to adhesive bonding, be cut to their final size. Knives and/or punches and/or lasers are preferably used for this method step in the context of the present application.

In summary, in the context of the present application a method for formulating dispersions according to the present invention in which
a) a detergent or cleaning agent in the form of a dispersion of solid particles in a dispersion agent that comprises, based on its total weight,
   i) 10 to 65 wt % dispersion agent and
   ii) 30 to 90 wt % dispersed materials, characterized in that the dispersed materials contain, based on their total weight, 0.1 to 50 wt % of an anionic and/or cationic and/or amphoteric polymer, is cast into a cast body having a receiving chamber;
b) the receiving chamber is filled with at least one active detergent or cleaning substance;
c) the filled receiving chamber is closed off in adhesive fashion with a water-soluble or water-dispersible closure part;
d) the corresponding adhesive agent having previously been applied, by means of rollers, a circulating conveyor belt, a spray apparatus, or a plunger, onto the cast body and/or the closure body, is preferred.

As described previously, preferred deep-drawn or injection-molded bodies for the dispersions according to the present invention, and the closure parts for the deep-drawn, injection-molded, or cast bodies are water-soluble or water-dispersible. It is therefore preferred in the context of the present application to produce those agents in which the corresponding bodies and the corresponding closure parts comprise at least one water-soluble or water-dispersible encasing material. Those agents according to the present invention in which the encasing materials used comprise a water-soluble or water-dispersible polymer are particularly preferred.

Particularly preferred agents are characterized in that they comprise at least two different encasing materials having different dissolution behaviors, these preferably differing on the basis of their chemical composition. The dissolution behavior of the deep-drawn, injection-molded, or cast bodies, and of the closure part that is used to seal the bodies, can be influenced not only by the chemical composition of the encasing materials used but also, for example, by the thickness of the walls of the deep-drawn, injection-molded, or cast bodies or of the walls of the closure parts. Preferred deep-drawn or injection-molded bodies are characterized in the context of the present application in that the sidewalls, made of the first encasing material, of the receiving chambers exhibit a thickness from 5 to 2000 μm, preferably from 10 to 1000 μm, particularly preferably from 15 to 500 μm, very particularly preferably from 20 to 200 μm, and in particular from 25 to 100 μm. Preferred cast bodies, in contrast, are characterized in that the wall thickness of the cast bodies, provided they have a receiving chamber, is between 0.1 and 25 mm, preferably between 0.5 and 20 mm, and in particular between 1 and 15 mm. The closure part used for sealing has a thickness preferably from 5 to 100 μm, particularly preferably from 6 to 80 μm, and in particular from 7 to 50 μm. It is particular preferred for the deep-drawn, injection-molded, or cast body and the closure part to have different thicknesses, those deep-drawn, injection-molded, or cast bodies whose wall thickness is greater than the wall thickness of the corresponding closure part being advantageous.

As may be inferred from what is stated above, these preferred agents according to the present invention are suitable in particular fashion for controlled release of the active substances contained in them, in particular the active substances from the group of the detergents or cleaning agents.

An embodiment according to which the deep-drawn, injection-molded, or cast body as a whole is water-soluble, i.e. completely dissolves when used as intended during washing or automatic cleaning when the conditions provided for dissolution are achieved, is therefore preferred according to the present invention. The substantial advantage of this embodiment is that the deep-drawn, injection-molded, or cast body at least partially dissolves in the cleaning bath, under precisely defined conditions, within a practically relevant short time (a few seconds to five minutes, as a non-limiting example), and thus introduces the encased contents, i.e. the active cleaning material or multiple materials, into the bath in accordance with requirements,. This release can be controlled or regulated in various ways.

In a first embodiment of the invention that is particularly preferred because of advantageous properties, the water-soluble deep-drawn, injection-molded, or cast body comprises regions that are less water-soluble or indeed not water-soluble or are water-soluble only at higher temperature, and regions that are readily water-soluble or water-soluble at lower temperature. In other words: the body is made not of a uniform material exhibiting the same water solubility in all regions, but of materials of differing water solubility. Regions of good water solubility, on the one hand, are to be distinguished from regions having less good water solubility, having poor or indeed no water solubility, or from regions in which the water solubility reaches the desired value only at higher temperature or only at a different pH or only in the context of a modified electrolyte concentration, on the other hand. The consequence of this can be that, in a context of use as intended under adjustable conditions, certain regions of the deep-drawn, injection-molded, or cast body dissolve while other regions remain intact. The result is to form a body equipped with pores or orifices into which water and/or bath can penetrate, dissolve active detergent, washing, or cleaning ingredients, and pour out of the body. In similar fashion, systems in the form of multi-chambered deep-drawn, injection-molded, or cast bodies, or in the form of bodies arranged one within another (“onion” systems), can also be provided. Systems with controlled release of the active detergent, washing, or cleaning ingredients can thus be produced.

The invention is subject to no limitations as regards the embodiment of such systems. For example, containers can be provided in which a uniform polymer material comprises small regions of incorporated compounds (e.g. salts) that are more rapidly water-soluble than the polymer material. On the other hand, multiple polymer materials having differing water solubilities can also be mixed (polymer blend), so that the more rapidly soluble polymer material is disintegrated by water or the bath, under defined conditions, more quickly than the more slowly soluble one.

Corresponding to a particularly preferred embodiment of the invention is the fact that the regions of the deep-drawn, injection-molded, or cast body that are less readily water-soluble, or not water-soluble at all, or water-soluble only at higher temperature, are made of a material that substantially corresponds chemically to that of the readily water-soluble regions or the regions water-soluble at lower temperature, but have a greater layer thickness and/or have a modified degree of polymerization of the same polymer and/or have a higher degree of crosslinking of the same polymer structure and/or have a higher degree of acetalization (in the case of PVAL, for example with saccharides, polysaccharides, such as starch) and/or contain water-insoluble salt components and/or contain water-insoluble polymers. Even taking into account the fact that the containers do not completely dissolve, it is thereby possible to make available portioned detergent or cleaning agent compositions according to the present invention that have advantageous properties in the context of the release of active substances, in particular active substances from the group of the detergents or cleaning agents, into the respective bath.

In addition to this controlled release by way of specific selection of the encasing materials used, however, further methodologies are also available to one skilled in the art. An alternative procedure, which is suitable alone or in combination with the aforesaid control by way of the selection of specific encasing materials for controlled release of active substances or active substance mixtures, is the integration of one or more “switches” into the aforesaid active substances, active substance mixtures, or active substance preparations.

Possible “switches” that influence the dissolution behavior of the active substances enclosed in the deep-drawn, injection-molded, or cast bodes according to the present invention are, in particularly preferred embodiments, physico-chemical parameters. Examples of these, which nevertheless should not be understood as a limitation, are
the mechanical stability of, for example, an optionally used capsule, coating, or an optionally used compacted shaped body such as a tablet, which - as a function of time, temperature or other parameters—can be a factor determining disintegration;
the solubility of optionally used capsules or coatings or molds as a function of pH and/or temperature and/or ionic strength;
the dissolution rate of optionally used capsules or coatings or molds as a function of pH and/or temperature and/or ionic strength;
the melting behavior (melting point) of optionally used capsules or coatings or molds as a function of pH and/or temperature and/or ionic strength.

In a particularly preferred embodiment, the deep-drawn, injection-molded, or cast body according to the present invention comprises at least one active substance or active substance preparation whose release is delayed. The delayed release is accomplished, preferably, by the use of at least one of the previously described means, but in particular by the use of different packaging materials and/or the use of selected coating materials, it being particularly preferred for this delayed release to occur, in the context of the use of active substances or active substance mixtures from the group of the detergents or cleaning agents, at the earliest 5 minutes, preferably at the earliest 7 minutes, particularly preferably at the earliest 10 minutes, very particularly preferably at the earliest 15 minutes, and in particular at the earliest 20 minutes after the beginning of the cleaning or washing process. The use of meltable coating materials from the group of the waxes or paraffins is particularly preferred in this context.

Active substances that are released with particular preference in delayed fashion are the fragrances, polymers, surfactants, bleaching agents, and bleach activators.

Particularly preferably, however, fragrances and/or surfactants are released in delayed fashion.

Particularly preferred in the context of the present application, therefore, are cast detergent or cleaning agent bodies in form of a dispersion of solid particles in a dispersion agent, which dispersion comprises, based on its total weight,

a) 10 to 65 wt % dispersion agent and

b) 30 to 90 wt % dispersed materials,

wherein the dispersed materials contain, based on their total weight, 0.1 to 50 wt % of an anionic and/or cationic and/or amphoteric polymer, the cast body comprising a receiving chamber or cavity which is filled at least in part with a cleaning agent component that comprises

c) 5 to 95 wt % surfactants and

d) 5 to 95 wt % meltable substance(s) having a melting point above 30° C. and a water solubility of less than 20 g/l at 20° C. and

e) optionally, further ingredients of detergents or cleaning agents.

Particularly preferred are those cast bodies in which nonionic surfactants, preferably nonionic surfactant(s) having a melting point above 20° C., preferably above 25° C., particularly preferably between 25 and 60° C., and in particular between 26.6 and 43.3° C., are used as ingredient c).

Particularly suitable as nonionic surfactants are:
ethoxylated nonionic surfactant(s) that was/were obtained from C₆₋₂₀ monohydroxyalkanols or C₆₋₂₀ alkyl phenols or C₁₆₋₂₀ fatty alcohols and more than 12 mol, preferably more than 15 mol, and in particular more than 20 mol, ethylene oxide per mol of alcohol,
ethoxylated and propoxylated nonionic surfactants in which the propylene oxide units in the molecule constitute up to 25 wt %, preferably up to 20 wt %, and in particular up to 15 wt % of the total molar weight of the nonionic surfactant,
nonionic surfactants of the formula
   R¹O[CH₂CH(CH₃)O]ₓ[CH₂CH₂O]_{y}[CH₂CH(OH)R²],
   in which R¹ denotes a linear or branched aliphatic hydrocarbon radical having 4 to 18 carbon atoms, or mixtures thereof; R² designates a linear or branched hydrocarbon radical having 2 to 26 carbon atoms or mixtures thereof; and x denotes values between 0.5 and 15, and y a value of at least 15;
end-capped poly(oxyalkylated) nonionic surfactants of the following formula:
   R¹O[CH₂CH(R³)O]ₓ[CH₂]ₖCH(OH)[CH₂]ⱼOR²,
   in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, preferably between 1 and 5, surfactants of the type
   R¹O[CH₂CH(R³)O]ₓCH₂CH(OH)[CH₂]OR²,
   in which x denotes numbers from 1 to 30, preferably from 1 to 20, and in particular from 6 to 18 being particularly preferred;
polyoxyalkyated nonionic surfactants of the general formula
   R¹O[EO]ₓ[PO]_{y}[BO]_{z},
   in which R¹ denotes linear or branched, saturated or unsaturated, aliphatic or aromatic hydrocarbon radicals having 6 to 20 carbon atoms, x denotes values between 2 and 30, y denotes values between 0 and 30, and z denotes values between 1 and 30;
nonionic surfactants of the general formula
   R¹O[CH₂CH(R³)O]ₓR²,
in which R¹ denotes linear or branched, saturated or unsaturated, aliphatic or aromatic hydrocarbon radicals having 1 to 30 carbon atoms; R² denotes linear or branched, saturated or unsaturated, aliphatic or aromatic hydrocarbon radicals having 1 to 30 carbon atoms which have 1 to 5, preferably 1 hydroxy group; R³ denotes H or a methyl, ethyl, n-propyl, isopropyl, n-butyl, 2-butyl, or 2-methyl-2-butyl radical; x denotes values between 1 and 30.

One or more substances having a melting range between 30 and 100° C., preferably between 40 and 80° C., and in particular between 50 and 75° C. are preferably used as ingredient d), ingredient b) particularly preferably containing at least one paraffin wax having a melting range from 30° C. to 65° C. Further preferred ingredients d) are the waxes and/or fat(s) and/or triglyceride(s) and/or fatty acids and/or fatty alcohols described previously.

The water solubility of ingredient d) at 20° C. is preferably less than 15 g/l, preferably less than 10 g/l, particularly preferably less than 5 g/l, and in particular less than 2 g/l.

The cast bodies described previously, having a filled receiving chamber or cavity, can have, for example, the appearance of the two-phase or multi-phase core tablets or two-phase or multi-phase ring tablets known to one skilled in the art, without actually having been subjected to tableting.

A further preferred method for formulating detergents or cleaning agents according to the present invention is processing of the dispersions into dimensionally stable bodies having a receiving cavity or into hollow bodies, and introduction of the further active detergent or cleaning preparation into that cavity or inner space. The resulting combination products can additionally comprise a water-soluble or water-dispersible packaging. Further preferred in the context of the present application, therefore, are detergents or cleaning agents in which the first active detergent or cleaning preparation forms a hollow body in whose inner space the further active detergent or cleaning preparation is at least in part comprised.

In the interest of increased sedimentation stability, it is preferred for the substances dispersed in the agents according to the present invention to be used in as finely divided a fashion as possible. This is advantageous in particular in the context of the polymers, builders, inorganic thickeners, and bleaching agents. Automatic dishwashing agents according to the present invention in which the average particle size of the polymers, builders, thickeners, or bleaching agents is less than 75 μm, preferably less than 50 μm, and in particular less than 25 μm are preferred here. Agents according to the present invention in which at least 50 wt %, preferably at least 70 wt %, particularly preferably at least 80 wt %, and in particular at least 90 wt % of the dispersed polymers and/or builders and/or bleaching agents have a particle size below 90 μm, by preference below 80 μm, preferably below 70 μm, particularly preferably below 60 μm, and in particular below 50 μm, are particularly preferred.

The dispersed materials or the dispersions can be, for example, milled in order to achieve such particle sizes. Both dry milling and wet milling are suitable for milling. Dry milling can be accomplished in all mills known in the existing art, pinned disk mills, impact crushers, and air-jet mills being listed, merely by way of example, as suitable devices. Milling is accomplished, particularly preferably, in an impact crusher or air-jet mill. For the particularly preferred wet milling, once again all milling equipment known in the existing art is usable; annular-gap ball mills, rolling mills, colloid mills, and inline dispersion mixers may be listed by way of example. Wet milling in a rolling mill is performed with particular advantage.

A further subject of the present invention is the use of an agent according to the present invention as a cleaning agent in a dishwasher.

### EXAMPLES

Two cleaning agents, of compositions V1 and E1, were produced. The constituents of cleaning agent V1 were compressed into tablets. For the production of cleaning agent E1, a portion of the STTP, the nonionic surfactant, the bleach activator, the polyacrylate, the glass corrosion protection agent, the silver protection agent, and the dispersion agent were kneaded into a dispersion, and the remaining constituents were mixed into a powder. This powder, together with the dispersion, constitutes agent E1 according to the present invention. The density of the dispersion was 1.37 g/cm³

TABLE 1
Composition of pre-mixes [parts by weight]:

| | | | E1 | E1 |
|---|---|---|---|---|
| | V1 | E1 | dispersion | powder |
| STTP | 57.0 | 57 | 15.0 | 42.0 |
| Nonionic surfactant | 12.5 | 12.5 | 12.5 | |
| Sodium carbonate | 6.0 | 6 | | 6.0 |
| Bleaching agent¹⁾ | 7.0 | 7 | | 7.0 |
| Bleach activator²⁾ | 0.5 | 0.5 | 0.5 | |
| Polyacrylate³⁾ | 10.0 | 10 | 10.0 | |
| Sodium silicate | 2.0 | 2 | | 2.0 |
| Dye | 0.5 | 0.5 | | 0.5 |
| Enzyme⁴⁾ | 3.0 | 3 | | 3.0 |
| Glass corrosion protection agent⁵⁾ | 1.0 | 1 | 1.0 | |
| Silver protection agent⁶⁾ | 0.5 | 0.5 | 0.5 | |
| Dispersion agent⁷⁾ | | 8.0 | 8.0 | |

¹⁾Percarbonate
²⁾TAED
³⁾Acrylic acid-sulfonic acid copolymer
⁴⁾Protease, amylase
⁵⁾Zinc acetate
⁶⁾Manganese sulfate
⁷⁾PEG 3000

Dissolution Behavior

To determine the solubility, 20 g each of comparison product V1, combination product E1, the dispersion (E1 dispersion), and the powder (E1 powder) were introduced into the interior of a dishwasher (Miele G 646 PLUS). The main washing phase of a standard washing cycle (45° C.) is started. The solubility is determined by measuring the conductivity, which is recorded by means of a conductivity sensor. The dissolution process is complete when a conductivity maximum is reached. In the conductivity diagram, this maximum corresponds to a plateau. The conductivity measurement begins with activation of the circulation pump in the main washing phase. The results are presented in Table 2.

TABLE 2
Dissolution times:

| | V1 | E1 | E1 dispersion | E1 powder |
|---|---|---|---|---|
| Dissolution time | 18 | 6 | 6 | 4.5 |
| (minutes) | | | | |

Cleaning Performance

In an automatic dishwasher (Bosch 5302), standardized soiled dishes (milk, burnt-on ground meat, egg yolk, starch) was subjected to a cleaning cycle at 40° C. Before each cleaning cycle, 25 g of cleaning agent V1 and E1, respectively, was metered into the dispenser chutes of the dishwashers (because of its PEG content by weight, agent El according to the present invention contains fewer active detergent or cleaning ingredients, for the same metered quantity, than agent V1). Once cleaning was complete, the cleaning results were checked.

TABLE 2
Cleaning performance:

| | V1 | E1 |
|---|---|---|
| Tea | 3 | 4.5 |
| Milk | 6 | 7 |
| Burnt-on ground meat | 7 | 8 |
| Starch | 6 | 7 |

Evaluation scale: 0 = heavily soiled to 10 = no soiling

It is evident from Table 2 that agent E1 according to the present invention, despite a reduced consumption of active detergent or cleaning substances, has improved cleaning performance as compared with the conventional agent V1.

Rinsing Performance

In an automatic dishwasher (Bosch 5302), formulas V1 and E1 were evaluated at 45° C. and 21° d, using standardized ballast contaminants, in terms of their rinsing performance. Before each cleaning cycle, 25 g of cleaning agent V1 and E1, respectively, was metered into the dispenser chutes of the dishwashers (because of its PEG content by weight, agent El according to the present invention contains fewer active detergent or cleaning ingredients, for the same metered quantity, than agent V1). Once cleaning was complete, the rinsing results were checked.

TABLE 3
Rinsing performance:

| | V1 | E1 |
|---|---|---|
| Glass | 4 | 4.5 |
| Steel (stainless) | 4 | 4.5 |
| Porcelain | 7 | 7 |

Evaluation scale: 0 = severe hazing and spotting to 10 = no hazing or spotting

It is evident from Table 3 that agent E1 according to the present invention, despite a reduced consumption of active detergent or cleaning substances, exhibits improved rinsing results as compared with the conventional agent V1.

Silver Corrosion Protection

The two manganese sulfate-containing dishwashing agents V1 and E1 were tested with regard to their silver corrosion protection properties. Silverware was washed in a continuously operated dishwasher at a water hardness of 0-1° dH. In comparison example V1, 25 g of cleaning agent V1 was metered in for each cleaning cycle; in example E1 according to the present invention, 25 g of agent E1. The washing operation was repeated 50 times under the conditions described above. The overall appearance of the washed items was assessed on the basis of the evaluation scale shown below

TABLE 4
Silver corrosion protection

| | V1 | E1 |
|---|---|---|
| Note | 2.4 | 1.5 |

Evaluation scale: 0 = no corrosion to 4 = severe corrosion.

Table 4 shows that agent El according to the present invention which contains the silver corrosion protection agent in the dispersion according to the present invention exhibits, under the stated conditions, considerably better silver corrosion protection properties than the conventional dishwashing agent.

1. A detergent or cleaning agent comprising a dispersion of solid particles in a dispersion agent wherein the dispersion is comprised of, based on the total weight of the dispersion (a) from 10 to 65 wt % dispersing agent and (b) from 30 to 90 wt % of dispersed materials, wherein the dispersed materials are comprised of from 0.1 to 50 wt % of an anionic and/or cationic and/or amphoteric polymer based on the total weight of the dispersed materials.

2. The detergent or cleaning agent of claim 1 wherein the amount of the dispersing agent is from 12 to 62 wt %.

3. The detergent or cleaning agent of claim 1 wherein the dispersing agent is a nonionic polymer selected from the group consisting of polyethylene glycol, polypropylene glycol and combinations thereof.

4. The detergent or cleaning agent of claim 4 wherein the dispersing agent is polyethylene glycol which is present in the amount of from 10 to 90 wt % based on the total weight of all dispersion agents.

5. The detergent or cleaning agent of claim 1 wherein the dispersing agent is an end capped polyoxyalkylated nonionic surfactant which is present in the amount of from 1 to 60 wt % based on the total weight of all dispersion agents.

6. The detergent or cleaning agent of claim 1 wherein at least one dispersion agent has an average relative molecular weight between 200 and 36000.

7. The detergent or cleaning agent of claim 1 wherein at least one dispersion agent has a melting point above 25° C.

8. The detergent or cleaning agent of claim 1 wherein the density of the dispersion is greater than 1.1 g/cm³.

9. The detergent or cleaning agent of claim 1 wherein the dispersed materials further comprise at least 20 wt % based on the total weight of the dispersed materials of an additive selected from the group consisting of builders, bleaching agents, bleach activators, active detergent or cleaning polymers, glass corrosion protection agents, silver protection agents, enzymes and combinations thereof.

10. The detergent or cleaning agent of claim 1 wherein the dispersed materials are comprised of from 0.2 and 40 wt % based on the total weight of the dispersed materials of an anionic and/or cationic and/or amphoteric polymer.

11. The detergent or cleaning agent of claim 1 wherein the anionic polymer contained in the dispersed material comprises at least one sulfonic acid group-containing copolymer of
a) unsaturated carboxylic acids
b) sulfonic acid group-containing monomers
c) optionally, further ionic or nonionogenic monomers.

12. The detergent or cleaning agent of claim 1 wherein the cationic or amphoteric polymer contained in the dispersed material comprises at least one polymer having a molecular weight above 2000.

13. The detergent or cleaning agent of claim 1 wherein the dispersion has, based on its total weight, a free water content below 10 wt %.

14. A unit packaged detergent or cleaning agent, said unit packaged detergent or cleaning agent comprising a detergent or cleaning agent composition of claim 1 wrapped in a film made of a water-soluble or water-dispersible material.

15. The unit packaged detergent or cleaning agent of claim 14 wherein the water-soluble or water-dispersible film was produced at least partially by deep drawing or injection molding or casting.

16. The unit packaged detergent or cleaning agent of claim 14 wherein the water-soluble the wall thickness of the water-soluble or water-dispersible film is less than 200 μm.

17. A detergent or cleaning agent comprising a dispersion of solid particles in a dispersion agent wherein the dispersion is comprised of, based on the total weight of the dispersion (a) from 10 to 65 wt % dispersion agent and (b) from 30 to 90 wt % dispersed materials, wherein the dispersed materials are comprised of from 0.1 to 50 wt % of an anionic and/or cationic and/or amphoteric polymer based on the total weight of the dispersed materials, the cast body comprising a receiving chamber or cavity which is at least partially filled with a cleaning agent component that comprises (c) from 5 to 95 wt % surfactants and (d) 5 to 95 wt % meltable substance(s) having a melting point above 30° C. and a water solubility of less than 20 g/l at 20° C. and (e) optionally additional ingredients of detergents or cleaning agents and wherein the detergent or cleaning agent is cast in the form of a shaped body.
